(19) United States
(12) Patent Application Publication
(10) Pub. No.: US 2003/0007180 A1
(43) Pub. Date: Jan. 9, 2003

(54) Printing control method for long pages

(75) Inventors: Koji Urasawa, Tokyo (JP); Tatsuya Takagi, Tokyo (JP)

Correspondence Address: AKIN, GUMP, STRAUSS, HAUER & FELD, L.L.P., ONE COMMERCE SQUARE, SUITE 2200, 2005 MARKET STREET, PHILADELPHIA, PA, 19103, US

(73) Assignee: Oki Data Corporation

(21) Appl. No.: 10/185,874

(22) Filed: Jun. 27, 2002

(30) Foreign Application Priority Data
Jun. 28, 2001 (JP) 2001-196892

(51) Int. Cl. B41B 1/00; G06F 15/00; G06K 9/00

(52) U.S. Cl. 358/1.16

(57) ABSTRACT

In a printing control system for printing on non-standard media having a long page length, a host device divides the print data of a single physical page into a plurality of blocks representing independent logical pages, and sends the print data blocks to a printing device together with information indicating the existence of multiple logical pages. The printing device generates printable image data blocks from the print data blocks, and prints the image data blocks on the physical page according to the information added by the host device. Since the printing device can process the print data blocks one by one, the physical length of the page is not constrained by the memory capacity of the printing device.

### BACKGROUND OF THE INVENTION

1. Field of the Invention

The present invention relates to a printing control system and method, and in particular to a method of controlling the printing of long pages.

2. Description of the Related Art

Conventional electrophotographic printers and other printing devices are configured to feed a page of paper as printing media, transport the paper at a constant speed while printing the page, and then eject the page, so paper transport cannot be stopped while the page is being printed. Many such printing devices print by interpreting and rasterizing print data received from a host device. Since each page is printed continuously, all of the print data for a page must be available before printing of the page starts. The host device therefore sends the printing device print data for one page at a time, and the printing device interprets, rasterizes, and prints the data a page at a time.

Some printing devices, or more specifically, some page printers, have a long page printing function, which enables them to print on custom-size paper having a long length (900 millimeters, for example), in addition to printing on standard-size media. FIG. 1 shows an example of a page printed by a page printer having a long page printing function. P denotes a long page printed on a sheet of paper having a length L1 in the direction of paper transport. In the conventional long page printing function, the print data for page P are received and processed as a single unit.

If an electrophotographic printer performs the long page printing function as described above by the frame-buffer method, the amount of random-access memory (RAM) needed to store the rasterized image data increases in proportion to the length of the paper. If the band-buffer method is used, the amount of intermediate data (display list) increases in proportion to the length of the paper, and the intermediate data must also be stored in memory. In either case, the printer's memory capacity constrains the size of paper that can be printed on.

### SUMMARY OF THE INVENTION

An object of the present invention is to provide a printing control method that does not constrain the size of the print media and allows printing on longer paper than was previously possible.

In the invented printing control method, a host device divides the print data of a single physical page into a plurality of blocks, adds information indicating that there are multiple logical pages to certain ones of the blocks, and sends the blocks of print data to a printing device. The printing device generates multiple image blocks, each image block constituting a logical page, from the print data, and prints the single physical page in accordance with the added information.

Since the printing device does not have to process the print data for a physical page all at once, but can process each logical page as a separate unit, the physical length of the printable media is not limited by the memory capacity of the printing device. Physical pages of arbitrary length can be printed by generating successive image blocks in the printing device.

The invention also provides a printing system including a host device and a printing device that use the invented method to print long pages.

### BRIEF DESCRIPTION OF THE DRAWINGS

In the attached drawings:

FIG. 1 shows an example of a page printed by a conventional page printer having a long page printing function;

FIG. 2 is a block diagram of a printing control system illustrating a first embodiment of the invention;

FIG. 3 is a flow chart illustrating the operation of the host device in the first embodiment;

FIG. 4 illustrates a data format used in the first embodiment;

FIG. 5 is a flow chart illustrating a main routine executed by the job controller in the first embodiment;

FIG. 6 is a flow chart illustrating a subroutine that starts receiving a job in the first embodiment;

FIG. 7 is a flow chart illustrating a subroutine that ends job translation in the first embodiment;

FIG. 8 is a flow chart illustrating the subroutine that ends the generation of a block in the first embodiment;

FIG. 9 shows an example of block connectivity information in the first embodiment;

FIG. 10 shows an example of the logical page division of a printed page with a long page length in the first embodiment;

FIG. 11 shows the timing at which printing starts in the first embodiment;

FIG. 12 shows the timing at which printing starts in a second embodiment of the invention;

FIG. 13 is a flow chart illustrating the operation of the host device in a third embodiment of the invention;

FIG. 14 illustrates a data format used in the third embodiment;

FIG. 15 is a flow chart illustrating the operation of the host device in a fourth embodiment of the invention;

FIG. 16 illustrates a data format used in the fourth embodiment;

FIG. 17 shows the timing at which printing starts in a fifth embodiment of the invention;

FIG. 18 is a flow chart illustrating the main routine executed by the job controller in the fifth embodiment;

FIG. 19 is a flow chart illustrating the subroutine that starts job reception in the fifth embodiment;

FIG. 20 is a flow chart illustrating the subroutine that ends job translation in the fifth embodiment;

FIG. 21 is a flow chart illustrating the subroutine that ends block interpretation in the fifth embodiment;

FIG. 22 is a flow chart illustrating the subroutine that ends block rasterization in the fifth embodiment;

FIG. 23 shows the timing at which printing starts in a sixth embodiment of the invention;

FIG. 24 is a block diagram of a printing control system illustrating a seventh embodiment of the invention;

FIG. 25 is a flow chart illustrating the main routine executed by the job controller in the seventh embodiment;

FIG. 26 is a flow chart illustrating the subroutine that starts receiving a job in the seventh embodiment;

FIG. 27 is a flow chart illustrating the subroutine that ends job spooling in the seventh embodiment;

FIG. 28 is a flow chart illustrating the subroutine that ends job translation in the seventh embodiment;

FIG. 29 is a flow chart illustrating the subroutine that ends block generation in the seventh embodiment;

FIG. 30 is a block diagram of a printing control system illustrating an eighth embodiment of the invention;

FIG. 31 is a flow chart illustrating the main routine executed by the job controller in the eighth embodiment;

FIG. 32 is a flow chart illustrating the subroutine that starts receiving a job in the eighth embodiment;

FIG. 33 is a flow chart illustrating the subroutine that ends job translation in the eighth embodiment;

FIG. 34 is a flow chart illustrating the subroutine that ends block generation in the eighth embodiment;

FIG. 35 is a block diagram of a printing control system illustrating a ninth embodiment of the invention;

FIG. 36 is a flow chart illustrating the main routine executed by the job controller in the ninth embodiment;

FIG. 37 is a flow chart illustrating the subroutine that starts receiving a job in the ninth embodiment;

FIG. 38 is a flow chart illustrating the subroutine that ends job translation in the ninth embodiment;

FIG. 39 is a flow chart illustrating the subroutine that ends block generation in the ninth embodiment;

FIG. 40 is a flow chart illustrating the subroutine that performs error recovery processing in the ninth embodiment;

FIG. 41 is a block diagram of a printing control system illustrating a tenth embodiment of the invention;

FIG. 42 is a flow chart illustrating the main routine executed by the job controller in the tenth embodiment;

FIG. 43 is a flow chart illustrating the subroutine that starts receiving a job in the tenth embodiment;

FIG. 44 is a flow chart illustrating the subroutine that ends job translation in the tenth embodiment;

FIG. 45 is a flow chart illustrating the subroutine that ends block generation in the tenth embodiment;

FIG. 46 illustrates the error recovery subroutine in the tenth embodiment;

FIG. 47 is a flow chart illustrating the subroutine that ends the printing process in the tenth embodiment;

FIG. 48 is a block diagram of a printing control system illustrating an eleventh embodiment of the invention;

FIG. 49 is a flow chart illustrating the operation of the job controller in the eleventh embodiment;

FIG. 50 is a flow chart illustrating a subroutine that starts receiving a job in the eleventh embodiment;

FIG. 51 is a flow chart illustrating the main routine executed by the reprinting controller in the eleventh embodiment;

FIG. 52 illustrates a subroutine that processes reprinting requests in the eleventh embodiment;

FIG. 53 is a block diagram of a printing control system illustrating a twelfth embodiment of the invention;

FIG. 54 shows the data structure of a block in the twelfth embodiment;

FIG. 55 is a flow chart illustrating the main routine executed by the printing processor in the twelfth embodiment;

FIG. 56 is a flow chart illustrating the subroutine that starts paper transport in the twelfth embodiment;

FIG. 57 is a flow chart illustrating the subroutine that starts printing in the twelfth embodiment;

FIG. 58 is a flow chart illustrating the subroutine that outputs a block in the twelfth embodiment;

FIG. 59 shows an example of normal printing in the twelfth embodiment;

FIG. 60 shows an example of a printed page with a long page length in the twelfth embodiment;

FIG. 61 is a flow chart illustrating the main routine executed by the image data manager in the twelfth embodiment;

FIG. 62 is a flow chart illustrating the subroutine that accepts a block in the twelfth embodiment;

FIG. 63 is a flow chart illustrating the subroutine that responds to a Frame-Sync-on acceptance event in the twelfth embodiment;

FIG. 64 is a flow chart illustrating the subroutine that responds to a Frame-Sync-off acceptance event in the twelfth embodiment;

FIG. 65 is a flow chart illustrating the subroutine that transmits the next band of image data in the twelfth embodiment;

FIG. 66 is a flow chart illustrating the main routine executed by the image data manager in a thirteenth embodiment of the invention;

FIG. 67 is a flow chart illustrating the subroutine that accepts a block in the thirteenth embodiment;

FIG. 68 is a flow chart illustrating the subroutine that responds to a Frame-Sync-on acceptance event in the thirteenth embodiment;

FIG. 69 is a flow chart illustrating the subroutine that responds to a Frame-Sync-off acceptance event in the thirteenth embodiment;

FIG. 70 is a flow chart illustrating the subroutine that transmits the next band in the thirteenth embodiment;

FIG. 71 shows the configuration of a data block in the thirteenth embodiment;

FIG. 72 shows the configuration of a data block in a fourteenth embodiment of the invention;

FIG. 73 is a flow chart illustrating the main routine executed by the printing processor in the fourteenth embodiment;

FIG. 74 is a flow chart illustrating the subroutine that starts paper transport in the fourteenth embodiment;

FIG. 75 is a flow chart illustrating the subroutine that starts printing in the fourteenth embodiment;

FIG. 76 is a flow chart illustrating the subroutine that outputs a block in the fourteenth embodiment;

FIG. 77 is a flow chart illustrating the subroutine that ends block transmission in the fourteenth embodiment;

FIG. 78 is a flow chart illustrating the main routine executed by the image data manager in the fourteenth embodiment;

FIG. 79 is a flow chart illustrating the subroutine that accepts a block in the fourteenth embodiment;

FIG. 80 is a flow chart illustrating the subroutine that responds to a Frame-Sync-on acceptance event in the fourteenth embodiment;

FIG. 81 is a flow chart illustrating the subroutine that responds to a Frame-Sync-off acceptance event in the fourteenth embodiment;

FIG. 82 is a flow chart illustrating the subroutine that transmits the next band of image data in the fourteenth embodiment;

FIG. 83 is a flow chart illustrating the subroutine that ends color plane transmission in the fourteenth embodiment;

FIG. 84 is a block diagram of a printing control system illustrating a fifteenth embodiment of the invention;

FIG. 85 illustrates the configuration of a data block in the fifteenth embodiment;

FIG. 86 is a flow chart illustrating the main routine executed by the block loading controller in the fifteenth embodiment;

FIG. 87 is a flow chart illustrating the subroutine that decides when to load blocks in the fifteenth embodiment; and

FIG. 88 is a flow chart illustrating the subroutine that loads blocks in the fifteenth embodiment.

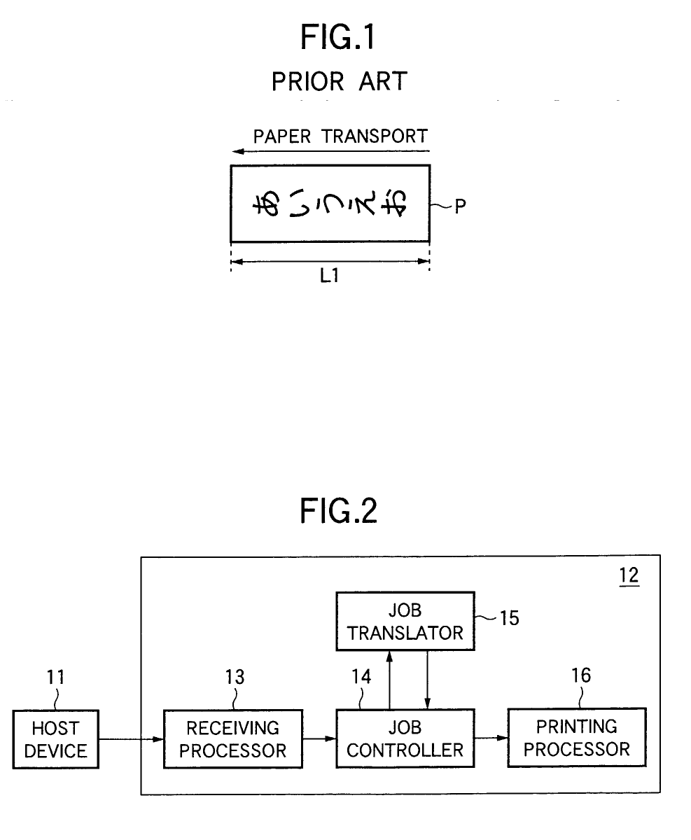

### DETAILED DESCRIPTION OF THE INVENTION

Embodiments of the invention will now be described with reference to the attached drawings, in which like elements are indicated by like reference characters.

FIG. 2 illustrates a printing control system according to a first embodiment of the invention. A host device 11 such as a personal computer, workstation, or the like sends print data in a page description language (PDL), such as the well-known PostScript language or PCL (Page Control Language), to a printing device 12 such as a printer or copier. The host device 11 and printing device 12 may be linked through a Centronics interface, a universal serial bus (USB), or any other known interface. From the point of view of the printing-device 12, the interface is the host interface, and it will be referred to as such below.

The printing device 12 comprises a receiving processor 13, a job controller 14, a job translator 15, and a printing processor 16, all of which may be implemented as software. The printing device 12 also comprises hardware units such as a paper transport mechanism and a printing unit (not shown).

When the printing device 12 receives print data from the host device 11, the receiving processor 13 detects the incoming data, determines the type of printing job (the type of PDL) represented by the print data, and recognizes the boundary between one printing job and the next. The job controller 14 controls the flow of operations during the printing of a job. The job translator 15 comprises a PDL interpreter such as a PostScript interpreter or PCL interpreter, which further comprises an interpretation processor and a rasterization processor. The interpretation processor interprets the print data, and the rasterization processor rasterizes the interpreted print data to generate printable image data. In a color printing device, the image data comprise bit-mapped image data for each of several different color planes. The printing processor 16 prints on print media in accordance with the image data generated by the job translator 15.

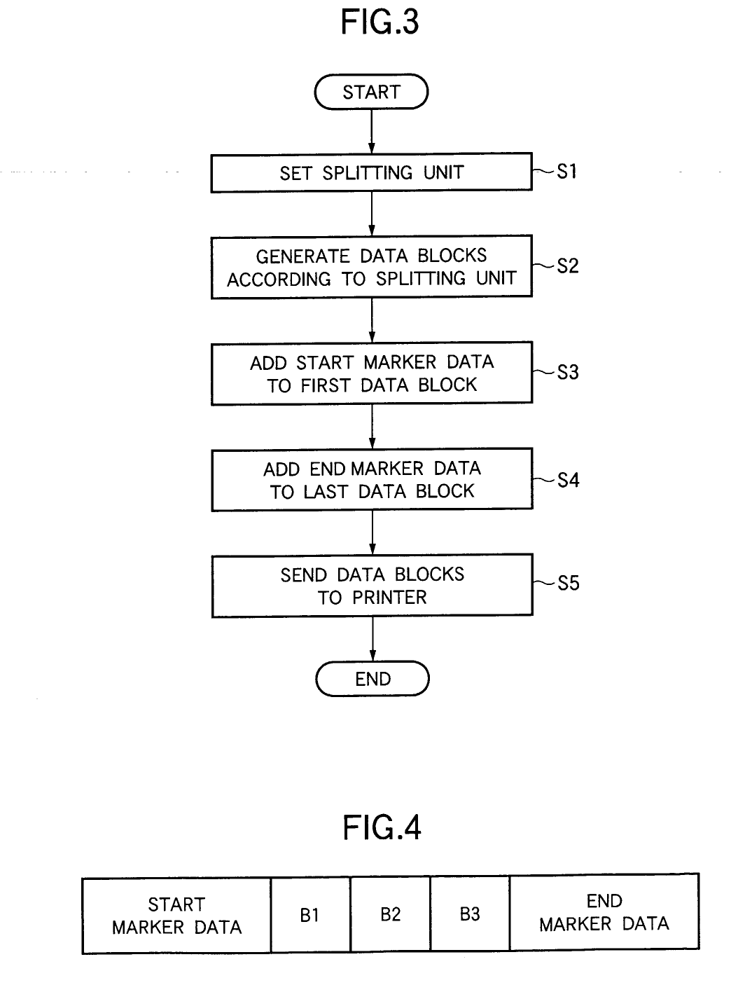

To print a page with a long page length, the host device 11 splits the print data into a plurality of blocks, which represent logical pages. This operation, as performed in the first embodiment, will be described with reference to FIGS. 3 and 4. FIG. 3 is a flow chart illustrating the operation of the host device; FIG. 4 shows an exemplary data format.

To execute a printing job with a long page length, the operator gives an instruction on a control panel or the like to split the print data. The host device 11 determines a splitting unit such as A3 size, A4 size, or letter size, and performs print processing accordingly. For instance, the host device 11 may split the print data of a single physical page into blocks B1 to B3, adding information marking the beginning of the data to the first block B1 and information marking the end of the data to the last block B3. The host device 11 then sends the split print data to the printing device 12. The processing in the host device 11 is simplified in that conventional processing methods can be used for each block.

The flow chart in FIG. 3 shows the operation of the host device 11 as described above:

Step S1: Determine a splitting unit.

Step S2: Perform processing to create print data in accordance with the splitting unit, generating data blocks B1 to B3.

Step S3: Add start-marker data to the first block B1.

Step S4: Add end-marker data to the last block B3.

Step S5: Send the print data to the printing device 12.

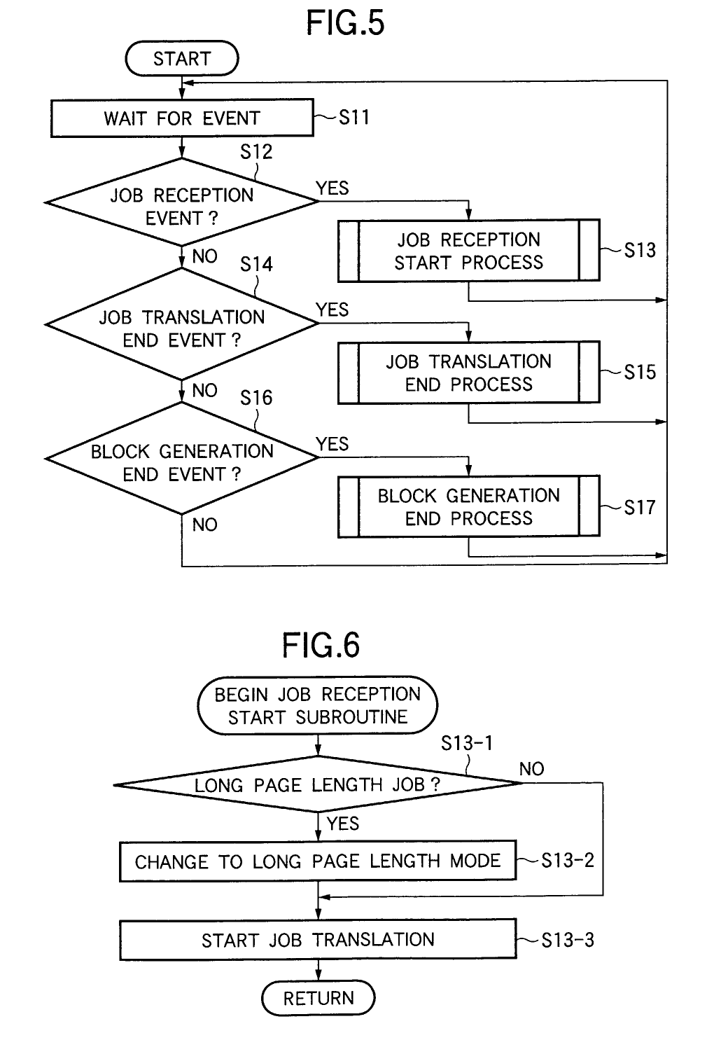

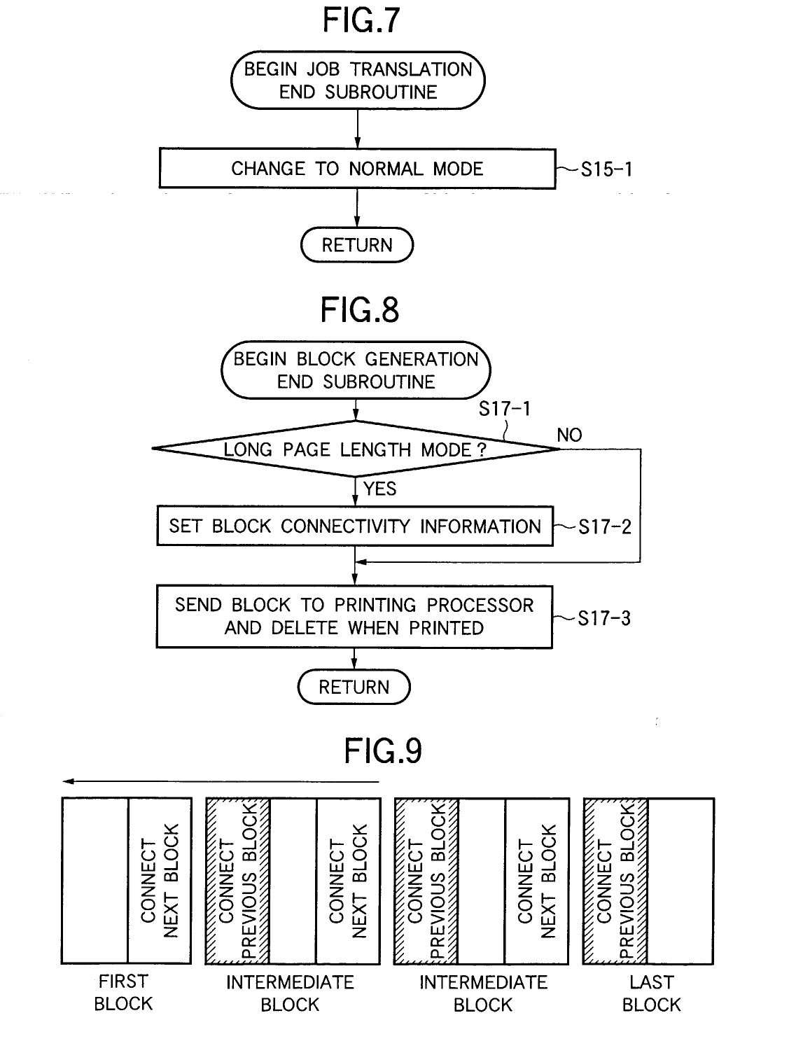

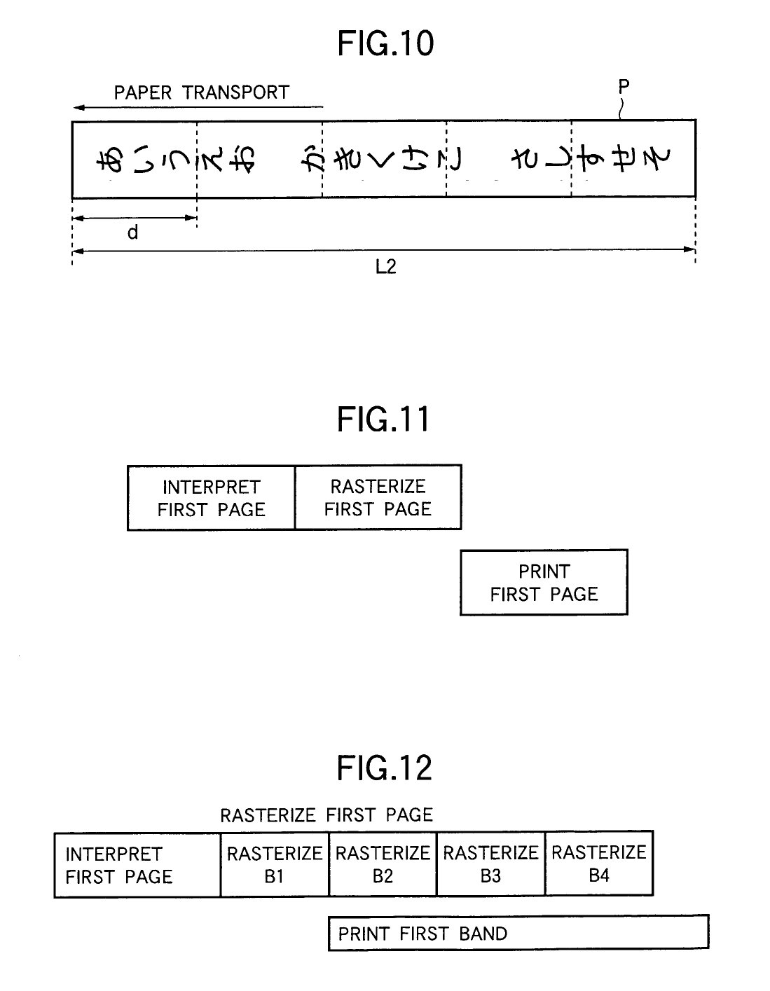

The operation of the job controller 14 in the first embodiment will next be described with reference to FIGS. 5 to 10. FIG. 5 illustrates the main routine executed by the job controller. FIG. 6 illustrates the subroutine that starts receiving a job. FIG. 7 illustrates the subroutine that ends job translation. FIG. 8 illustrates the subroutine that ends the generation of a block. FIG. 9 shows an example of block connectivity information. FIG. 10 shows an example of the logical page division of a printed page with a long page length.

During this operation, the job controller 14 (FIG. 2) operates according to a multitasking discipline. When the printing device 12 is activated, the main routine of the job controller 14 is called and executes in an endless loop.

In this loop, the job controller 14 waits until an event occurs. When a job reception event occurs, a job reception processor (not shown in the drawings) in the job controller 14 performs processing to start job reception, and determines whether the print data are split, signifying that the printing job has a long page length. If the printing job has a long page length, the job controller 14 changes the printing mode to the long page length mode and instructs the job translator 15 to start translation.

Although the long page length mode has been selected, the job translator 15 performs normal translation processing. When the translation ends, the job translator 15 notifies the job controller 14, which thereby detects an end-of-translation event. A job translation termination processor (not shown in the drawings) in the job controller 14 then performs processing to end job translation and restore the normal printing mode.

During the translation process, blocks of bit-mapped image data corresponding to blocks B1 to B3 in FIG. 4 are generated, and the generation of each block is reported to the job controller 14. When the job controller 14 detects an end-of-block-generation event, a block generation termination processor (not shown in the drawings) in the job controller 14 performs end-of-block-generation processing by deciding whether the current operating mode is the long page length mode, setting block connectivity information in the block in accordance with the start-marker data and end-marker data added to blocks B1 and B3 if the current operating mode is the long page length mode, and sending the block of image data to the printing processor 16. The block connectivity information can be any information that enables the printing processor 16 to print on a page with a long page length by indicating whether to connect the current block to the succeeding and/or preceding block. As shown in FIG. 9, the first block, intermediate blocks, and last block follow one another in downstream-to-upstream order in the direction of paper transport. The first block is connected to its succeeding block, each intermediate block is connected to its preceding and succeeding blocks, and the last block is connected to its preceding block.

The printing processor 16 connects the blocks in accordance with the block connectivity information and sends the connected blocks to be printed by the printing unit (not shown). When a block has been printed, its image data are deleted. The block connection method depends on the printing method. For instance, an ink-jet printer can connect image data just by suppressing form feeds until the last block.

Referring to FIG. 10, in the long page printing mode, for a sheet of paper P having length L2 in the direction of paper transport, the printing is carried out as described above in units of length d, where d is the length of one logical page (one block).

The printing procedure for a page with a long page length is thus as follows: the host device 11 splits the print data into a plurality of blocks and sends the split print data to the printing device 12; the printing device 12 generates image data blocks corresponding to the print data blocks; the printing processor 16 connects and prints the image data blocks. The printed image data blocks are deleted. Therefore, the amount of RAM or other memory (not shown in the drawings) available for storing the image data in the job translator 15 does not limit the size of paper that can be used as printing media.

The flow chart in FIG. 5 shows the main routine of the operation described above.

Step S11: Wait for an event to occur.

Step S12: Decide whether a job reception event has occurred. If so, go to step S13. If not, go to step S14.

Step S13: Carry out processing to start job reception; then return to step S11.

Step S14: Decide whether an end-of-job-translation event has occurred. If so, go to step S15. If not, go to step S16.

Step S15: Carry out processing to end job translation; then return to step S11.

Step S16: Decide whether an end-of-block-generation event has occurred. If so, go to step S17. If not, return to step S11.

Step S17: Carry out processing to end block generation; then return to step S11.

The flow chart in FIG. 6 shows the subroutine that carries out step S13.

Step S13-1: Decide whether the current job is to be printed in the long page length mode. If so, go to step S13-2. If not, go to step S13-3.

Step S13-2: Change the printing mode to the long page length mode.

Step S13-3: Instruct the job translator 15 to start translation; then return.

The flow chart in FIG. 7 shows the subroutine that carries out step S15.

Step S15-1: Change the printing mode to the normal mode; then return.

The flow chart in FIG. 8 shows the subroutine that carries out step S17.

Step S17-1: Decide whether the long page length mode is selected. If so, go to step S17-2. If not, go to step S17-3.

Step S17-2: Set block connectivity information.

Step S17-3: Send the block to the printing processor 16; delete the printed block; then return.

The blocks are generated by the interpretation processor and rasterization processor mentioned above. The interpretation processor translates the received print data into intermediate data; the rasterization processor rasterizes the interpreted intermediate data to obtain printable bit-mapped image data. Therefore, the presence or absence of a succeeding block is known by the end of interpretation at the latest.

In the normal mode in the first embodiment, the image data are sent to the printing processor 16 by the frame-buffer method, and printing starts after the creation of the image data for an entire physical page. As shown in FIG. 11, the printing of a normal page starts when the rasterization of the page ends. After the first page is interpreted and rasterized, for example, the printing processor 16 receives the image data representing the first page and starts printing the first page. Logical pages are also printed in this way in the long page length mode.

Next, a second embodiment of the invention will be described. In this embodiment, the image data are sent to the printing processor 16 by the band-buffer method. The print data of a single page are split into a plurality of bands (a band representing a unit amount of image data), and the bands are rasterized one by one, reusing the same memory areas cyclically, while printing is in progress.

FIG. 12 shows the timing at which printing starts in the second embodiment. Printing starts while rasterization is in progress. In the normal mode, after the first logical page has been interpreted, the rasterization of the first band (B1) on the first page starts. When the rasterization ends, the printing processor 16 receives and starts printing the first rasterized band. After being printed, the first rasterized band of image data is deleted. In the meantime, the rasterization of the second band begins. Printing continues in this way, the printing of each band starting when the rasterization of the band is completed and each band being deleted after being printed. Logical pages are also printed in this way in the long page length mode.

Next, a third embodiment of the invention will be described. In the third embodiment, when generating the data blocks for a long page, the host device 11 also calculates a block count indicating the number of blocks into which the page is divided. The structure of the printing device 12 is similar to the structure of the printing device 12 in the first embodiment, shown in FIG. 2.

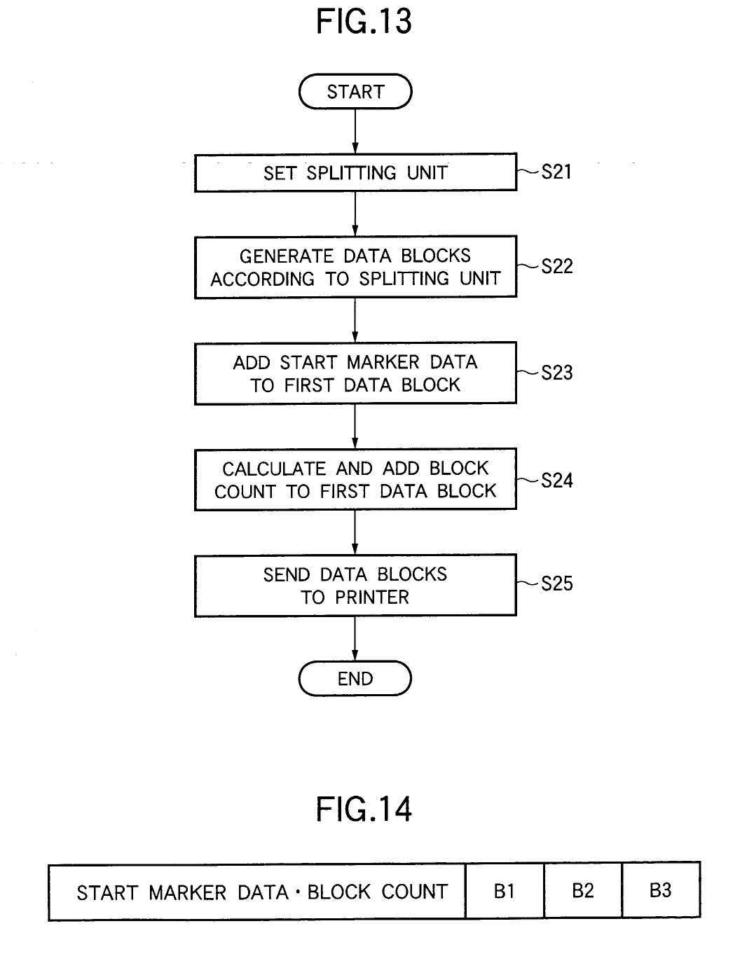

The operation of the host device in the third embodiment will be described with reference to the flow chart in FIG. 13 and the exemplary data format diagram in FIG. 14.

In the third embodiment, the host device 11 determines a splitting unit and calculates a block count. For instance, the host device 11 may split the print data for a single physical page P into data blocks B1 to B3 and calculate a block count of three. Alternatively, the block count may be calculated as two, indicating the number of blocks on the page after the first block. The host device 11 adds start-marker data and the block count to the first data block B1 and sends the blocks of print data to the printing device 12.

The flow chart in FIG. 13 shows the operation of the host device 11 in more detail:

Step S21: Determine a splitting unit.

Step S22: Perform print processing in accordance with the splitting unit, generating data blocks B1 to B3.

Step S23: Add start-marker data to the first block B1.

Step S24: Calculate the block count and add the block count to the first block B1.

Step S25: Send the print data to the printing device 12 and end the processing.

The printing device 12 operates as in the first embodiment, except that it uses the block count to decide whether each block (after the first block) on the physical page is an intermediate block or the last block.

A fourth embodiment of the invention will be described next. In this embodiment, each data block is provided with linking information indicating whether there is a next data block. The structure of the printing device 12 in this embodiment is similar to the structure of the printing device 12 in the first embodiment.

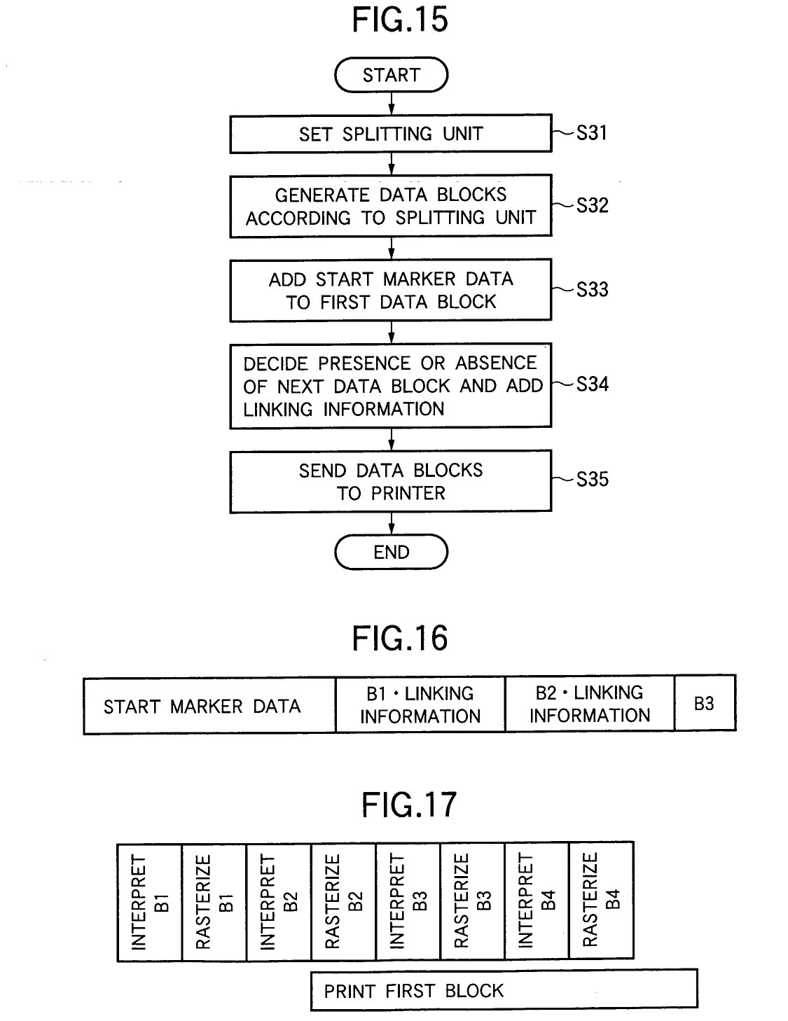

The operation of the host device 11 in the fourth embodiment will be described with reference to FIGS. 15 and 16. FIG. 15 is a flow chart illustrating the operation; FIG. 16 shows an example of the data format.

In the fourth embodiment, the host device 11 (FIG. 2) determines a splitting unit and performs print processing accordingly, splitting the print data into blocks. For instance, the host device 11 may split the print data into data blocks B1 to B3. Next, the host device 11 adds start-marker data to data block B1 and linking information indicating the presence of a succeeding data block to data blocks B1 and B2. Then the host device 11 sends the print data to the printing device 12.

The flow chart in FIG. 15 shows the operation of the host device 11 as described above:

Step S31: Determine a splitting unit.

Step S32: Perform print processing in accordance with the splitting unit, generating data blocks B1 to B3.

Step S33: Add start-marker data to the first block B1.

Step S34: Decide whether each block (B1 to B3) is followed by another block, and if so, add linking information to the block.

Step S35: Send the print data to the printing device 12 and end the processing.

The printing device 12 operates as in the first embodiment, except that it uses the linking information to decide whether each block is the last block on the physical page.

In the embodiments described above, the printing device 12 determines whether a block is followed by another block on the basis of an explicit indication such as end-marker data, a block count, or linking information added to the blocks. It may also be possible, however, to determine the presence or absence of a succeeding block from implicit information such as specifications given in the page description language used for the print data. If the printing device 12 can use such implicit information to decide whether there is a next block on the same physical page, the host device 11 does not have to add explicit indications to the print data. The necessary indications can be added by the printing device 12 itself, as in the fifth embodiment described next.

In some cases, even after generating a block, the printing device 12 may be unable to decide from the implicit information available so far whether there is a next block on the same physical page; this decision can only be made after the next block has been interpreted. In the fifth embodiment, accordingly, after interpreting each block in the long page length mode, the printing device 12 determines whether this block is part of the same physical page as the preceding block, and if it is, adds block connectivity information to both blocks.

The structure of the printing device 12 in the fifth embodiment is similar to the structure of the printing device 12 in the first embodiment, shown in FIG. 2. FIG. 17 shows the timing at which printing starts in the fifth embodiment.

In the fifth embodiment, because the job controller 14 (FIG. 2) cannot always decide, when the generation of a block ends, whether there is a next block on the same physical page, before sending the generated block to the printing processor 16, it waits until the presence or absence of a next block can be determined, and then adds block connectivity information if a next block is present. As shown in FIG. 17, the presence of a second block (B2) on the same physical page as the first block (B1) is known after the interpretation and rasterization of the first block and the interpretation of the second block. Therefore, the first block is sent to the printing processor 16 and printed when the interpretation of the second block ends. The interpreted and rasterized data of a block are deleted when the block has been printed.

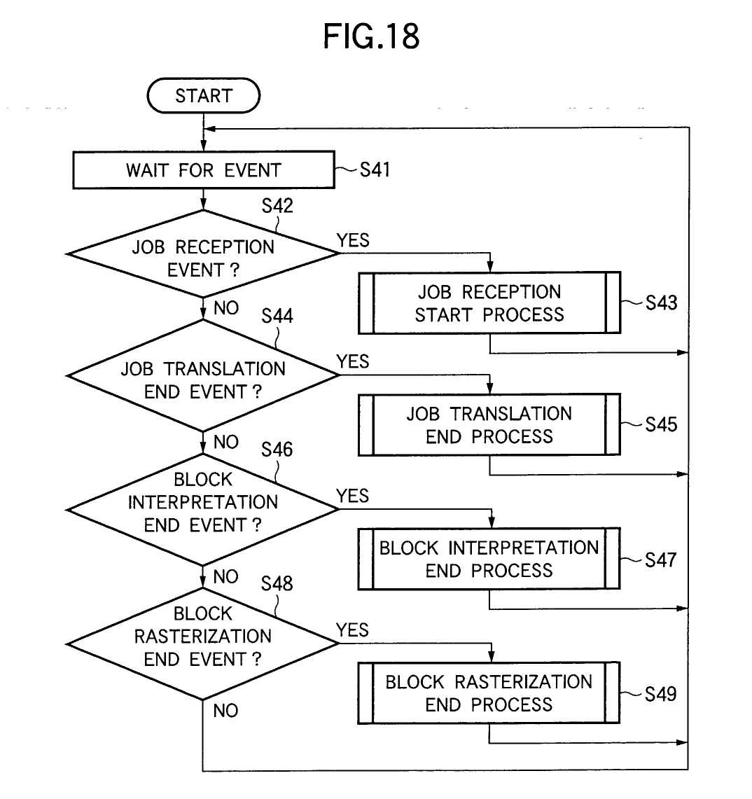

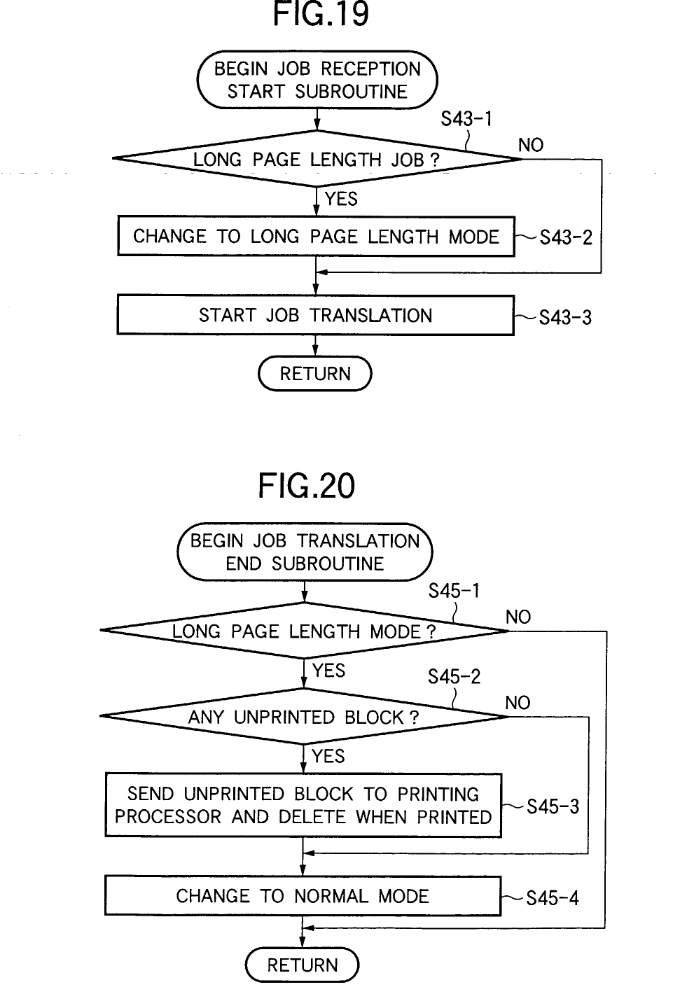

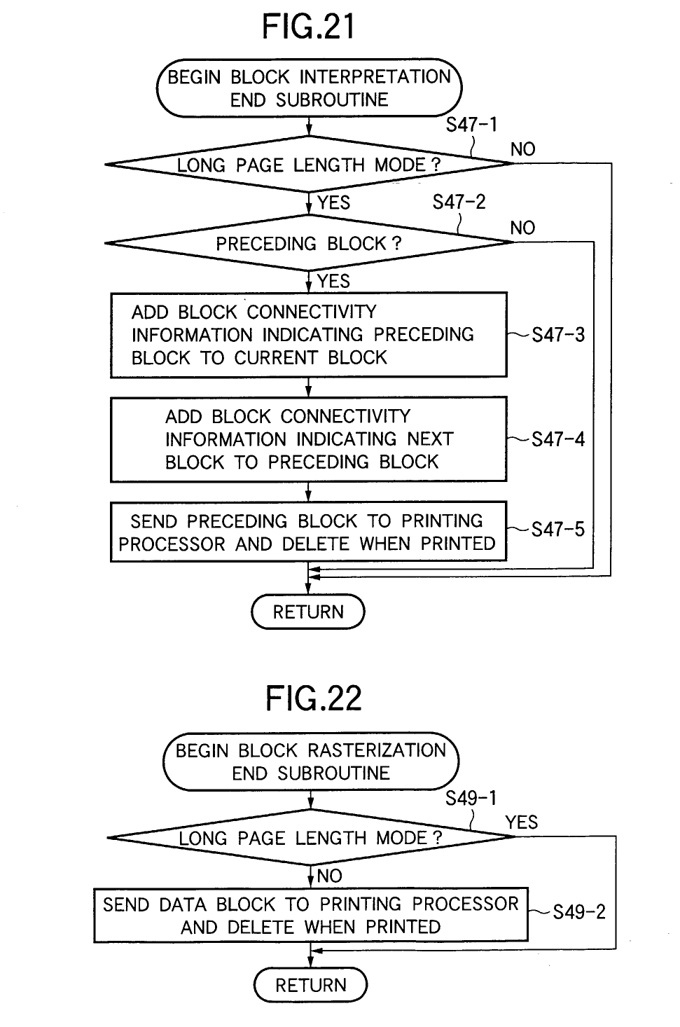

The operation of the job controller 14 in the fifth embodiment will next be described with reference to FIGS. 18 to 22. FIG. 18 illustrates the main routine executed by the job controller. FIG. 19 illustrates the subroutine that starts job reception. FIG. 20 illustrates the subroutine that ends job translation. FIG. 21 illustrates the subroutine that ends block interpretation. FIG. 22 illustrates the subroutine that ends block rasterization.

In this embodiment, when a job reception event occurs, a job reception processor (not shown in the drawings) in the job controller 14 (FIG. 2) performs processing to start job reception, and the job translator 15 begins translating the received blocks, by interpreting and rasterizing each block.

When the interpretation of a block ends, the job translator 15 informs the job controller 14, and a block interpretation termination processor (not shown in the drawings) in the job controller 14 decides whether the current operating mode is the long page length mode. If the current operating mode is the long page length mode, the block interpretation termination processor checks whether there is a preceding block on the same page. If no preceding block is present, the block interpretation termination processor recognizes that the current block is the first block on the physical page. If a preceding block is present, the block interpretation termination processor adds block connectivity information to the current block indicating that there is a preceding block, adds block connectivity information to the preceding block indicating that there is a next block, and sends the preceding block to the printing processor 16.

When the rasterization of a block ends, the job translator 15 informs the job controller 14, and a block rasterization termination processor (not shown in the drawings) in the job controller 14 decides whether the current operating mode is the long page length mode. If the long page length mode is not selected, the rasterized block is sent to the printing processor 16. If the operating mode is the long page length mode, the current block is not sent to the printing processor 16, because it is not yet known whether the current block will be followed by another block on the same page.

When the job translator 15 has finished translating the entire job, a job translation termination processor (not shown in the drawings) in the job controller 14 decides whether the current operating mode is the long page length mode. If the long page length mode is not selected, processing of the job ends. If the operating mode is the long page length mode, the job translation termination processor decides whether the job translator 15 is still holding an unprinted block, sends the unprinted block (if present) to the printing processor 16, then changes the printing mode to the normal mode.

The processing that ended block generation in the first to fourth embodiments is thus divided into two processes in the fifth embodiment, one ending block interpretation, the other ending block rasterization. The block generation termination process corresponds to the block interpretation termination process in the frame-buffer method, and to the block-rasterization termination process in the band-buffer method. In the fifth embodiment, the operation of adding block connectivity information is based on the frame-buffer method.

The flow chart in FIG. 18 illustrates the main routine executed by the job controller 14 in the fifth embodiment.

Step S41: Wait for an event to occur.

Step S42: Decide whether a job reception event has occurred. If so, go to step S43. If not, go to step S44.

Step S43: Carry out processing to start job reception; then return to step S41.

Step S44: Decide whether an end-of-job-translation event has occurred. If so, go to step S45. If not, go to step S46.

Step S45: Carry out processing to end job translation; then return to step S41.

Step S46: Decide whether an end-of-block-interpretation event has occurred. If so, go to step S47. If not, go to step S48.

Step S47: Carry out processing to end block interpretation; then return to step S41.

Step S48: Decide whether an end-of-block-rasterization event has occurred. If so, go to step S49. If not, return to step S41.

Step S49: Carry out processing to end block rasterization; then return to step S41.

The flow chart in FIG. 19 shows the subroutine that carries out step S43.

Step S43-1: Decide whether the current job has a long page length. If so, go to step S43-2. If not, go to step S43-3.

Step S43-2: Change the operating mode to the long page length mode.

Step S43-3: Instruct the job translator 15 to start translation; then return.

The flow chart in FIG. 20 shows the subroutine that carries out step S45.

Step S45-1: Decide whether the long page length mode is selected. If so, go to step S45-2. If not, return.

Step S45-2: Decide whether there is an unprinted block. If so, go to step S45-3. If not, go to step S45-4.

Step S45-3: Send the unprinted block to the printing processor 16; delete the block when it has been printed.

Step S45-4: Change the operating mode to the normal mode; then return.

The flow chart in FIG. 21 shows the subroutine that carries out step S47.

Step S47-1: Decide whether the long page length mode is selected. If so, go to step S47-2. If not, return.

Step S47-2: Decide whether there is a preceding block. If so, go to step S47-3. If not, return.

Step S47-3: Add block connectivity information indicating the presence of a preceding block to the current block.

Step S47-4: Add block connectivity information indicating the presence of a succeeding block to the preceding block.

Step S47-5: Send the previous block to the printing processor 16; delete the block when it has been printed; then return.

The flow chart in FIG. 22 shows the subroutine that carries out step S49.

Step S49-1: Decide whether the long page length mode is selected. If so, return. If not, go to step S49-2.

Step S49-2: Send the block to the printing processor 16; delete the block when it has been printed; then return.

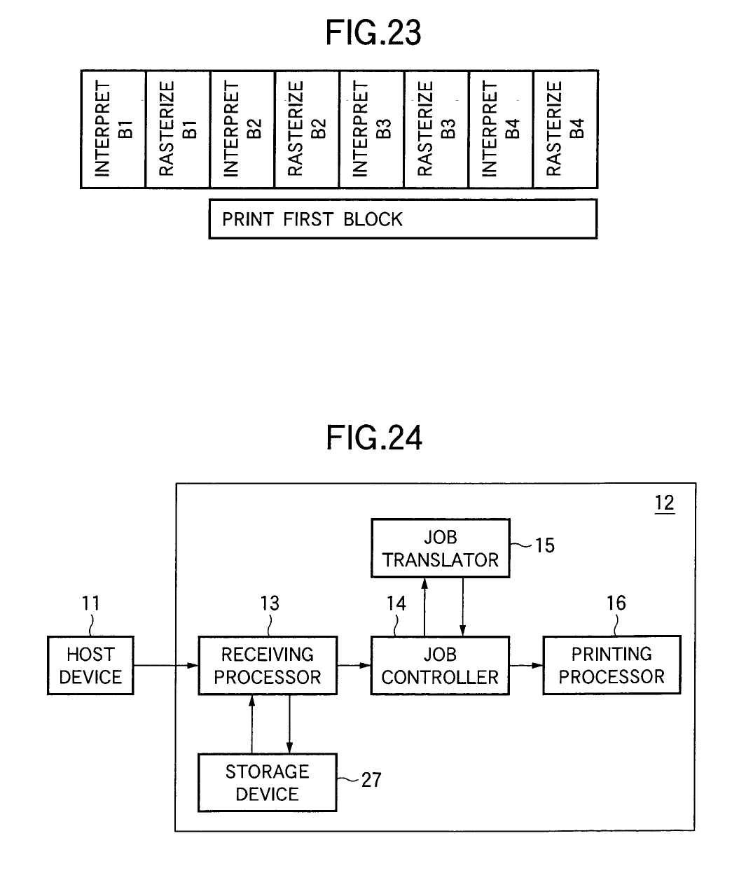

If the print data are sent in a data format similar to the format used in the third or fourth embodiment, when the generation of a block ends, it is already known whether there is a succeeding block. In a sixth embodiment of the invention, accordingly, the printing device 12 adds block connectivity information at the end of the generation of the block, instead of at the end of interpretation of the next block. FIG. 23 shows the timing of the starting of printing in the sixth embodiment.

In this embodiment, a block count is added to the first block (B1), and linking information is added to the other blocks. When the interpretation and rasterization of the first block end, the presence of a second block is recognized. Therefore, the printing of the first block starts as soon as the rasterization of the first block ends.

When a page printer is used to print a long page, it must generate blocks fast enough to keep up with the transport speed of the paper P (FIG. 10); otherwise, a so-called overrun will occur. For a variety of reasons, such as the data transfer rate on the host interface between the host device 11 and printing device 12, the size and complexity of the print data sent from the host device 11, and the speed with which the printing device 12 can interpret the print data, it is not always possible for the printing device 12 to generate blocks at the necessary rate.

In a page printer, from the beginning to the end of the printing of a single physical page, the paper P travels at a constant speed. In the long page length mode, if blocks cannot be generated fast enough to keep up with this speed, some of the blocks may be printed in the wrong positions on the page, or printed on the next page, or not printed at all. Any of these conditions is referred to as an overrun.

When the band buffer method is used, the bit-mapped image data are generated in several memory areas known as bands, which are reused cyclically to conserve memory space. In this case, an overrun occurs if successive bands cannot be generated fast enough to keep up with the paper transport speed. Incidentally, the band buffer method is not normally used in a tandem color printer, because of the difficulty of matching the timing of the different color planes.

When the frame buffer method is used, overrun does not normally occur, because a page is normally not printed until all the bit-mapped image data for the page are available. The frame buffer method uses more memory than the band buffer method, however.

The seventh embodiment, described next, addresses the problem of overrun due to the data transfer speed on the host interface.

Referring to FIG. 24, the printing device 12 in the seventh embodiment comprises, in addition to the receiving processor 13, job controller 14, job translator 15, and printing processor 16 described in the first embodiment, a storage device 27 such as a hard disk or RAM disk. The access speed of the storage device 27 is significantly faster than the data transfer rate of the host interface.

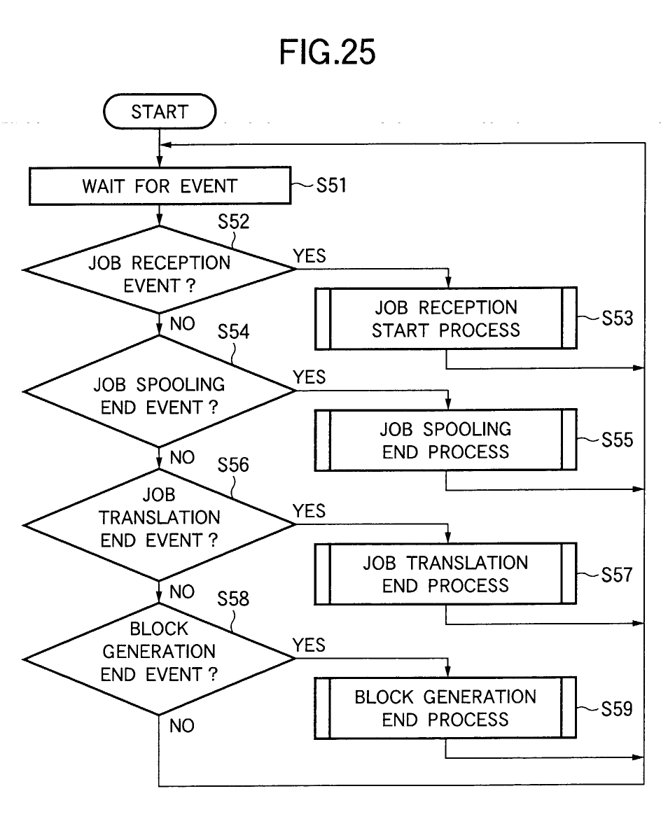

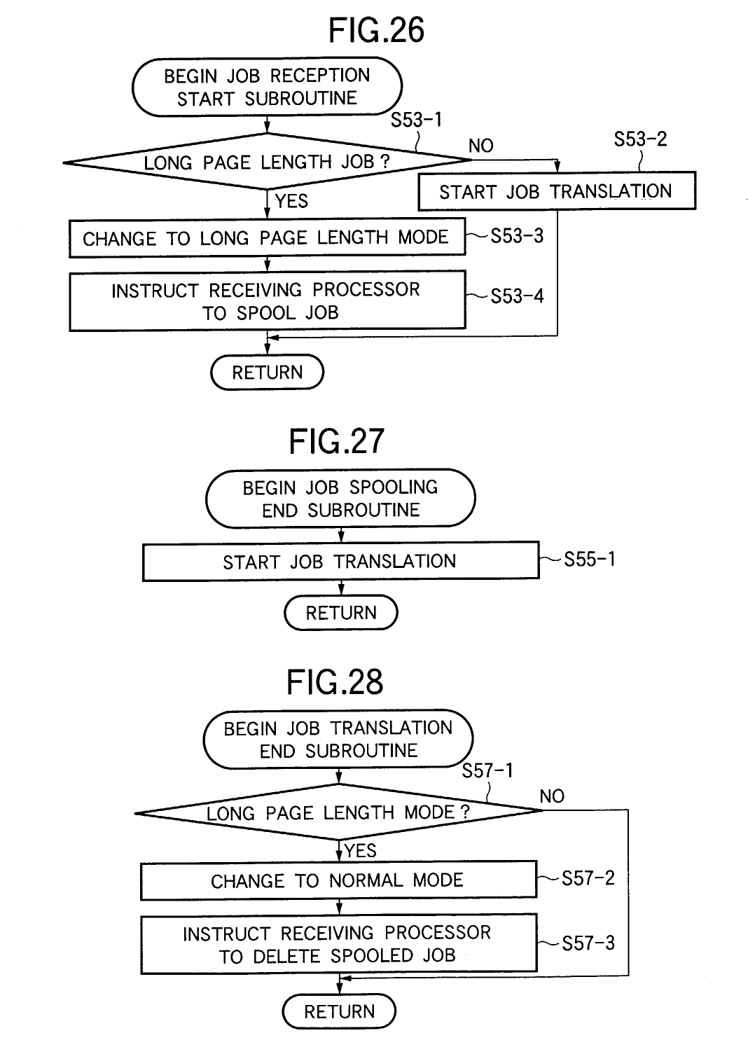

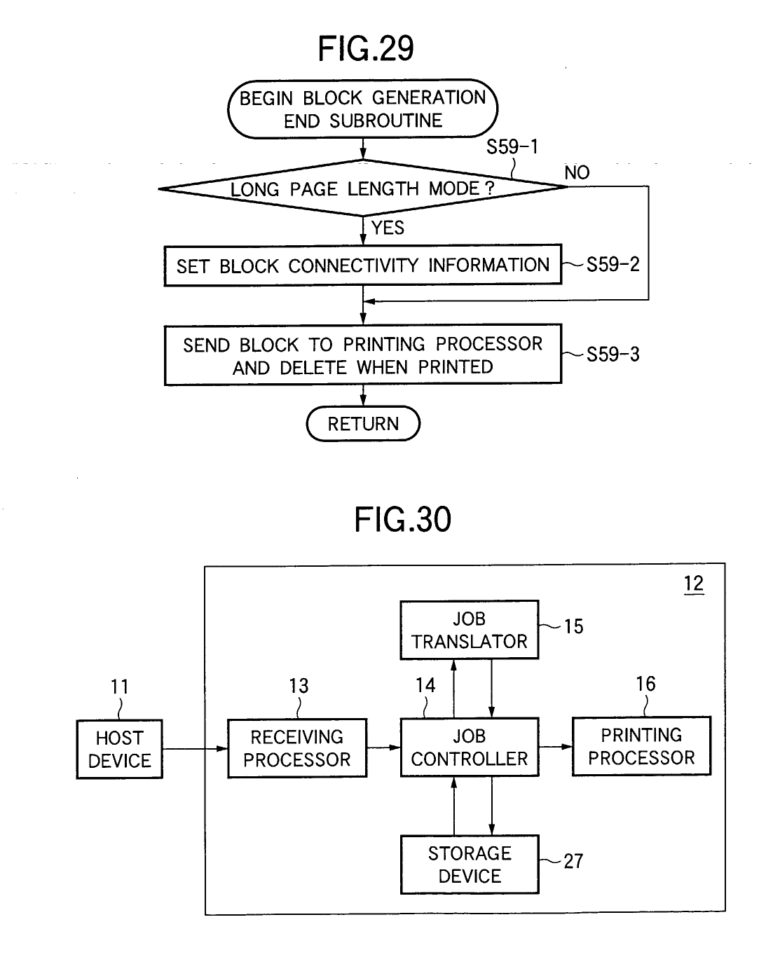

Next, the operation of the job controller 14 in the seventh embodiment will be described. FIG. 25 illustrates the main routine executed by the job controller. FIG. 26 illustrates the subroutine that starts receiving a job. FIG. 27 illustrates the subroutine that ends job spooling. FIG. 28 illustrates the subroutine that ends job translation. FIG. 29 illustrates the subroutine that ends block generation.

When a job reception event occurs, a job reception processor (not shown in the drawings) in the job controller 14 performs processing to start job reception, and determines whether the printing job has a long page length. If the printing job does not have a long page length, the job controller 14 instructs the job translator 15 to begin normal job translation. If the printing job has a long page length, the job controller 14 changes the printing mode to the long page length mode and instructs the receiving processor 13 to spool the print data. The receiving processor 13 then receives the blocks of print data from the host interface, stores them in the storage device 27, and informs the job controller 14 when the entire job has been spooled in this way.

When the spooling of the job ends, a job spooling termination processor (not shown in the drawings) in the job controller 14 instructs the job translator 15 to start job translation. The job translator 15 translates the blocks of print data in the normal way, except that it reads the data from the storage device 27 instead of from the host interface.

When the generation of a block of image data ends, a block generation termination processor (not shown in the drawings) in the job controller 14 decides whether the current operating mode is the long page length mode, sets block connectivity information in the block if the current operating mode is the long page length mode, and sends the block of image data to the printing processor 16.

When the entire job has been translated, a job translation termination processor (not shown in the drawings) in the job controller 14 terminates the job translation process. If the job controller 14 is operating in the long page length mode, the job translation termination processor also restores the normal printing mode and instructs the receiving processor 13 to delete the spooled data. The receiving processor 13 then deletes the spooled print data from the storage device 27.

In the seventh embodiment, a page printer can print pages with a long page length without the risk of overrun due to a low-speed host interface, because as described above, the print data are first stored in the high-speed storage device 27. The job translator 15 can obtain the data blocks as fast they can be read from the storage device 27.

The flow chart in FIG. 25 illustrates the main routine in the operation described above.

Step S51: Wait for an event to occur.

Step S52: Decide whether a job reception event has occurred. If so, go to step S53. If not, go to step S54.

Step S53: Carry out processing to start job reception; then return to step S51.

Step S54: Decide whether an end-of-job-spooling event has occurred. If so, go to step S55. If not, go to step S56.

Step S55: Carry out processing to end job spooling; then return to step S51.

Step S56: Decide whether an end-of-job-translation event has occurred. If so, go to step S57. If not, go to step S58.

Step S57: Carry out processing to end job translation; then return to step S51.

Step S58: Decide whether an end-of-block-generation event has occurred. If so, go to step S59. If not, go to step S51.

Step S59: Carry out processing to end block generation; then return to step S51.

The flow chart in FIG. 26 shows the subroutine that carries out step S53.

Step S53-1: Decide whether the current job has a long page length. If so, go to step S53-3. If not, go to step S53-2.

Step S53-2: Instruct the job translator 15 to start translation; then return.

Step S53-3: Change the operating mode to the long page length mode.

Step S53-4: Instruct the receiving processor 13 to spool the job; then return.

The flow chart in FIG. 27 shows the subroutine that carries out step S55.

Step S55-1: Instruct the job translator 15 to start translation; then return.

The flow chart in FIG. 28 shows the subroutine that carries out step S57.

Step S57-1: Decide whether the long page length mode is selected. If so, go to step S57-2. If not, return.

Step S57-2: Change the operating mode to the normal mode.

Step S57-3: Instruct the receiving processor 13 to delete the spooled job; then return.

The flow chart in FIG. 29 shows the subroutine that carries out step S59.

Step S59-1: Decide whether the long page length mode is selected. If so, go to step S59-2. If not, go to step S59-3.

Step S59-2: Add block connectivity information.

Step S59-3: Send the block to the printing processor 16; delete the block when it has been printed; then return.

The eighth embodiment, described next, addresses the problem of overrun due to such factors as the size or complexity of the print data, or the processing speed of the job translator.

Referring to FIG. 30, the printing device 12 in the eighth embodiment comprises a receiving processor 13, a job controller 14, a job translator 15, and a printing processor 16 as described in the first embodiment, and a storage device 27, such as a hard disk or RAM disk, that is accessed by the job controller 14.

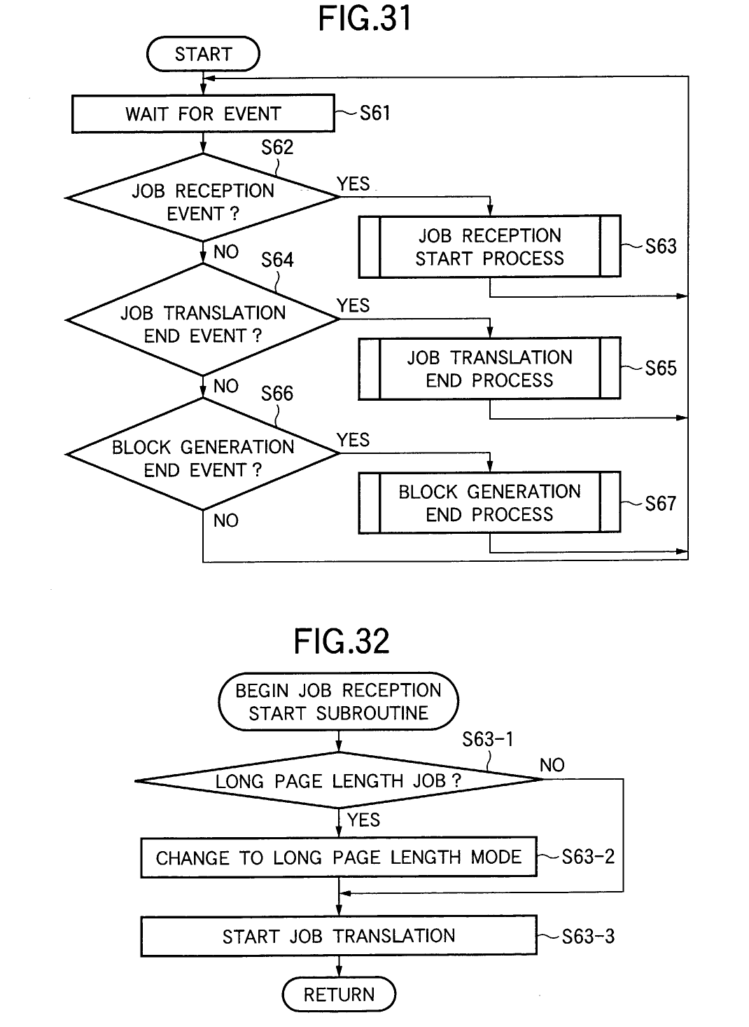

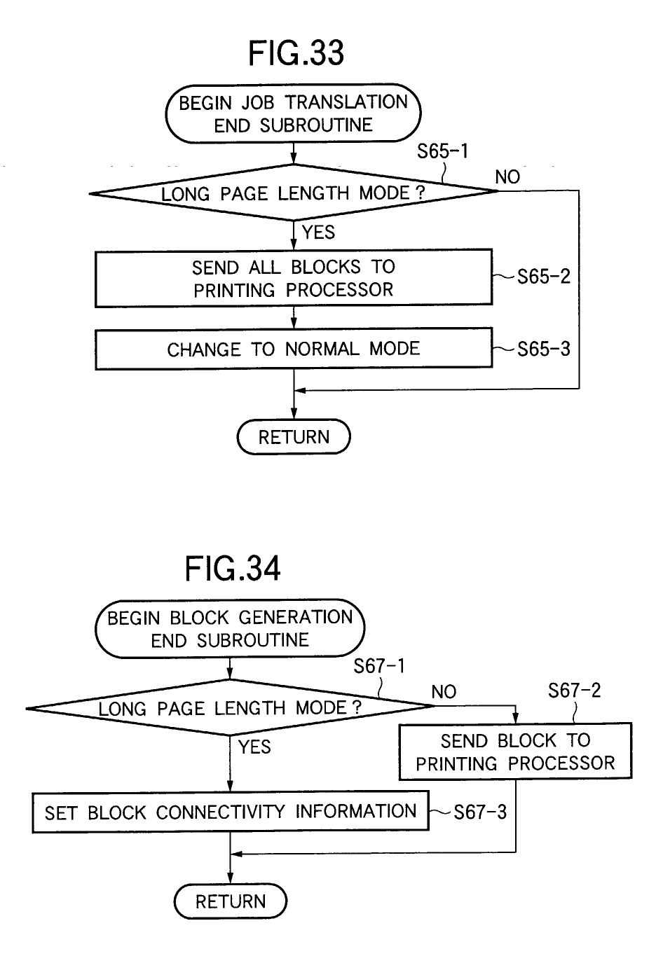

Next, the operation of the job controller 14 in the eighth embodiment will be described with reference to FIGS. 31 to 34. FIG. 31 illustrates the main routine executed by the job controller 14. FIG. 32 illustrates the subroutine that starts receiving a job. FIG. 33 illustrates the subroutine that ends job translation. FIG. 34 illustrates the subroutine that ends block generation.

When a job reception event occurs, a job reception processor (not shown in the drawings) in the job controller 14 determines whether the printing job has a long page length. If the printing job has a long page length, the job controller 14 changes the printing mode to the long page length mode. Regardless of the page length, the job controller 14 then instructs the job translator 15 to begin job translation. The job translator 15 translates the blocks of print data in the normal way, and informs the job controller 14 when each block of image data has been generated and when the entire job translation process is completed. The job controller 14 detects these events.

When an end-of-block-generation event occurs, a block generation termination processor (not shown in the drawings) in the job controller 14 performs end-of-block-generation processing by sending the generated image data block to the printing processor 16 if the printing mode is the normal mode, and setting block connectivity information in the block if the printing mode is the long page length mode.

When an end-of-job-translation event occurs, a job translation termination processor (not shown in the drawings) in the job controller 14 terminates the job translation process. If the job controller 14 is operating in the long page length mode, the job translation termination processor sends all generated blocks to the printing processor 16, then restores the normal printing mode.

In the eighth embodiment, the blocks making up a physical page are not sent to the printing processor 16 until they have all been translated, so regardless of the size or complexity of the original print data blocks, the processing speed of the job translator 15, and the consequent length of time taken by the translation process, the printing processor 16 receives all the blocks in time to print the page without overrun. If the job translator 15 runs out of memory space during the translation process, the job controller 14 frees up memory space by transferring one or more of the image data blocks generated so far to the storage device 27, enabling the job translator 15 to continue translation. Thus, some or all of the blocks may be sent to the printing processor 16 from the storage device 27. After each block of image data has been sent to the printing processor 16, it is deleted from the storage device 27, or from the memory area used by the job translator 15.

The flow chart in FIG. 31 shows the main routine in the operation described above.

Step S61: Wait for an event to occur.

Step S62: Decide whether a job reception event has occurred. If so, go to step S63. If not, go to step S64.

Step S63: Carry out processing to start job reception; then return to step S61.

Step S64: Decide whether an end-of-job-translation event has occurred. If so, go to step S65. If not, go to step S66.

Step S65: Carry out processing to end job translation; then return to step S61.

Step S66: Decide whether an end-of-block-generation event has occurred. If so, go to step S67. If not, return to step S61.

Step S67: Carry out processing to end block generation; then return to step S61.

The flow chart in FIG. 32 shows the subroutine that carries out step S63.

Step S63-1: Decide whether the current job is to be printed in the long page length mode. If so, go to step S63-2. If not, go to step S63-3.

Step S63-2: Change the printing mode to the long page length mode.

Step S63-3: Instruct the job translator 15 to start translation; then return.

The flow chart in FIG. 33 shows the subroutine that carries out step S65.

Step S65-1: Decide whether the long page length mode is selected. If so, go to step S65-2. If not, end the processing.

Step S65-2: Send all the blocks to the printing processor 16.

Step S65-3: Change the operating mode to the normal mode; then return.

The flow chart in FIG. 34 shows the subroutine that carries out step S67.

Step S67-1: Decide whether the long page length mode is selected. If so, go to step S67-3. If not, go to step S67-2.

Step S67-2: Send the block to the printing processor 16; then return.

Step S67-3: Add block connectivity information; then return.

The printing control methods used in the preceding embodiments can be combined. For example, the method of the seventh embodiment can be combined with the method of any of the first six embodiments to prevent overrun due to the transfer rate on the host interface. The method of the eighth embodiment can be combined with the method of any of the first six embodiments to prevent overrun due to data size or complexity, or the processing speed of the data translation process.

In the seventh and eighth embodiments, each block of data read from the storage device 27 was deleted after being read. Each block of image data sent to the printing processor 16 is also deleted from the memory area used by the printing processor 16 after being printed. In the long page length mode, accordingly, if a paper jam or other error condition occurs in the course of the printing of a page, it is not possible to restart printing from the top of the page, because the first data block on the page is no longer present in the printing device. Thus the printing device may be unable to recover from the error, and the host device may have to resend some or all of the print data.

Incidentally, a paper jam is an event in which paper fails to be transported correctly inside the printing device. To recover from a paper jam, it is necessary to open the printer, remove the jammed paper, and then resume printing on a new sheet of paper, from the top of the page that jammed. Other types of printing errors require similar recovery procedures.

A conventional method of enabling a printer to recover from such errors is to save each block of bit-mapped image data or intermediate data temporarily in a RAM area or other storage area. A similar method is adopted in the ninth embodiment, described below.

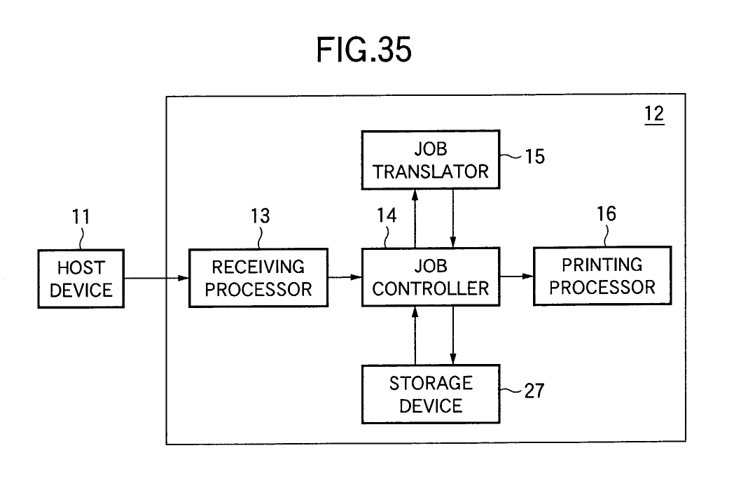

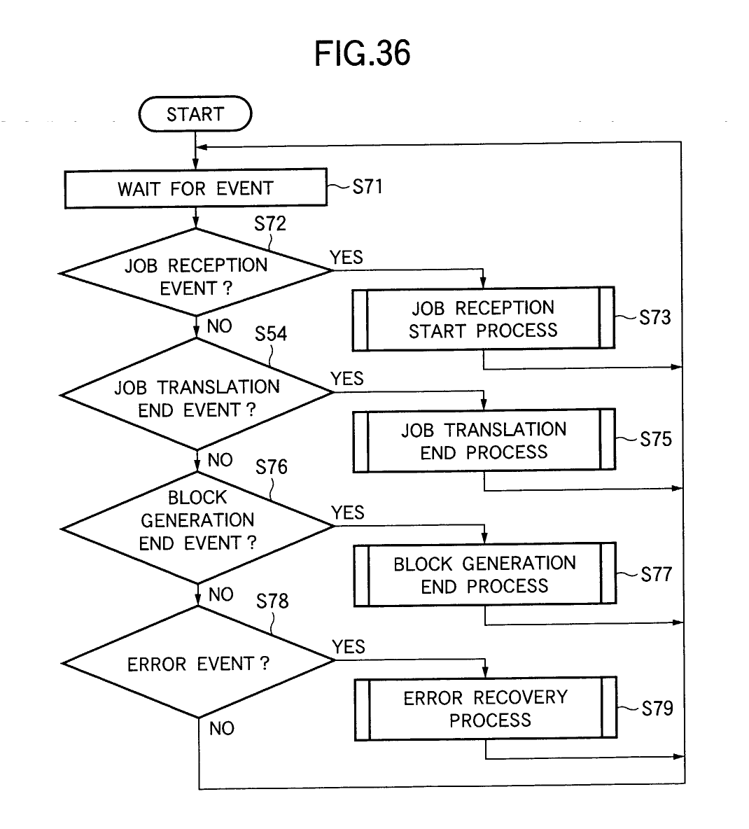

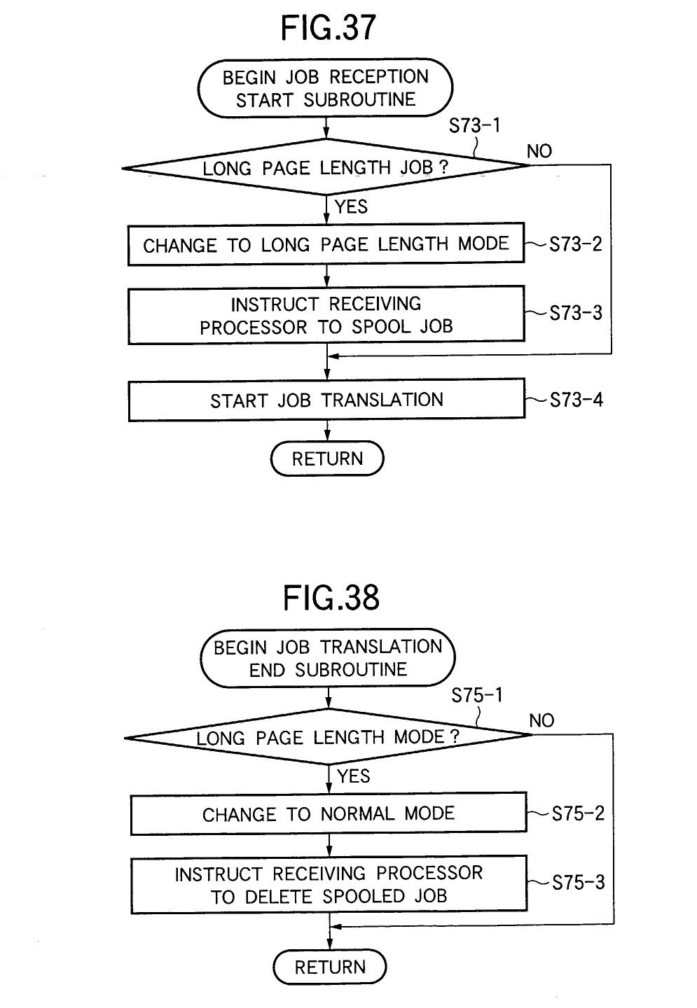

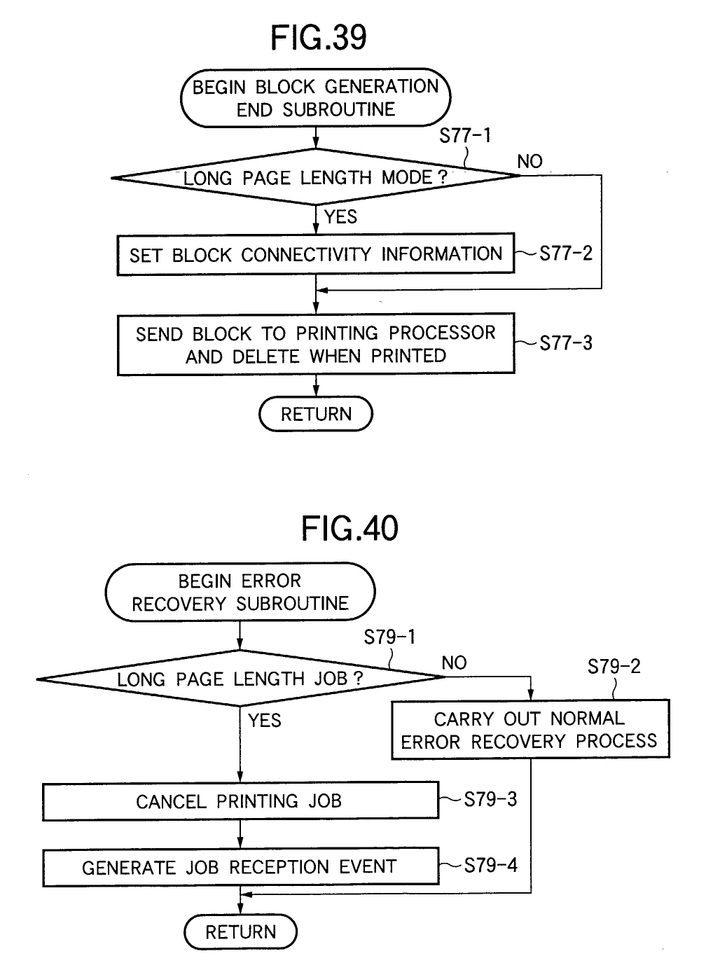

Referring to FIG. 35, the printing device 12 has the same structure in the ninth embodiment as in the seventh embodiment, but operates differently. FIG. 36 illustrates the main routine executed by the job controller 14 in the ninth embodiment. FIG. 37 illustrates the subroutine that starts receiving a job. FIG. 38 illustrates the subroutine that ends job translation. FIG. 39 illustrates the subroutine that ends block generation. FIG. 40 illustrates the subroutine that performs error recovery processing.

When a job reception event occurs, a job reception processor (not shown in the drawings) in the job controller 14 performs processing to start job reception, and determines whether the printing job has a long page length. If the printing job does not have a long page length, the job controller 14 instructs the job translator 15 to begin job translation. If the printing job has a long page length, the job controller 14 changes the printing mode to the long page length mode and instructs the receiving processor 13 to spool the print data. The receiving processor 13 receives the blocks of print data from the host interface, stores them in the storage device 27, and sends them to the job translator 15. The receiving processor 13 may, for example, wait until all data blocks for one physical page have been stored in the storage device 27, then send these blocks from the storage device 27 to the job translator 15. Alternatively, the receiving processor 13 may send each block directly to the job translator 15 and have the job translator 15 store each block in the storage device 27. In either case, when the blocks of print data have been stored in the storage device 27, the job controller 14 is notified and the job translator 15 is instructed to begin translation.

The job translator 15 translates the blocks of print data in the normal way, regardless of the page length, and regardless of whether it receives the print data directly from the host interface or from the storage device 27.

When job translation ends, if the printing mode is the long page length mode, a job translation termination processor (not shown in the drawings) in the job controller 14 changes the mode back to the normal printing mode and instructs the receiving processor 13 to delete the spooled data. The receiving processor 13 deletes the spooled print data from the storage device 27.

At the end of the generation of each block of image data, a block generation termination processor (not shown in the drawings) in the job controller 14 sends the generated image data block to the printing processor 16, also setting block connectivity information in the block if the current operating mode is the long page length mode.

If an error occurs during the printing of a page, an error recovery processor (not shown in the drawings) in the job controller 14 performs error recovery processing. First, the error recovery processor must determine whether the job is being printed in the long page length mode. Since the job translation process may already have ended and the job controller 14 may have been reset to the normal mode, the error recovery processor may use other information to determine the job mode. For example the job may have job identification information indicating whether the job has a long page length, or the mode may be determined from the presence or absence of block connectivity information.

If the job is being printed in the long page length mode, the error recovery processor cancels the job, reads the print data stored in the storage device 27, and generates a new job reception event, as if the print data were being read from the host interface. Since the print data are not deleted from the storage device 27 until all pages have been translated, this usually enables the printing process to be re-executed from the first block.

The flow chart in FIG. 36 illustrates the main routine in the operation described above.

Step S71: Wait for an event to occur.

Step S72: Decide whether a job reception event has occurred. If so, go to step S73. If not, go to step S74.

Step S73: Carry out processing to start job reception; then return to step S71.

Step S74: Decide whether an end-of-job-translation event has occurred. If so, go to step S75. If not, go to step S76.

Step S75: Carry out processing to end job translation; then return to step S71.

Step S76: Decide whether an end-of-block-generation event has occurred. If so, go to step S77. If not, go to step S78.

Step S77: Carry out processing to end block generation; then return to step S71.

Step S78: Decide whether an error event has occurred. If so, go to step S79. If not, return to step S71.

Step S79: Carry out error recovery processing; then return to step S71.

The flow chart in FIG. 37 shows the subroutine that carries out step S73.

Step S73-1: Decide whether the current job has a long page length. If so, go to step S73-3. If not, go to step S73-4.

Step S73-2: Change the operating mode to the long page length mode.

Step S73-3: Instruct the receiving processor 13 to spool the job.

Step S73-4: Instruct the job translator 15 to start translation; then return.

The flow chart in FIG. 38 shows the subroutine that carries out step S75.

Step S75-1: Decide whether the long page length mode is selected. If so, go to step S75-2. If not, return.

Step S75-2: Change the operating mode to the normal mode.

Step S75-3: Instruct the receiving processor 13 to delete the spooled job; then return.

The flow chart in FIG. 39 shows the subroutine that carries out step S77.

Step S77-1: Decide whether the long page length mode is selected. If so, go to step S77-2. If not, go to step S77-3.

Step S77-2: Add block connectivity information.

Step S77-3: Send the block to the printing processor 16; delete the block when it has been printed; then return.

The flow chart in FIG. 40 shows the subroutine that carries out step S79.

Step S79-1: Decide whether the current job has a long page length. If so, go to step S79-3. If not, go to step S79-2.

Step S79-2: Carry out normal error recovery processing; then return.

Step S79-3: Cancel the printing job.

Step S79-4: Generate a job reception event; then return.

In the tenth embodiment, described next, the printing device 12 is capable of operating in a collating mode in which, if so instructed by the host device 11, it prints multiple copies of each page, even though the host device 11 sends the data for each page only once. The functions of the printing device 12 that enable the printing of multiple copies can also be used for error recovery.

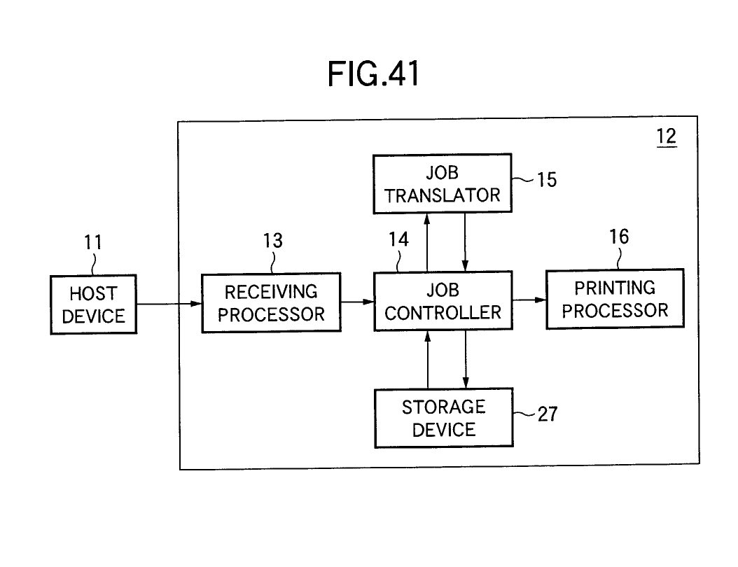

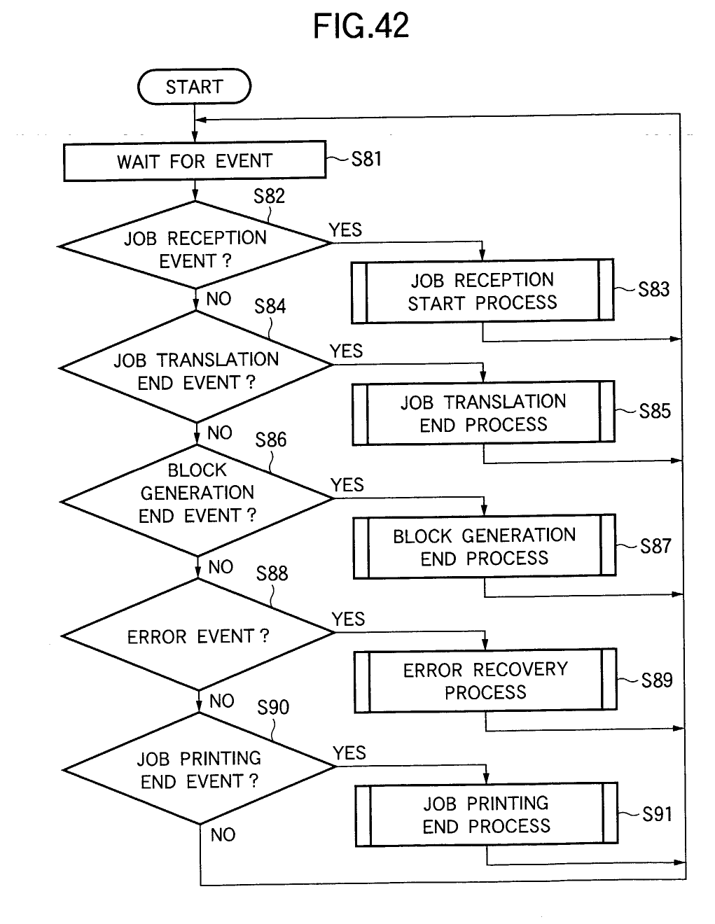

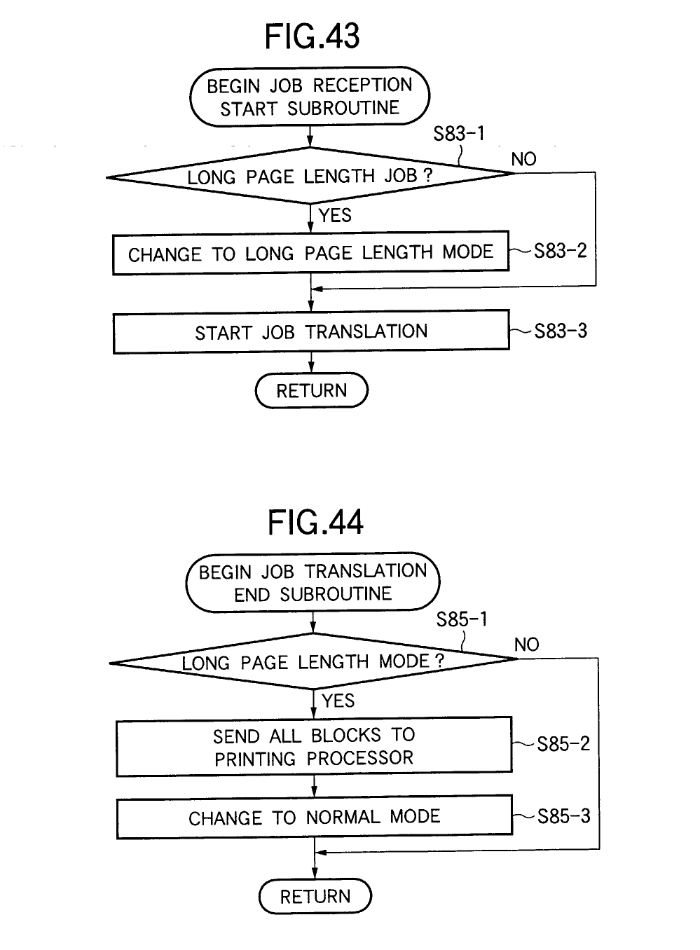

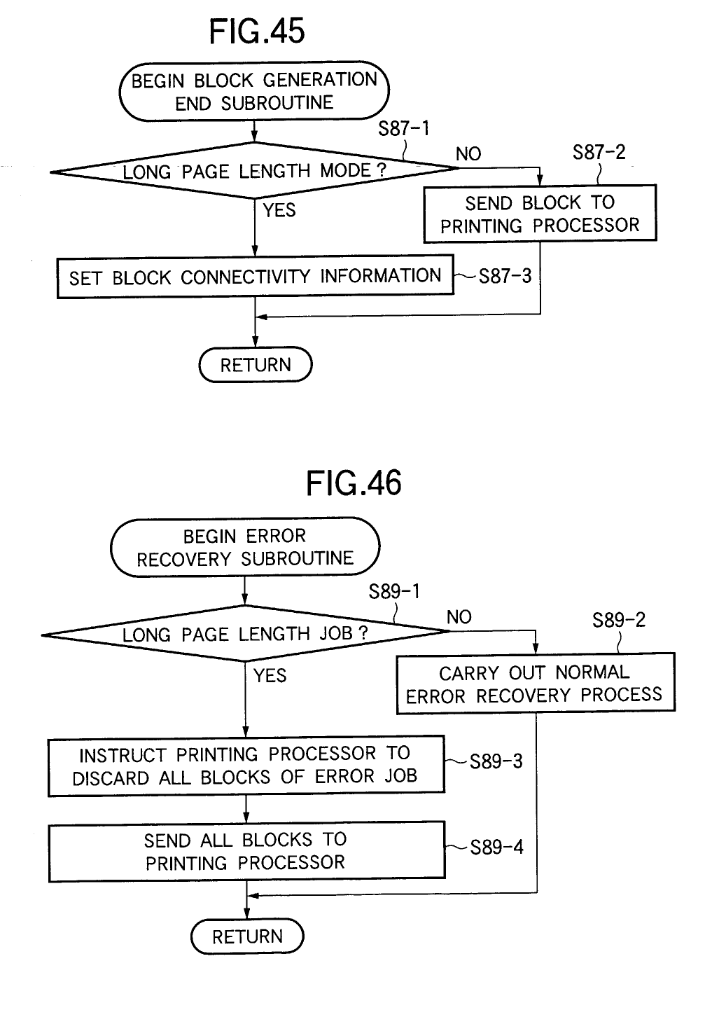

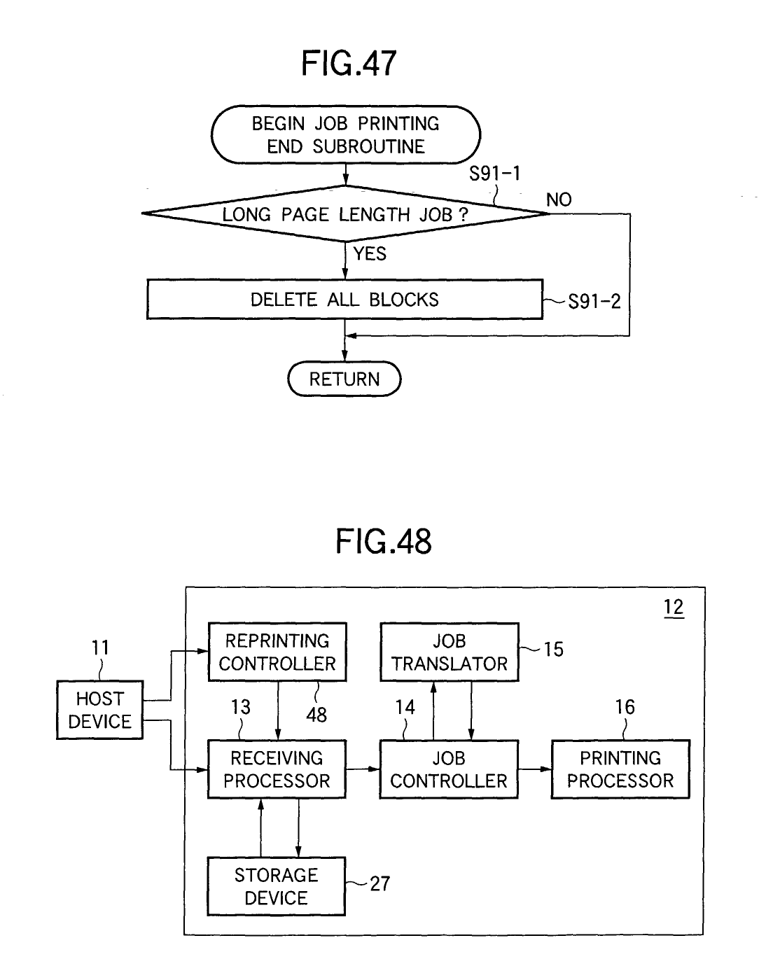

Referring to FIG. 41, the printing device 12 has the same structure in the twelfth embodiment as in the eighth embodiment, but operates differently. FIG. 42 illustrates the main routine executed by the job controller 14 in the twelfth embodiment. FIG. 43 illustrates the subroutine that starts receiving a job. FIG. 44 illustrates the subroutine that ends job translation. FIG. 45 illustrates the subroutine that ends block generation. FIG. 46 illustrates the error recovery subroutine. FIG. 47 illustrates the subroutine that ends the printing process.

When a job reception event occurs, a job reception processor (not shown in the drawings) in the job controller 14 determines whether the printing job has a long page length. If the printing job has a long page length, the job reception processor changes the printing mode to the long page length mode. Regardless of the page length, the job reception processor instructs the job translator 15 to begin job translation. The job translator 15 translates the blocks of print data in the normal way, and informs the job controller 14 when each block of image data has been generated and when the entire job translation process is completed. The job controller 14 detects these events.

When an end-of-block-generation event occurs, a block generation termination processor (not shown in the drawings) in the job controller 14 performs end-of-block-generation processing by sending the generated image data block to the printing processor 16 if the printing mode is the normal mode, and setting block connectivity information in the block if the printing mode is the long page length mode.

When an end-of-job-translation event occurs, a job translation termination processor (not shown in the drawings) in the job controller 14 terminates the job translation process. If the job controller 14 is operating in the long page length mode, the job translation termination processor sends all generated blocks to the printing processor 16, then restores the normal printing mode.

When the printing processor 16 receives the blocks for a job having a long page length, it prints them according to the connectivity information. To enable the printing device 12 to print multiple copies of each page, the blocks are not deleted after being sent to the printing processor 16, but remain stored in a RAM area or other storage area used by the job translator 15. If this storage area is exhausted, the job controller 14 stores the generated blocks in the storage device 27 so that the job translator 15 can continue job translation.

If an error occurs during the printing of a page, an error recovery processor (not shown in the drawings) in the job controller 14 determines whether the job is being printed in the long page length mode. If the job is being printed in the long page length mode, the error recovery processor instructs the printing processor 16 to delete all blocks of the page or job in which the error occurred, then reads all the blocks from the above-mentioned storage area, or from the storage device 27, and sends them to the printing processor 16 again. If the job is not being printed in the long page length mode, the error recovery processor performs normal error recovery processing.

When the printing of the job ends, a job printing termination processor (not shown in the drawings) in the job controller 14 determines whether the job is being printed in the long page length mode. If the job is being printed in the long page length mode, the job printing termination processor restores the normal mode and deletes all the blocks stored in the storage area used by the job translator 15, or stored in the storage device 27.

In the tenth embodiment, the blocks making up a printing job remain stored in the printing device 12 to enable the printing of multiple copies of a page, so if an error occurs, the stored blocks can be used to recover from the error by reprinting the necessary page or pages, starting from the first block, even in the long page length mode.

The flow chart in FIG. 42 illustrates the main routine in the operation described above.

Step S81: Wait for an event to occur.

Step S82: Decide whether a job reception event has occurred. If so, go to step S83. If not, go to step S84.

Step S83: Carry out processing to start job reception; then return to step S81.

Step S84: Decide whether an end-of-job-translation event has occurred. If so, go to step S85. If not, go to step S86.

Step S85: Carry out processing to end job translation; then return to step S81.

Step S86: Decide whether an end-of-block-generation event has occurred. If so, go to step S87. If not, go to step S88.

Step S87: Carry out processing to end block generation; then return to step S81.

Step S88: Decide whether an error event has occurred. If so, go to step S89. If not, go to step S90.

Step S89: Carry out error recovery processing; then return to step S81.

Step S90: Decide whether an end-of-job-printing event has occurred. If so, go to step S91. If not, return to step S81.

Step S91: Carry out processing to end job printing; then return to step S81.

The flow chart in FIG. 43 shows the subroutine that carries out step S83.

Step S83-1: Decide whether the current job has a long page length. If so, go to step S83-2. If not, go to step S83-3.

Step S83-2: Change the operating mode to the long page length mode.

Step S83-3: Instruct the job translator 15 to start translation; then return.

The flow chart in FIG. 44 shows the subroutine that carries out step S85.

Step S85-1: Decide whether the long page length mode is selected. If so, go to step S85-2. If not, return.

Step S85-2: Send all the blocks to the printing processor 16.

Step S85-3: Change the operating mode to the normal mode; then return.

The flow chart in FIG. 45 shows the subroutine that carries out step S87.

Step S87-1: Decide whether the long page length mode is selected. If so, go to step S87-3. If not, go to step S87-2.

Step S87-2: Send the block to the printing processor 16; then return.

Step S87-3: Add block connectivity information; then return.

The flow chart in FIG. 46 shows the subroutine that carries out step S89.

Step S89-1: Decide whether the current job has a long page length. If so, go to step 889-3. If not, go to step S89-2.

Step S89-2: Carry out normal error recovery processing; then return.

Step S89-3: Instruct the printing processor 16 to discard all the blocks of the printing job in which the error has occurred; then return.

Step S89-4: Send all the blocks to the printing processor 16; then return.

The flow chart in FIG. 47 shows the subroutine that carries out step S91.

Step S91-1: Decide whether the current job has a long page length. If so, go to step S91-2. If not, return.

Step S91-2: Delete all the blocks; then return.

In the preceding embodiments, when an entire job is printed repeatedly, the host device 11 must send the print data to the printing device 12 repeatedly. In the long page length mode, since the printing device 12 may be printing on paper P with an extremely long length, transferring the print data from the host device 11 to the printing device 12 can take much longer than for a job printed in the normal mode, so if the transfer has to be performed repeatedly, much time is consumed. The eleventh embodiment, described below, enables a job to be printed repeatedly even if the host device 11 sends the print data only once. This repeated printing function is not limited to the long page length mode, but can also be used in the normal printing mode.

Referring to FIG. 48, the printing device 12 in the twelfth embodiment comprises a receiving processor 13, a job controller 14, a job translator 15, a printing processor 16, and a storage device 27 as described in the seventh embodiment. The storage device 27 is a nonvolatile storage device such as a hard disk. The printing device 12 also comprises a reprinting controller 48.

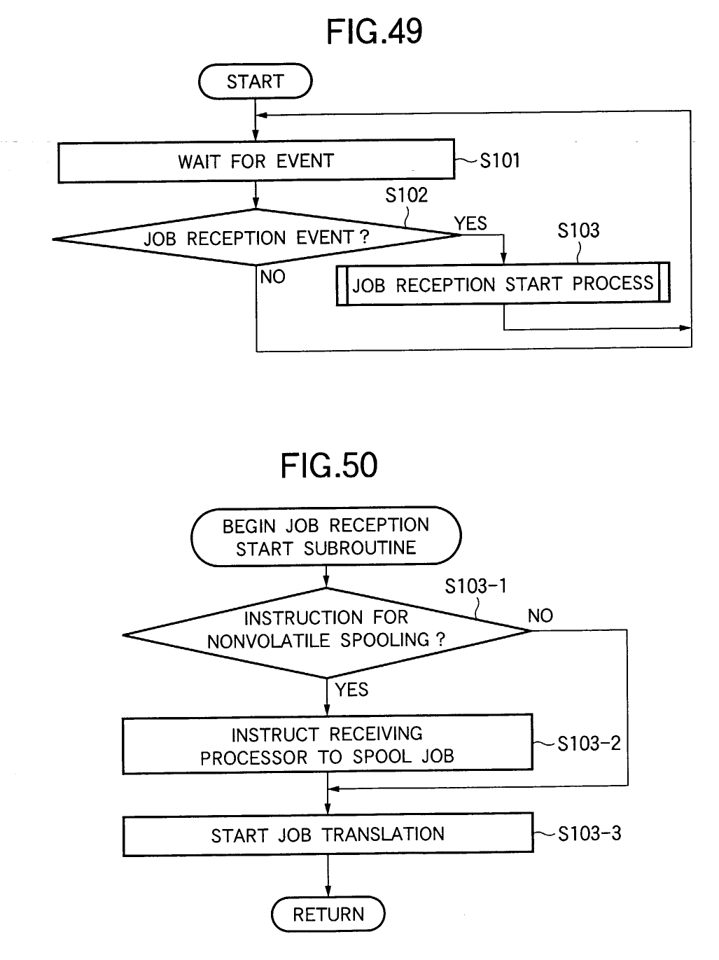

The operation of the job controller 14 in the eleventh embodiment will be described with reference to FIGS. 49 and 50. FIG. 49 is a flow chart illustrating the operation of the job controller; FIG. 50 is a flow chart illustrating a subroutine that starts receiving a job.

When a job reception event occurs, a job reception processor (not shown in the drawings) in the job controller 14 performs processing to start job reception, and determines whether the job is accompanied by an instruction for nonvolatile spooling. If so, the job reception processor instructs the receiving processor 13 to spool the print data, and the receiving processor 13-stores the received print data in the storage device 27. The job reception processor also instructs,the job translator 15 to start job translation.

The flow chart in FIG. 49 shows the main routine of the operation described above.

Step S101: Wait for an event to occur.

Step S102: Decide whether a job reception event has occurred. If so, go to step S103. If not, return to step S101.

Step S103: Carry out processing to start job reception; then return to step S101.

The flow chart in FIG. 50 shows the subroutine that carries out step S103.

Step S103-1: Decide whether there is an instruction for nonvolatile spooling. If so, go to step S103-2. If not, go to step S103-3.

Step S103-2: Instruct the receiving processor 13 to spool the job.

Step S103-3: Instruct the job translator 15 to start job translation; then return.

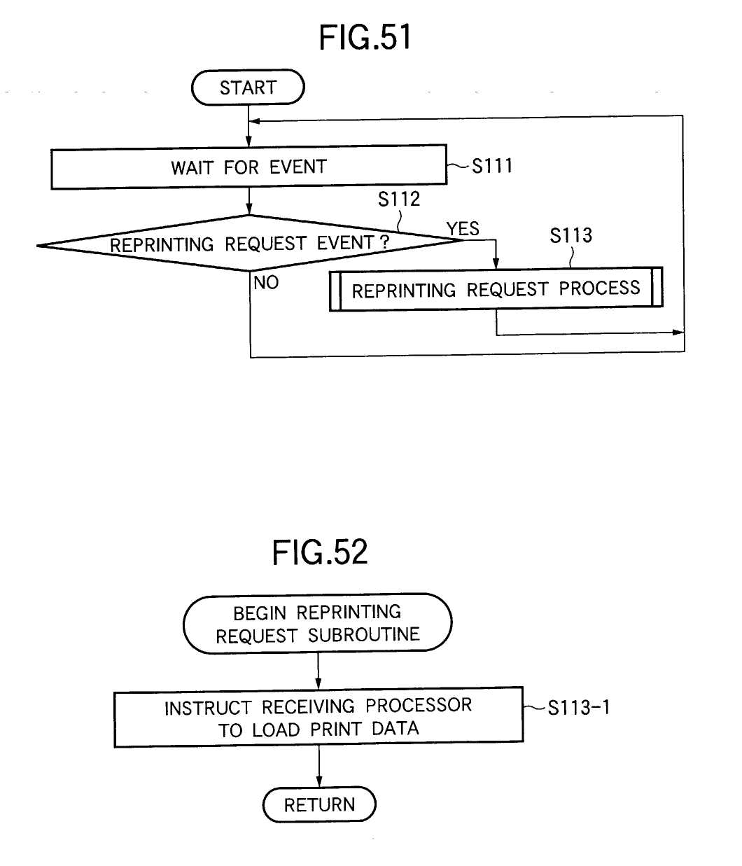

The operation of the reprinting controller 48 in the eleventh embodiment will be described with reference to FIGS. 51 and 52. FIG. 51 is a flow chart illustrating the main routine executed by the reprinting controller 48; FIG. 52 illustrates a subroutine that processes reprinting requests.

As shown in FIG. 51, the reprinting controller 48 executes an endless loop in which it waits for a certain event to occur. More specifically, it waits for the reprinting of a job to be requested. The request can be made from, for example, a control panel (not shown in the drawings) of the printing device 12, or a utility program in the host device 11, provided the job was originally accompanied by a nonvolatile spooling instruction and has been stored in the storage device 27.

When a job reprinting request occurs, a reprinting request processor (not shown in the drawings) in the reprinting controller 48 instructs the receiving processor 13 to load the print data of the job from the storage device 27 into the job controller 14. The job is then printed in the usual way, without the need to transfer the print data from the host device 11 to the printing device 12 again.

Since the print data are stored in the storage device 27, they remain stored even after the printing job is completed and the printing device 12 is powered off. The job can accordingly be reprinted at an arbitrary time later.

The flow chart in FIG. 51 shows the main routine of the operation described above.

Step S111: Wait for an event to occur.

Step S112: Decide whether a reprinting request event has occurred. If so, go to step S113. If- not, return to step S111.

Step S113: Process the reprinting request; then return to step S111.

The flow chart in FIG. 52 shows the subroutine that carries out step S113.

Step S113-1: Instruct the receiving processor 13 to load the print data; then return.

To position the printing correctly on the page, it is necessary to sense the position of the beginning of the page. In the normal printing mode, this is accomplished by a sensor, not shown in the drawings, that senses the leading edge of the paper.

In the long page length mode, it may be similarly necessary to sense the beginning of each logical page, but the sensor can sense only the beginning of the first logical page on the physical page P (FIG. 10). The twelfth embodiment, described next, provides means for sensing the beginning of the other logical pages, so that the printing of each logical page can start at the right time. Specifically, in the twelfth embodiment, paper transport is driven by a stepper motor, and the boundary between one logical page and the next is located by counting the electrical pulses that drive the stepper motor.

The printing device 12 in the twelfth embodiment is a color printer employing different printing heads for different primary colors. Normally, a frame synchronizing signal (Frame Sync) is used to request image data for each print head; the Frame Sync signal is switched on at the beginning of a page and off at the end of the page. In the long page length mode, however, the Frame Sync signal is not switched off between different logical pages, so that the image data can be printed continuously, without breaks between logical pages.

In the following description, the switching on of the Frame Sync signal will be referred to as a Frame-Sync-on event; the switching off of the Frame Sync signal will be referred to as a Frame-Sync-off event; and the recognition of these events will be referred to as a Frame-Sync-on acceptance event or a Frame-Sync-off acceptance event.

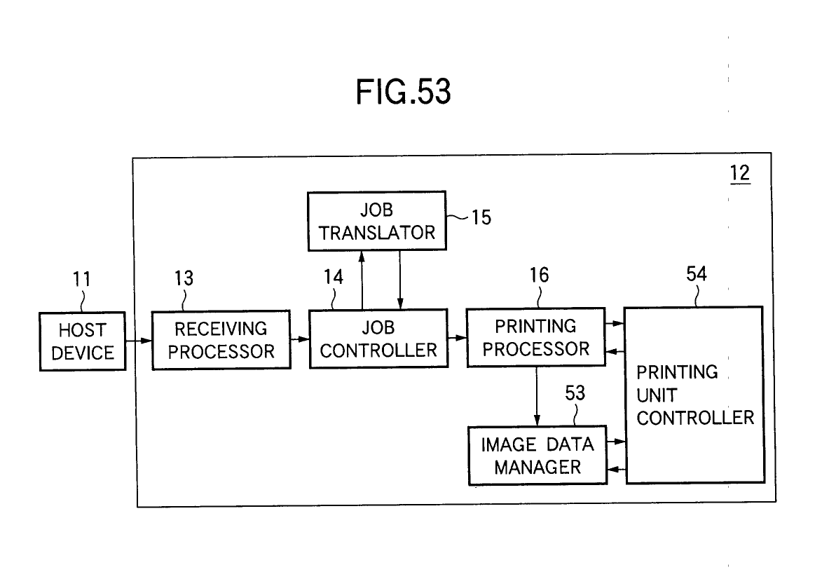

Referring to FIG. 53, the printing device 12 in the twelfth embodiment comprises a receiving processor 13, a job controller 14, a job translator 15, and a printing processor 16 as described in the first embodiment, and an image data manager 53 and a printing unit controller 54, both of which are connected to the printing processor 16. The printing processor 16 receives data blocks from the job controller 14, and exchanges command signals with the printing unit controller 54, thereby instructing the printing unit controller 54 to print pages.

The image data manager 53 receives the data blocks from the printing processor 16, manages the data therein, and receives Frame Sync signals from the printing unit controller 54. While a Frame Sync signal is in the ‘on’ state, the image data manager 53 sends image data to the printing unit controller 54. In the long page length mode, the image data manager 53 connects blocks and sends a continuous stream of data, spanning multiple logical pages, to the printing unit controller 54.

Besides sending the Frame Sync signal to the image data manager 53, the printing unit controller 54 exchanges commands with the printing processor 16. To control the timing of these command exchanges, when printing on paper P (FIG. 10) with a long page length, the printing unit controller 54 counts the pulses supplied to the stepper motor (not shown in the drawings) that drives the paper transport mechanism and thereby recognizes the boundaries between logical pages.

The purpose of the Frame Sync signal is to synchronize the sending and receiving of data blocks representing, in the long page length mode, logical pages. When the Frame Sync signal is in the ‘on’ state, the image data manager 53 sends data from the image blocks to the printing unit controller 54 on an image data signal line, and the printing unit controller 54 receives the data.

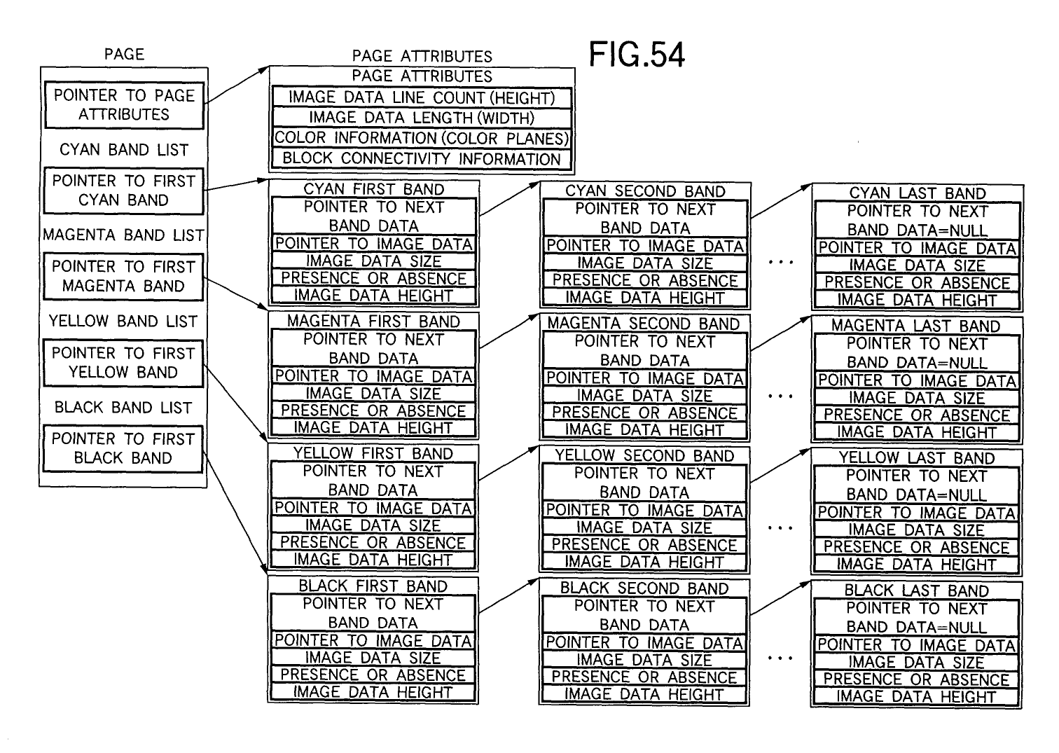

FIG. 54 shows the data structure of a block in the twelfth embodiment. A logical page has page attributes indicating such information as the number of lines of image data on the page (the page height), the line length (the page width), the primary color planes (cyan, magenta, yellow, black) present on the page, and block connectivity information. For each primary color, the page has a band list, which is managed by a pointer to the first band, or more precisely, by a pointer to a block of band data for the first band.

The band data for the first band of each color include a pointer to the second band, a pointer to the image data of the first band, and information such as the size of the image data, the presence or absence of the image data, and the height of the image data. Each subsequent band similarly includes a pointer to the next band, a pointer to the image data, and other information such as the size, presence or absence, and height of the image data. For the last band, the pointer to the next band data is a null pointer.

Next, the operation of the printing device 12 in the twelfth embodiment will be described.

The commands passed between the printing processor 16 and printing unit controller 54 include, for example, a CUSTOMBYDOT command, a PAGECONNECT command, a PAGECOLOR command, a PREFEED command, a PRINT command, a PPOUT command, and a PRINTREADY command.

The printing processor 16 uses the CUSTOMBYDOT command to inform the printing unit controller 54 of the equivalent paper length of each logical page. The equivalent paper length, referred to below as the logical length or logical paper length, is expressed as, for example, the number of lines of image data on the logical page, counted from what would be the leading edge to what would be the trailing edge of a hypothetical sheet of paper having the same length as the logical page.

The printing processor 16 uses the PAGECONNECT command to inform the printing unit controller 54 of the block connectivity information for each block. The block connectivity information indicates whether the block is the first block, an intermediate block, or the last block on the physical page.

The printing processor 16 uses the PAGECOLOR command to inform the printing unit controller 54 of the primary colors making up the page. In a printer employing cyan, magenta, yellow, and black toner, the presence or absence of cyan, magenta, yellow, and black color planes is indicated.

The printing processor 16 uses the PREFEED command to tell the printing unit controller 54 to start feeding the paper P (FIG. 10), and the PRINT command to tell the printing unit controller 54 to start printing on the page. The printing unit controller 54 uses the PPOUT command to inform the printing processor 16 of the end of the printing of each page, and the PRINTREADY command to indicate that it is ready to print the next page, thereby prompting the printing processor 16 to initiate the printing process for that page.

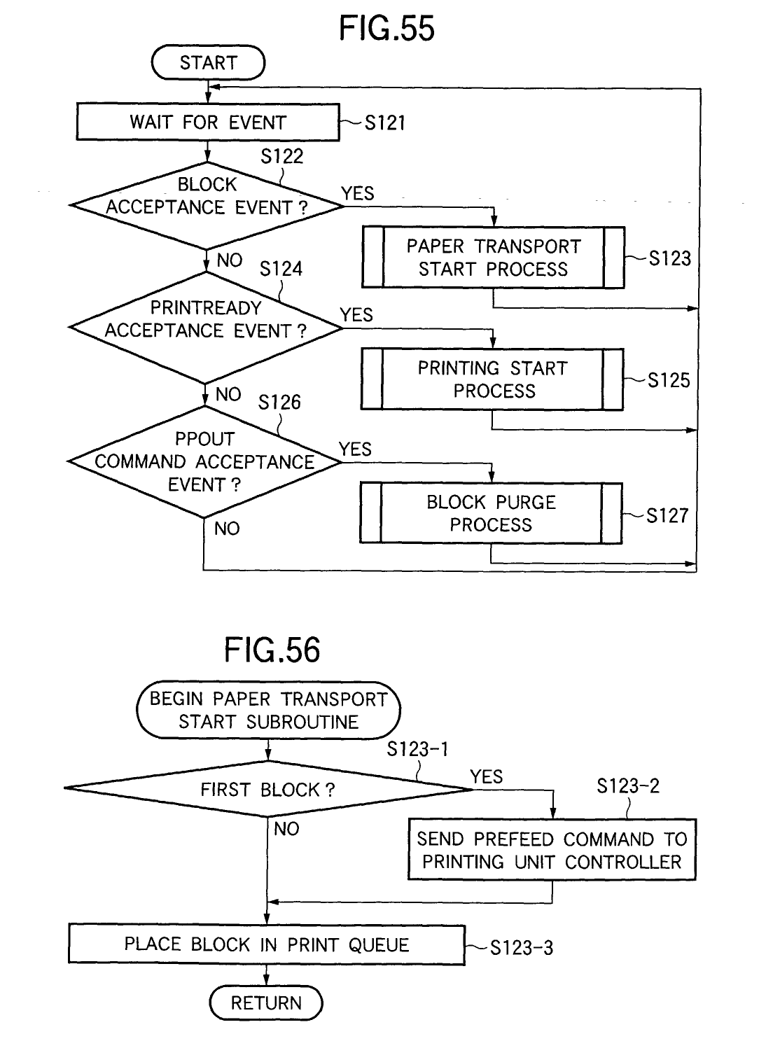

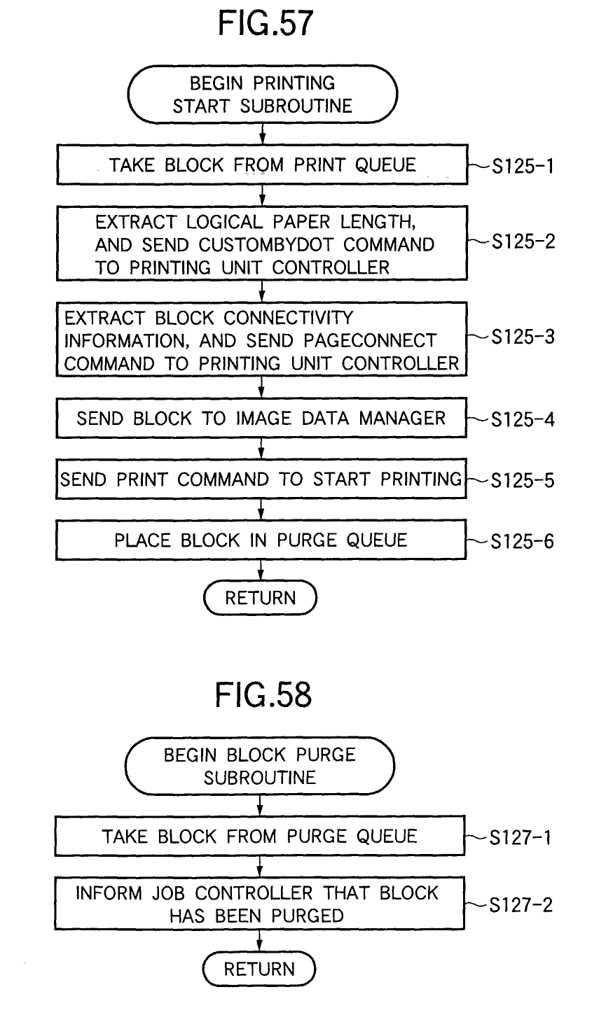

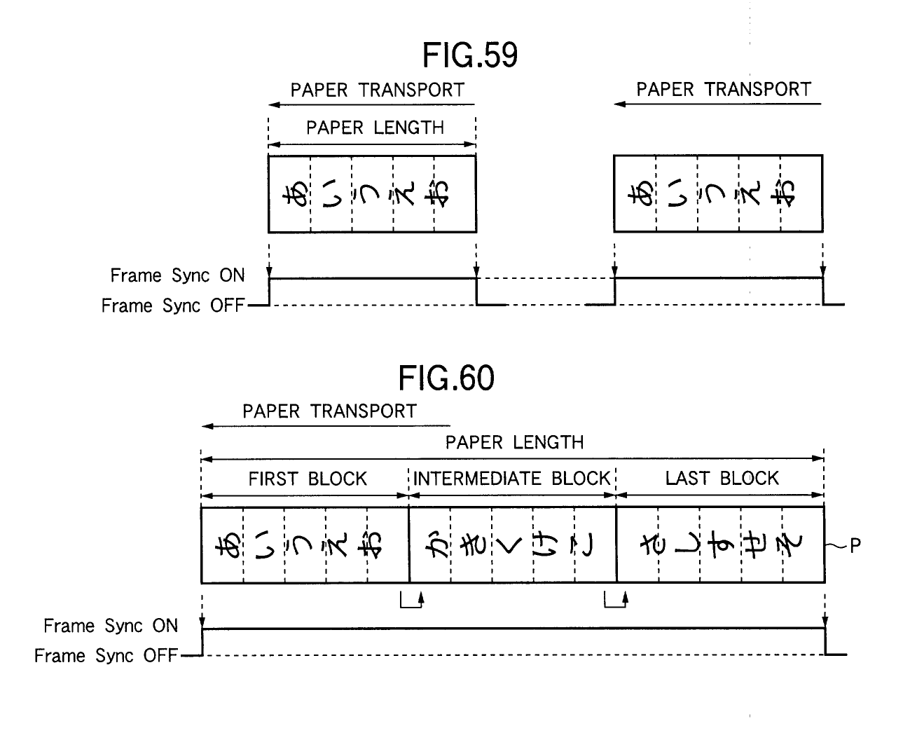

The operation of the printing processor 16 in the twelfth embodiment will next be described with reference to FIGS. 55 to 60. FIG. 55 illustrates the main routine executed by the printing processor. FIG. 56 illustrates the subroutine that starts paper transport. FIG. 57 illustrates the subroutine that starts printing. FIG. 58 illustrates the subroutine that outputs a block. FIG. 59 shows an example of normal printing. FIG. 60 shows an example of a printed page with a long page length.

In the main routine, the printing processor 16 waits for an event to occur. When the printing processor 16 receives a block of image data, a block acceptance event occurs. A paper transport start processor (not shown in the drawings) in the printing processor 16 then uses the block connectivity information to decide if the block is the first block on the physical page, and if so, sends the printing unit controller 54 a PREFEED command. Regardless of whether the block is the first block on the page or another block, the block is also enqueued in a print queue, which is managed as a first-in-first-out (FIFO) queue.

When the printing processor 16 receives the PRINTREADY command, causing a PRINTREADY acceptance event indicating that the printing unit controller 54 has finished printing a logical page, a print-starting processor (not shown in the drawings) in the printing processor 16 starts printing the next block by taking this block from the print queue, obtaining the logical page length from the block, and sending the printing unit controller 54 a CUSTOMBYDOT command. The print-starting processor also obtains the block connectivity information from the block and sends this information to the printing unit controller 54 in a PAGECONNECT command. The printing unit controller 54 is now ready to print the block, so the print-starting processor passes the block to the image data manager 53 with an instruction to prepare to transmit the image data, and sends the printing unit controller 54 a PRINT command, instructing it to start printing. Upon sending the PRINT command, the print-starting processor enqueues the block in a purge queue, which is managed as an FIFO queue.

When the printing processor 16 receives a PPOUT command, causing a PPOUT command acceptance event indicating that the printing unit controller 54 has finished printing a logical page, a block purge processor (not shown in the drawings) in the printing processor 16 removes a block from the purge queue and informs the job controller 14 that the block has been purged. The job controller 14 then frees the memory area used by the block, so that another block can be generated.

The printing unit controller 54 obtains the logical paper length of the logical page from the CUSTOMBYDOT command sent from the printing processor 16 and treats this logical length as the page length, even though there may be no physical edge at the beginning or end of the logical page. From the number of PAGECONNECT commands received from the printing processor 16, the printing unit controller 54 also knows the number of logical pages to be printed on the physical page, and from the block connectivity information included in the PAGECONNECT commands, it can distinguish the first, intermediate, and last blocks on the physical page.

The printing unit controller 54 measures the logical page length in terms of the rotation of the paper transport motor. If this motor is structured so that one pulse advances the paper by one six-hundredth of an inch, for printing at six hundred dots per inch (600 DPI), for example, and if the CUSTOMBYDOT command specifies a logical page length of one hundred lines at 600 DPI, the printing control unit 54 counts a sequence of one hundred driving pulses supplied to the paper transport motor, during which sequence the paper travels by the length of one logical page.

When the printing unit controller 54 is ready to print a logical page, it sends the PRINTREADY command to the printing processor 16, causing the printing processor 16 to carry out the process described above. At the end of the printing of the logical page, the printing unit controller 54 sends the printing processor 16 the PPOUT command, indicating that the logical page has been printed.

The printing unit controller 54 holds the Frame Sync signal for each color in the ‘on’ state from the first block to the last block on the physical page. The Frame Sync signals thus remain on for the entire interval during which all the logical pages on the physical page are being printed. This enables the image data manager 53 to transmit image data without breaks between logical pages.

The image data manager 53 transmits the image data for each page to the printing unit controller 54 in bands, starting with the first band, then transmitting the second band, and continuing through the last band.

In the normal printing mode, as shown in FIG. 59, the printing unit controller 54 switches the Frame Sync signal on at the top of a page, and off at the end of the page. The image data manager 53 starts transmitting the first band of image data when the Frame Sync signal is switched on, and stops transmitting image data when the Frame Sync signal is switched off. For the next page, the Frame Sync signal must be switched on again, at which point the image data manager 53 starts transmitting the image data in the first band of the next page.

In the long page length mode, as shown in FIG. 60, the Frame Sync signal is not switched off at the end of a logical page, so as not to create a break in the printing on the physical page. Band control is therefore performed on the basis of the block connectivity information, instead of the Frame Sync signal.

The flow chart in FIG. 55 shows the main routine executed by the printing processor 16 in the operation described above.

Step S121: Wait for an event to occur.

Step S122: Decide whether a block acceptance event has occurred. If so, go to step S123. If not, go to step S124.

Step S123: Carry out processing to start paper transport; then return to step S121.

Step S124: Decide whether a PRINTREADY acceptance event has occurred. If so, go to step S125. If not, go to step S126.

Step S125: Carry out processing to start printing; then return to step S121.

Step S126: Decide whether a PPOUT command acceptance event has occurred. If so, go to step S127. If not, return to step S121.

Step S127: Carry out processing to output the block; then return to step S121.

The flow chart in FIG. 56 shows the subroutine that carries out step S123.

Step S123-1: Decide whether the current block is the first block on the page. If so, go to step S123-2. If not, go to step S123-3.

Step S123-2: Send the PREFEED command to the printing unit controller 54.

Step S123-3: Place the block in the print queue; then return.

The flow chart in FIG. 57 shows the subroutine that carries out step S125.

Step S125-1: Remove the block from the print queue.

Step S125-2: Extract the logical paper length from the block; then issue a CUSTOMBYDOT command to inform the printing unit controller 54 of the logical paper length.

Step S125-3: Extract block connectivity information from the block; then issue a PAGECONNECT command to inform the printing unit controller 54 of the block connectivity information.

Step S125-4: Send the block to the image data manager 53.

Step S125-5: Issue a PRINT command to instruct the printing unit controller 54 to start printing.

Step S125-6: Place the block in the purge queue; then return.

The flow chart in FIG. 58 shows the subroutine that carries out step S127.

Step S127-1: Remove a block from the purge queue.

Step S127-2: Inform the job controller 14 that the block has been purged; then return.

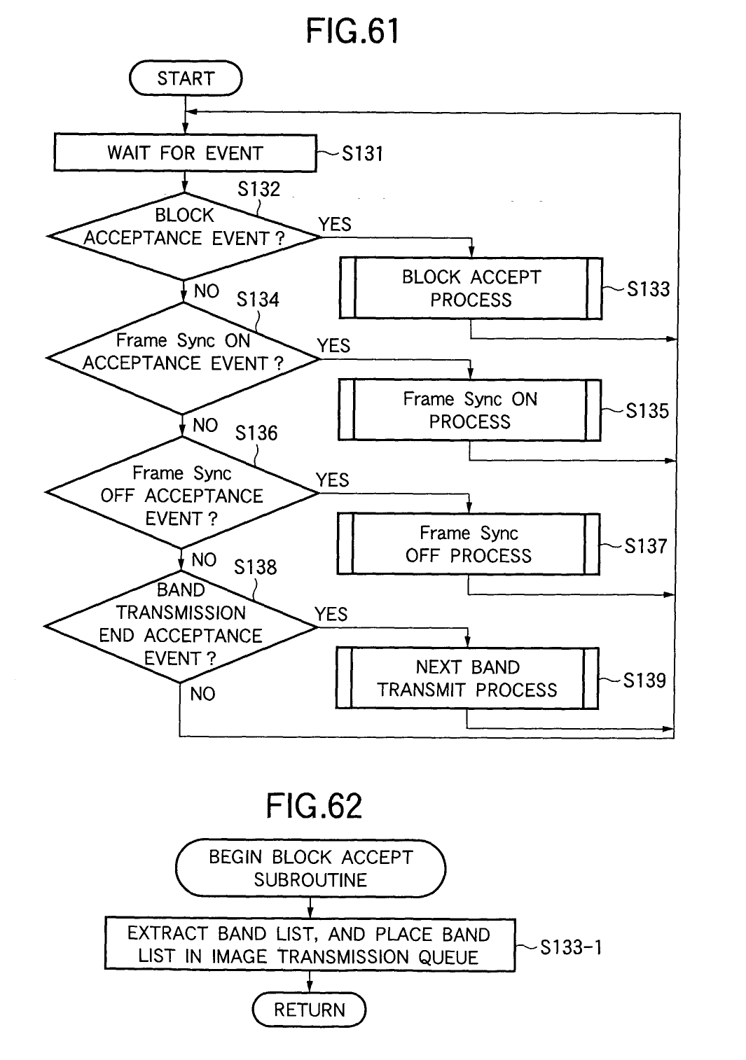

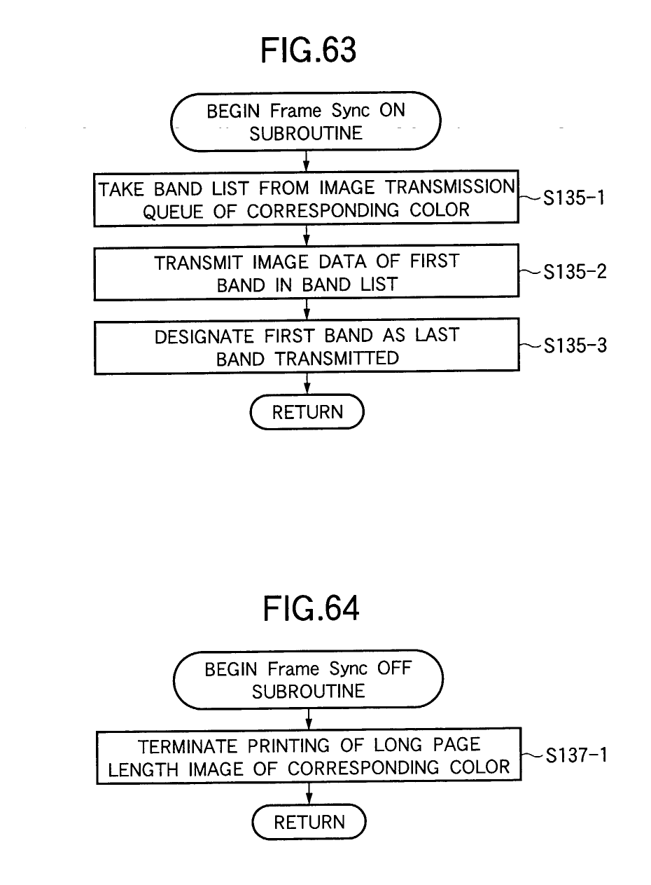

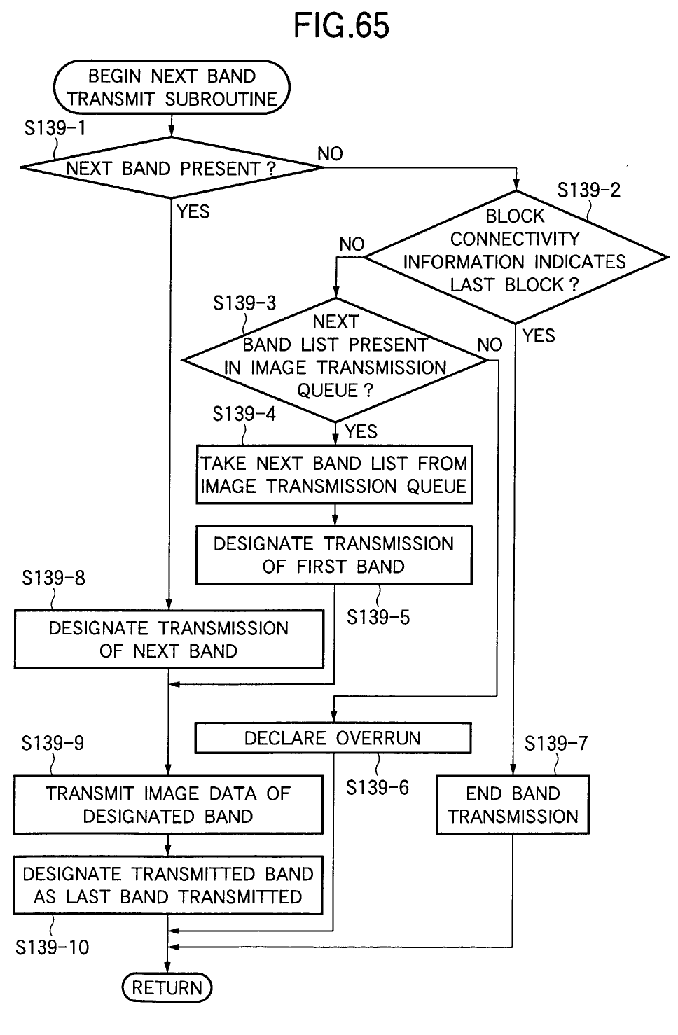

The operation of the image data manager 53 in the twelfth embodiment of the invention will be described with reference to FIGS. 61 to 65. FIG. 61 illustrates the main routine executed by the image data manager. FIG. 62 illustrates the subroutine that accepts a block. FIG. 63 illustrates the subroutine that responds to a Frame-Sync-on acceptance event. FIG. 64 illustrates the subroutine that responds to a Frame-Sync-off acceptance event. FIG. 65 illustrates the subroutine that transmits the next band of image data.

In its main routine, the image data manager 53 waits for an event to occur. When it receives a block from the printing processor 16, a block acceptance event occurs. A block acceptance processor (not shown in the drawings) in the image data manager 53 then obtains the band lists from the block, and places the band list for each color in an image transmission queue, which is managed as an FIFO queue. If there is a separate Frame Sync signal for each color, there is also a separate image transmission queue for each color, and each band list is placed in the image transmission queue of the corresponding color.

When the Frame Sync signal of a particular color is switched on, causing a Frame-Sync-on acceptance event, a Frame-Sync-on processor (not shown in the drawings) in the image data manager 53 obtains the band list from the corresponding image transmission queue, transmits the first band of image data in the band list to the printing unit controller 54, and sets information indicating that this band is the last band to have been transmitted for that particular color. In the long page length mode, the Frame-Sync-on acceptance event occurs only in the first block on the physical page.

When the Frame Sync signal of a particular color is switched off, causing a Frame-Sync-off acceptance event, the a Frame-Sync-off processor (not shown in the drawings) in the image data manager 53 terminates the printing of that particular color.

When a band of image data of a particular color has been transmitted to the printing unit controller 54, causing a band transmission end acceptance event, a next-band transmission processor (not shown in the drawings) in the image data manager 53 decides whether there is a next band of image data of the same color in the current band list. If there is, the next-band transmission processor designates this band as the next band to be transmitted. If there is no next band to be sent in the current band list, as indicated by a null pointer, the next-band transmission processor uses the block connectivity information to decide whether the current block is the last block on the page. If it is the last block, the next-band transmission processor terminates the transmission of bands of that color. If the current block is not the last block, the next-band transmission processor checks for the presence of another band list in the image transmission queue of that color. If a band list is present in the queue, the next-band transmission processor takes it from the queue and designates the first band in this band list as the next band to be transmitted. If there is no band list in the queue, the next-band transmission processor declares an overrun error.

If a next band to be transmitted has been designated in the procedure above, the next-band transmission processor transmits it to the printing unit controller 54, and sets information indicating that this band is the last band to have been transmitted.

In the twelfth embodiment, as described above, the length of one logical page of image data, in the direction of paper transport, is set as a logical paper length, the beginning and end of each logical page on the physical page are determined by counting stepper-motor pulses, and the Frame Sync signal is held in the ‘on’ state continuously during the printing of the logical pages, including the intervals between logical pages, so that the image data can be printed continuously on the physical page.

The flow chart in FIG. 61 shows the main routine of the operation described above.

Step S131: Wait for an event to occur.

Step S132: Decide whether a block acceptance event has occurred. If so, go to step S133. If not, go to step S134.

Step S133: Start managing the accepted block; then return to step S131.

Step S134: Decide whether a Frame-Sync-on acceptance event has occurred. If so, go to step S135. If not, go to step S136.

Step S135: Execute a Frame-Sync-on process; then return to step S131.

Step S136: Decide whether a Frame-Sync-off acceptance event has occurred. If so, go to step S137. If not, go to step S138.

Step S137: Execute a Frame-Sync-off process; then return to step S131.

Step S138: Decide whether a band transmission end acceptance event has occurred. If so, go to step S139. If not, return to step S131.

Step S139: Carry out processing to transmit the next band; then return to step S131.

The flow chart in FIG. 62 shows the subroutine that carries out step S133.

Step S133-1: Extract band lists from the block, and place each band list in the image transmission queue for the corresponding color; then return.

The flow chart in FIG. 63 shows the subroutine that carries out step S135.

Step S135-1: Take a band list from the image transmission queue for the color for which the Frame Sync signal has been switched on.

Step S135-2: Transmit the image data of the first band on the band list.

Step S135-3: Designate the first band as the last band to have been transmitted; then return.

The flow chart in FIG. 64 shows the subroutine that carries out step S137.

Step S137-1: Carry out processing to terminate printing of the long-page-length image in the color for which the Frame Sync signal has been switched off; then return.

The flow chart in FIG. 65 shows the subroutine that carries out step S139.

Step S139-1: Decide whether the most recently transmitted band is followed by a next band. If so, go to step S139-8. If not, go to step S139-2.

Step S139-2: Decide whether the block connectivity information indicates that the block is the last block. If so, go to step S139-7. If not, go to step S139-3.

Step S139-3: Decide whether there is a next band list in the image transmission queue. If so, go to step S139-4. If not, go to step S139-6.

Step S139-4: Take the next band list from the image transmission queue.

Step S139-5: Designate transmission of the first band in the band list.

Step S139-6: Declare an overrun; then return.

Step S139-7: End the transmission of bands of the current primary color; then return.

Step S139-8: Designate transmission of the next band.

Step S139-9: Transmit the image data of the designated band.

Step S139-10: Designate the band just transmitted as the last band to have been transmitted; then return.

When a page printer operates in the long page length mode by the method of the twelfth embodiment, there may be pages that are printed partly in color and partly in monochrome. If printing is performed using cyan, magenta, yellow, and black toner, there may also be pages on which one or two of these four primary colors are not used.

With conventional printing methods, the printing processor 16 informs the printing unit controller 54 of the presence or absence of each color plane on a page, and the printing unit controller 54 prints only the color planes indicated to be present, without switching on the Frame Sync signal for color planes that are not present.

In the twelfth embodiment, however, the printing unit controller 54 keeps the Frame Sync signal switched on from the first block to the last block of a page printed in the long page length mode, so in a color page printer that prints with cyan, magenta, yellow, and black, for example, if one logical page is printed in color and the next logical page is a monochrome page with only black image data, the image data manager 53 cannot send the printing unit controller 54 the cyan, magenta, and yellow image data requested by the Frame Sync signals.

The thirteenth embodiment, described below, enables transmission of image data to the printing unit controller 54 even when the logical pages on a physical page include a mixture of color and monochrome pages. The printing device 12 has the same structure in the thirteenth embodiment as in the twelfth embodiment, and the printing processor 16 and printing unit controller 54 operate in the same way as in the twelfth embodiment.

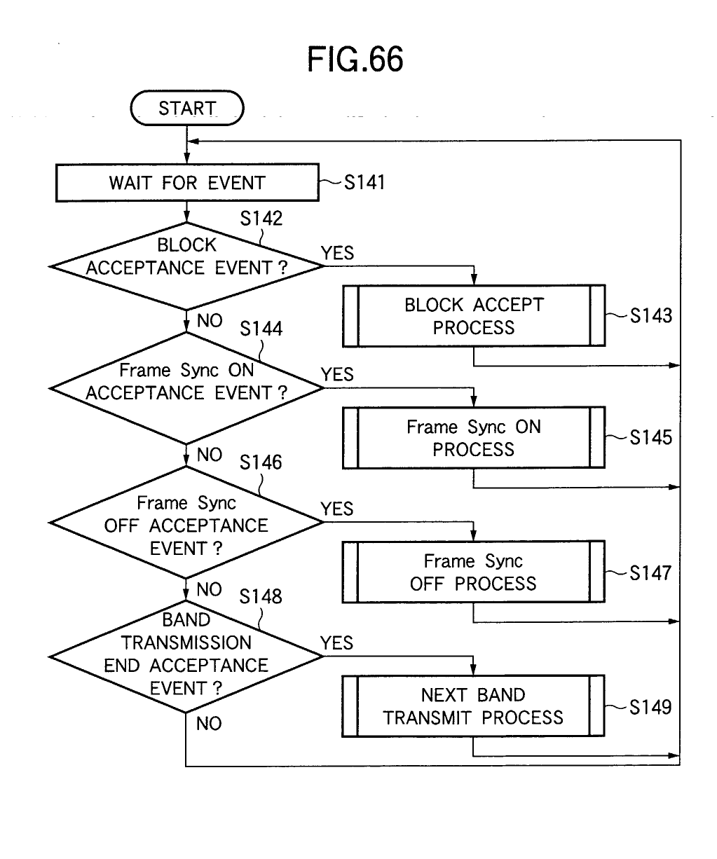

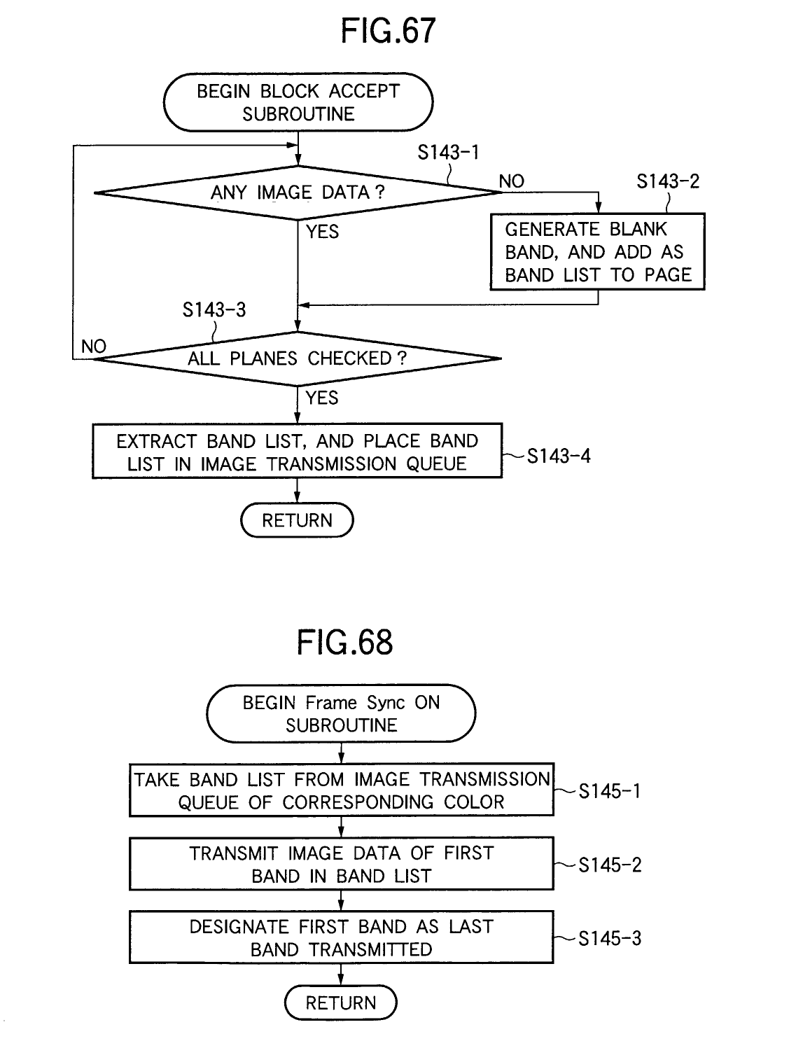

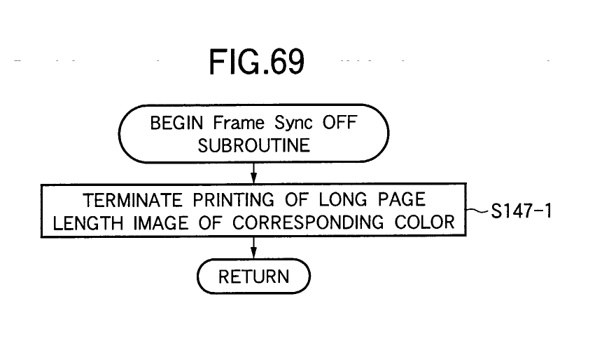

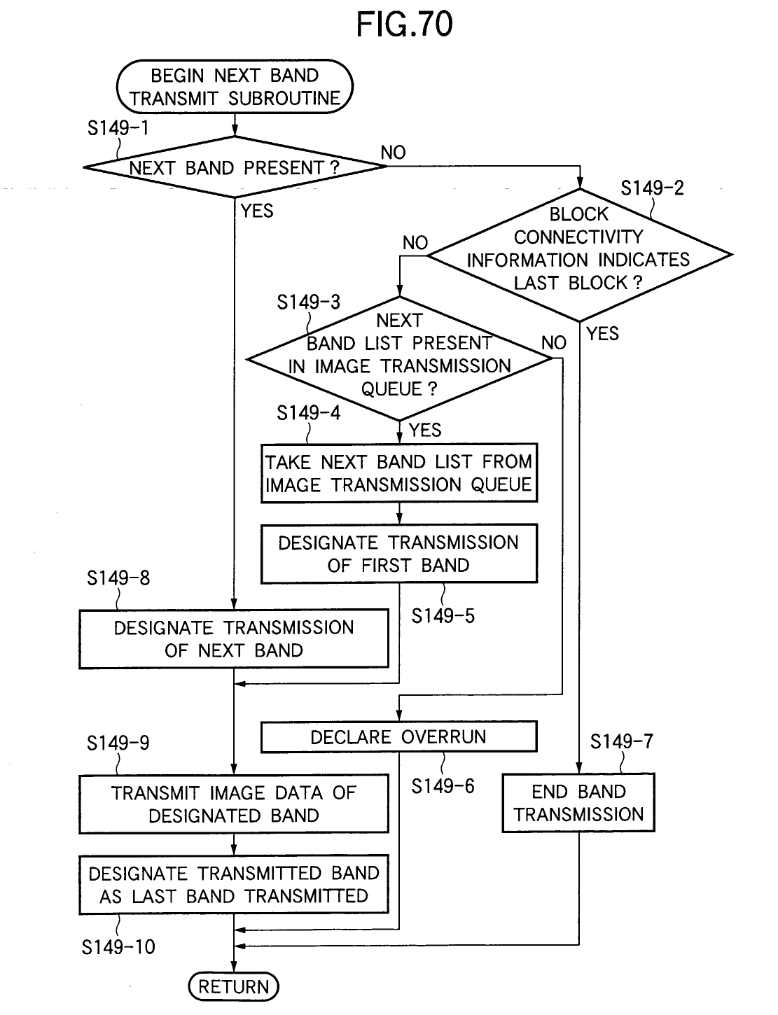

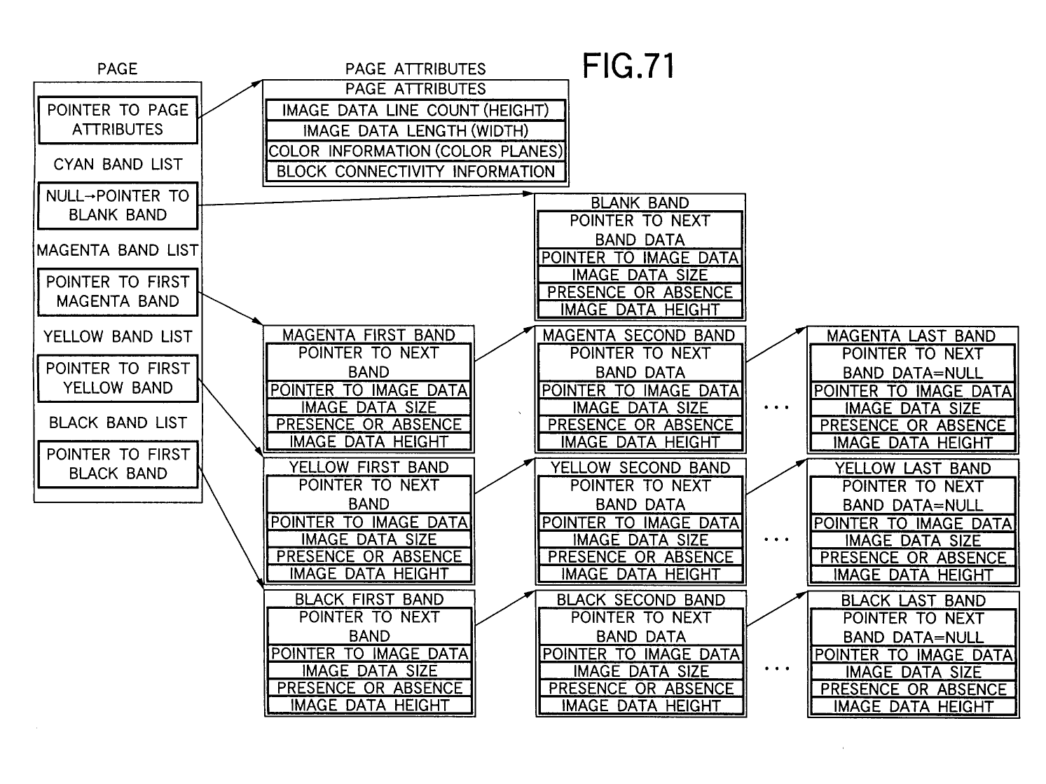

The operation of the image data manager 53 in the thirteenth embodiment will be described with reference to FIGS. 66 to 71. FIG. 66 illustrates the main routine executed by the image data manager. FIG. 67 illustrates the subroutine that accepts a block. FIG. 68 illustrates the subroutine that responds to a Frame-Sync-on event. FIG. 69 illustrates the subroutine that responds to a Frame-Sync-off event. FIG. 70 illustrates the subroutine that transmits the next band. FIG. 71 shows the configuration of a data block.

In the thirteenth embodiment, the image data manager 53 transmits successive bands of image data for all primary colors.

The image data manager 53 waits for an event to occur. When it receives a block from the printing processor 16, a block acceptance event occurs. A block acceptance processor (not shown in the drawings) in the image data manager 53 then checks whether each primary color plane of the block has image data. If there is a plane without image data, the block acceptance processor generates a blank band, and adds the blank band to the page as a band list for the missing primary color. FIG. 71 shows an example in which the cyan color plane is missing. The blank band has the usual pointers and other information, including a pointer to the next band, an image data pointer, and information indicating the size of the image data, the presence or absence of image data, and the band height.

The band lists are then taken from the block and enqueued in the image transmission queue, which is managed as an FIFO queue. If there is a separate Frame Sync signal for each color, there is also a separate image transmission queue for each color, and each band list is enqueued in the image transmission queue of the corresponding color.

When a Frame-Sync-on acceptance event occurs, a Frame-Sync-on processor (not shown in the drawings) in the image data manager 53 carries out Frame-Sync-on processing. In the long page length mode, the Frame-Sync-on acceptance event occurs only in the first block on the physical page. The Frame-Sync-on processor takes a band list from the image transmission queue for the color for which the Frame Sync signal has been switched on and transmits the first band of image data in the band list to the printing unit controller 54. To keep track of which bands in the band list have been transmitted, the Frame-Sync-on processor designates the first band, which has just been transmitted, as the last band to have been transmitted.

When a Frame-Sync-off acceptance event occurs, a Frame-Sync-off acceptance processor (not shown in the drawings) in the image data manager 53 terminates the long-page-length printing of the image for the color for which the Frame Sync signal has been switched off.

When a band transmission end acceptance event occurs, a next-band transmission processor (not shown in the drawings) in the image data manager 53 decides whether the last band transmitted is followed by a next band in the same band list. If there is a next band, the next-band transmission processor designates this band as the next band to be transmitted in the current primary color. If all the bands of the band list have been transmitted, the next-band transmission processor checks the block connectivity information of the block containing the band list to see whether the current block is the last block on the page. If it is the last block, the next-band transmission processor terminates the transmission of bands of this primary color. If the current block is not the last block, the next-band transmission processor checks for the presence of another band list in the image transmission queue of this primary color. If a band list is present in the queue, the next-band transmission processor takes it from the queue and designates the first band in this band list as the next band to be transmitted. If there is no band list in the queue, the next-band transmission processor declares an overrun error.

If a next band to be transmitted has been designated in the procedure above, the next-band transmission processor transmits the image data of the band to the printing unit controller 54 and designates the transmitted band as the last band to have been transmitted.

The logical pages on a physical page printed in the long page length mode may include a mixture of color and monochrome pages or may include pages without cyan, magenta, yellow, or black image data. In the thirteenth embodiment, a blank band is generated for a color plane without any image data, and the blank band is used in place of image data in the printing process. Accordingly, the image data manager 53 can send requested image data to the printing unit controller 54, and the image data can be printed continuously, without breaks between logical pages on the paper P (FIG. 60).

The flow chart in FIG. 66 shows the main routine of the operation described above.

Step S141: Wait for an event to occur.

Step S142: Decide whether a block acceptance event has occurred. If so, go to step S143. If not, go to step S144.

Step S143: Carry out processing to start managing the accepted block; then return to step S141.

Step S144: Decide whether a Frame-Sync-on acceptance event has occurred. If so, go to step S145. If not, go to step S146.

Step S145: Execute a Frame-Sync-on process; then return to step S141.

Step S146: Decide whether a Frame-Sync-off acceptance event has occurred. If so, go to step S147. If not, go to step S148.

Step S147: Execute a Frame-Sync-off process; then return to step S141.

Step S148: Decide whether a band transmission end acceptance event has occurred. If so, go to step S149. If not, return to step S141.

Step S149: Carry out processing to transmit the next band; then return to step S141.

The flow chart in FIG. 67 shows the subroutine that carries out step S143.

Step S143-1: Decide whether there is image data. If so, go to step S143-3. If not, go to step S143-2.

Step S143-2: Generate a blank band for the color plane; then add the blank band as a band list to the image data block for the page.

Step S143-3: Decide whether the presence or absence of image data has been checked in all the planes. If so, go to step S143-4. If not, go to step S143-1.

Step S143-4: Extract band lists from the block, and place each band list in the image transmission queue for the corresponding color; then return.

The flow chart in FIG. 68 shows the subroutine that carries out step S145.

Step S145-1: Take a band list from the image transmission queue for the color for which the Frame Sync signal has been switched on.

Step S145-2: Transmit the image data of the first band in the band list.

Step S145-3: Designate the first band as the last band to have been transmitted; then return.

The flow chart in FIG. 69 shows the subroutine that carries out step S147.

Step S147-1: Carry out processing to terminate printing of the long-page-length image in the color for which the Frame Sync signal has been switched off; then return.

The flow chart in FIG. 70 shows the subroutine that carries out step S149.

Step S149-1: Decide whether the most recently transmitted band is followed by a next band. If so, go to step S149-8. If not, go to step S149-2.

Step S149-2: Decide whether the block connectivity information indicates that the block is the last block. If so, go to step S149-7. If not, go to step S149-3.

Step S149-3: Decide whether there is a next band list in the image transmission queue. If so, go to step S149-4. If not, go to step S149-6.

Step S149-4: Take the next band list from the image transmission queue.

Step S149-5: Designate transmission of the first band in the band list.

Step S149-6: Declare an overrun; then return.

Step S149-7: End the transmission of bands of image data for the current color; then return.

Step S149-8: Designate transmission of the next band.

Step S149-9: Transmit the image data of the designated band.

Step S149-10: Designate the band just transmitted as the last band to have been transmitted; then return.

In the twelfth embodiment, the printing processor passed blocks of image data to the image data manager on the basis of PRINTREADY commands received from the printing unit controller, sent the printing unit controller a PAGECONNECT command and a PRINT command for each block, and purged the blocks according to PPOUT commands received from the printing unit controller. The image data manager managed the image data blocks separately. The printing unit controller had to detect the boundaries between logical pages on the basis of a logical paper length, by counting pulses of the paper transport motor, so that it could send a PRINTREADY command and a PPOUT command for each logical page.

In the fourteenth embodiment, described below, the image data manager links the image data together according to the block connectivity information so that in the long page length mode, the image data for an entire physical page P can be printed as a single page without the need to detect logical page boundaries. The PRINTREADY, PRINT, and PPOUT commands are accordingly issued only once per physical page.

As in the twelfth embodiment, the Frame Sync signal is turned on at the top and off at the bottom of each physical page printed in the long page length mode, so that image data can be continuously printed on the paper P (FIG. 60) without breaks. The Frame Sync signal is not switched on and off between different data blocks on the same physical page.

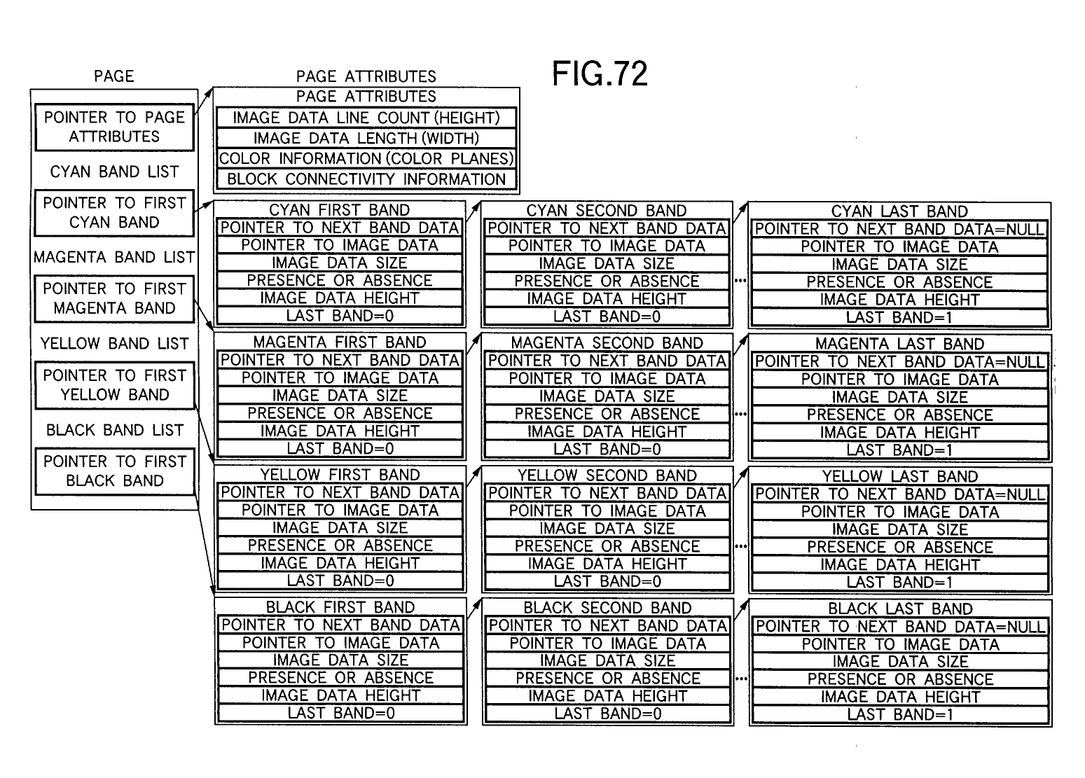

FIG. 72 shows the configuration of a data block in the fourteenth embodiment.

In the fourteenth embodiment, the printing processor 16 receives data blocks from the job controller 14, and exchanges command signals with the printing unit controller 54, thereby instructing the printing unit controller 54 to print on the paper P (FIG. 60).

In the long page length mode, the image data manager 53 receives a data block from the printing processor 16 and connects the current block with the preceding block in accordance with the block connectivity information of the current block. The image data manager 53 also receives Frame Sync signals from the printing unit controller 54. While a Frame Sync signal is in the ‘on’ state, the image data manager 53 sends data from the appropriate block to the printing unit controller 54.

The printing unit controller 54 prints by exchanging command signals with the printing processor 16. In the long page length mode, the printing unit controller 54 adds up the number of lines of image data in the blocks on the page, holds the Frame Sync signals on for a sufficient duration to receive image data from the image data manager 53 for the total number of lines on the page, and prints the corresponding number of lines of image data on the paper P.

As shown in FIG. 72, each band has last-band identification information, referred to below as a last-band flag, that indicates whether the band is the last band of the band list for the logical page. If the band is not the last band, the last-band flag is cleared to ‘0’. If the band is the last band, the last-band flag is set to ‘1’.

Next, the operation of the printing device 12 in the fourteenth embodiment will be described.

The commands passed between the printing processor 16 and printing unit controller 54 include, for example, a CUSTOMBYDOT command, a PAGECONNECTSTART command, a PAGECONNECTEND command, a PAGECOLOR command, a PREFEED command, a PRINT command, a PPOUT command, and a PRINTREADY command.

The printing processor 16 uses the PAGECONNECTSTART and PAGECONNECTEND commands to inform the printing unit controller 54 of the beginning and end of a series of commands associated with a single physical page P in the long page length mode. The series of commands includes a CUSTOMBYDOT command giving the logical paper length of each logical page, a PREFEED command instructing the printing unit controller 54 to start paper transport, and a PRINT command the printing unit controller 54 to start printing.

The printing unit controller 54 uses the PRINTREADY command to indicate that it is ready to print a physical page P, and the PPOUT command to inform the printing processor 16 of the end of the printing of the physical page.

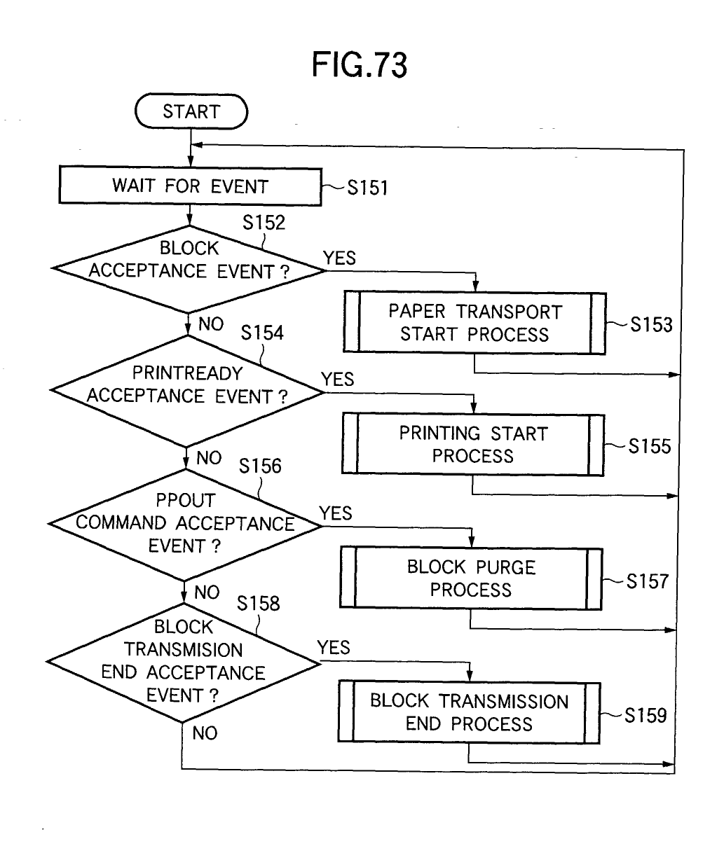

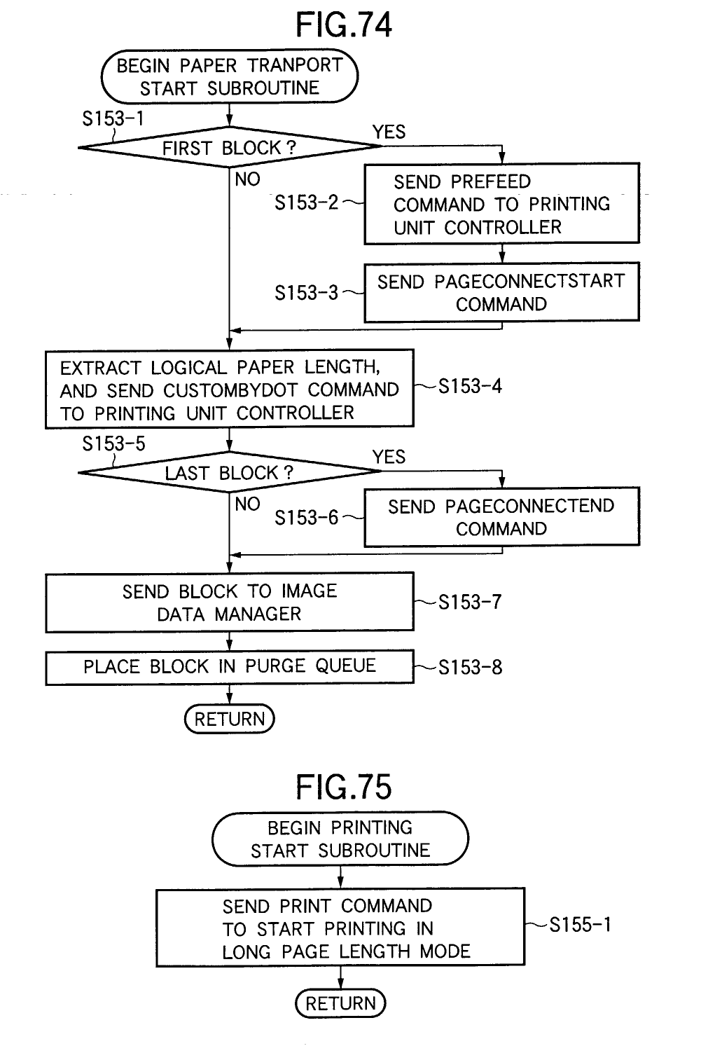

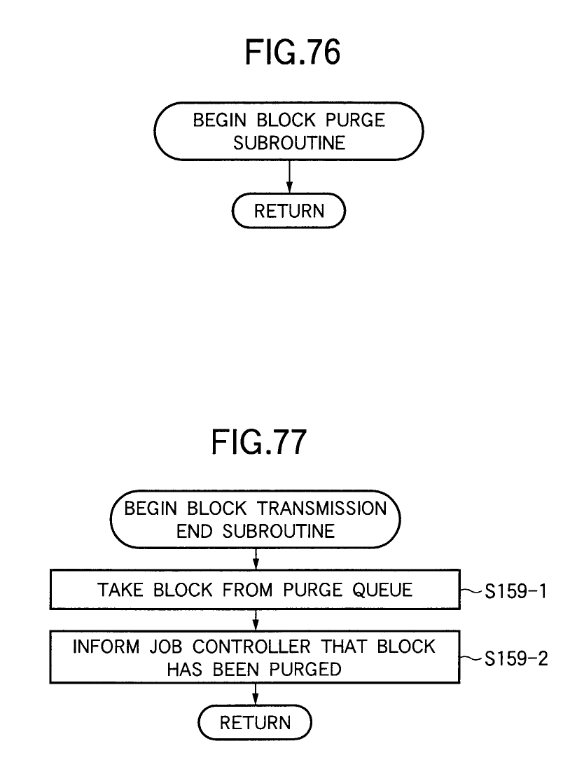

The operation of the printing processor 16 in the fourteenth embodiment will next be described with reference to FIGS. 73 to 77. FIG. 73 illustrates the main routine executed by the printing processor. FIG. 74 illustrates the subroutine that starts paper transport. FIG. 75 illustrates the subroutine that starts printing. FIG. 76 illustrates the subroutine that outputs a block. FIG. 77 illustrates the subroutine that ends block transmission.

In the main routine, the printing processor 16 waits for an event to occur. When the printing processor 16 receives a block of image data, a block acceptance event occurs. A paper transport start processor (not shown in the drawings) in the printing processor 16 uses the block connectivity information to decide if the block is the first block on the physical page, and if so, sends the printing unit controller 54 a PREFEED command and a PAGECONNECTSTART command.

After sending the PREFEED command and PAGECONNECTSTART command for the first block on the page, the paper transport start processor recognizes subsequent blocks on the same page from block connectivity information indicating that the corresponding blocks are not the first block on the physical page. The paper transport start processor obtains the logical paper length of each block on the page and issues a CUSTOMBYDOT command to inform the printing unit controller 54 of the logical length of the block. When the paper transport start processor encounters block connectivity information indicating that the corresponding block is the last block on the physical page, it also sends the printing unit controller 54 a PAGECONNECTEND command.

In the long page length mode, the printing unit controller 54 accordingly receives a PREFEED command, PAGECONNECTSTART command, and CUSTOMBYDOT command for the first block, a CUSTOMBYDOT command for each intermediate block, and a CUSTOMBYDOT command and PAGECONNECTEND command for the last block.

At each block acceptance event, the paper transport start processor sends the accepted block to the image data manager 53 and enqueues the block in a purge queue, which is managed as an FIFO queue.

When the printing processor 16 receives the PRINTREADY command, a PRINTREADY acceptance event occurs to indicate that the printing unit controller 54 is ready to start printing the physical page P. A print-starting processor (not shown in the drawings) in the printing processor 16 then sends a PRINT command to the printing unit controller 54, instructing it to start printing in the long page length mode.

When the printing processor 16 receives a PPOUT command, causing a PPOUT command acceptance event indicating that the printing unit controller 54 has finished printing the physical page P, the printing processor 16 takes no particular action.

When a block transmission end acceptance event occurs, indicating that the image data manager 53 has transmitted the block of image data corresponding to a single logical page, a block transmission termination processor (not shown in the drawings) in the printing processor 16 removes a block from the purge queue and informs the job controller 14 that the block has been purged. The job controller 14 then frees the memory area used by the block, so that another block can be generated.

As explained above, during the printing of a page P in the long page length mode, the printing unit controller 54 first receives a PREFEED command from the printing processor 16, followed by a STARTPAGECONNECT command and a series of CUSTOMBYDOT commands giving the logical paper lengths of the logical pages constituting the physical page P, the series being terminated by a the PAGECONNECTSTART command. The printing unit controller 54 sums the logical paper lengths in the series of CUSTOMBYDOT commands, and uses the sum as the total length of the physical page P.

The printing control unit 54 responds to the PREFEED command by starting paper transport of the physical page P. When ready to start printing on the page P, the printing unit controller 54 sends the printing processor 16 a PRINTREADY command, receiving a PRINT command in return. The printing unit 54 then begins switching on the Frame Sync signals for the different primary colors.

The printing unit controller 54 holds the Frame Sync signal for each primary color in the ‘on’ state until printing of that color on the physical page P ends, then switches the Frame Sync signal for that color off. When the printing of all colors ends, the printing unit controller 54 sends the printing processor 16 a PPOUT command.

The flow chart in FIG. 73 shows the main routine executed by the printing processor 16 in the fourteenth embodiment.

Step S151: Wait for an event to occur.

Step S152: Decide whether a block acceptance event has occurred. If so, go to step S153. If not, go to step S154.

Step S153: Carry out processing to start paper transport; then return to step S151.

Step S154: Decide whether a PRINTREADY acceptance event has occurred. If so, go to step S155. If not, go to step S156.

Step S155: Carry out processing to start printing; then return to step S151.

Step S156: Decide whether a PPOUT command acceptance event has occurred. If so, go to step S157. If not, go to step S158.

Step S157: Carry out dummy processing to purge a block; then return to step S151.

Step S158: Decide whether a block transmission end acceptance event has occurred. If so, go to step S159. If not, go to step S151.

S159: Carry out processing to terminate block transmission; then return to step S151.

The flow chart in FIG. 74 shows the subroutine that carries out step S153.

Step S153-1: Decide whether the current block is the first block on the page. If so, go to step S153-2. If not, go to step S153-4.

Step S153-2: Send a PREFEED command to the printing unit controller 54.

Step S153-3: Send a PAGECONNECTSTART command.

Step S153-4: Obtain the logical paper length from the block and send a CUSTOMBYDOT command to inform the printing unit controller 54 of the logical paper length.

Step S153-5: Decide whether the current block is the last block on the page. If so, go to step S153-6. If not, go to step S153-7.

Step S153-6: Send a PAGECONNECTEND command.

Step S153-7: Send the block to the image data manager 53.

Step S153-8: Place the block in the purge queue; then return.

The flow chart in FIG. 75 shows the subroutine that carries out step S155.

Step S155-1: Issue a PRINT command to instruct the printing unit controller 54 to start printing in the long page length mode; then return.

The flow chart in FIG. 76 shows the dummy subroutine that carries out step S157. This subroutine simply returns without doing anything.

The flow chart in FIG. 77 shows the subroutine that carries out step S159.

Step S159-1: Remove a block from the purge queue.

Step S159-2: Inform the job controller 14 that the block has been purged; then return.

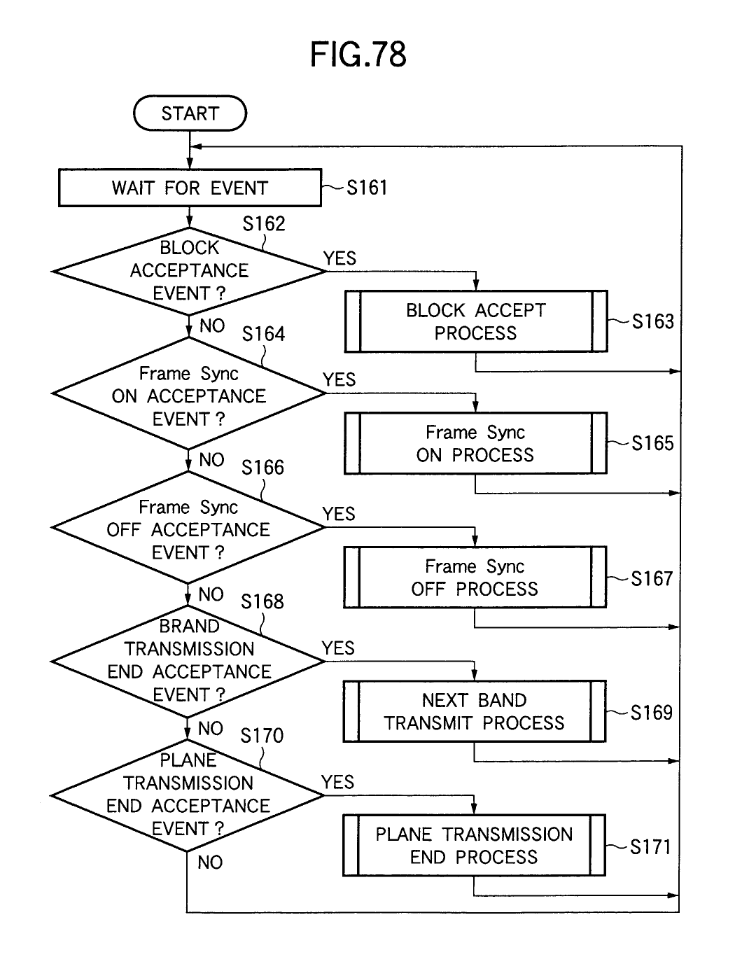

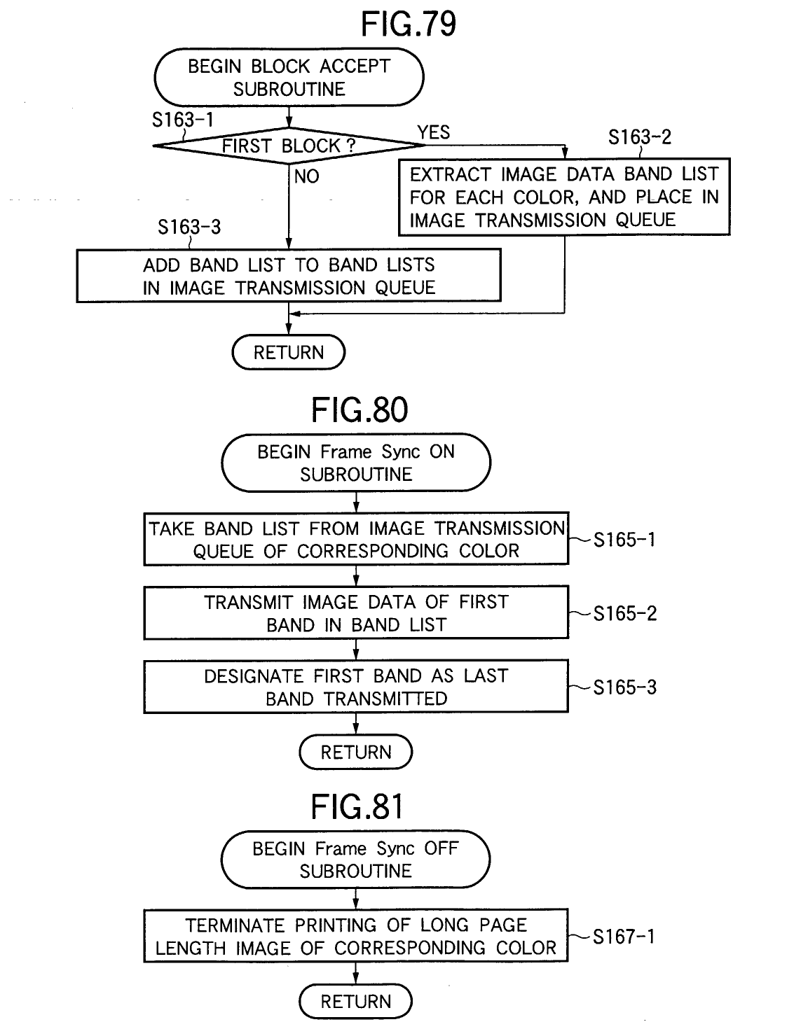

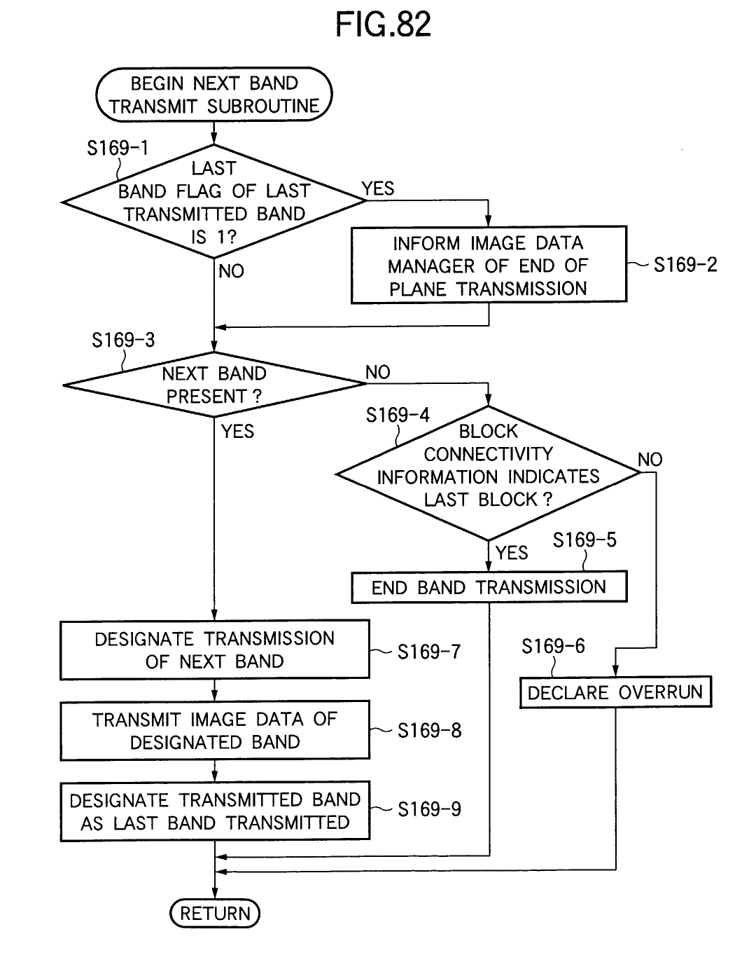

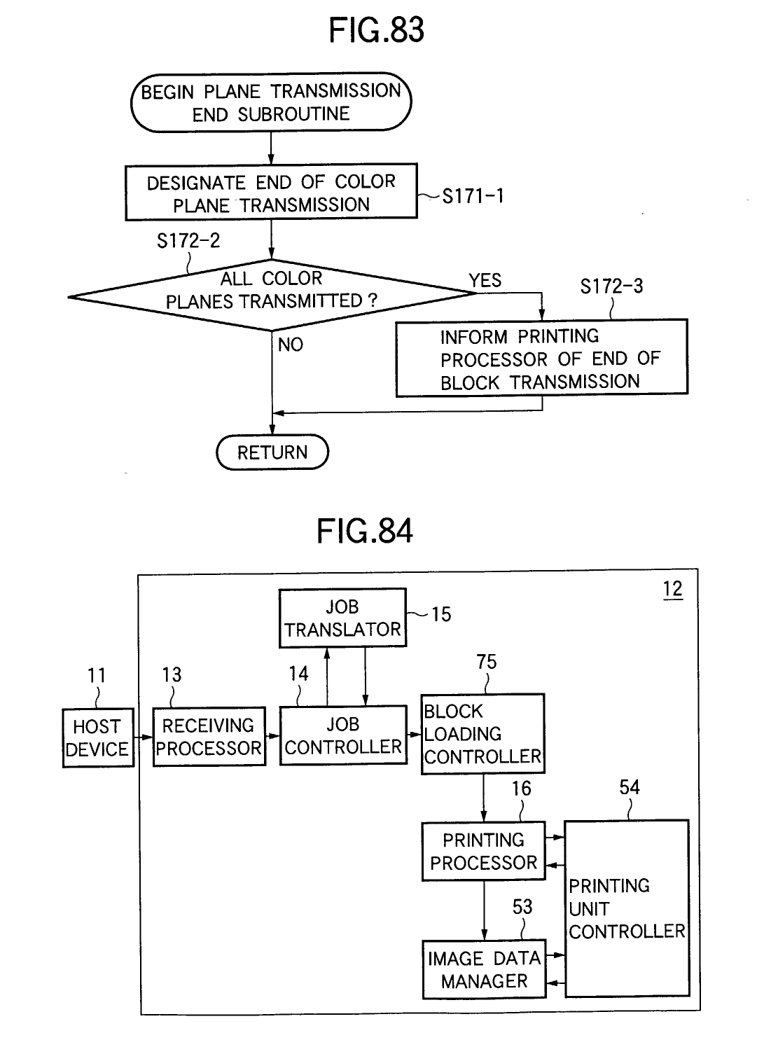

The operation of the image data manager 53 in the fourteenth embodiment will be described with reference to FIGS. 78 to 83. FIG. 78 illustrates the main routine executed by the image data manager. FIG. 79 illustrates the subroutine that accepts a block. FIG. 80 illustrates the subroutine that responds to a Frame-Sync-on acceptance event. FIG. 81 illustrates the subroutine that responds to a Frame-Sync-off acceptance event. FIG. 82 illustrates the subroutine that transmits the next band of image data. FIG. 83 illustrates the subroutine that ends plane transmission.

In the fourteenth embodiment, as soon as the image data manager 53 finishes transmitting each band of image data, it proceeds directly to the transmission of the next band.

In its main routine, the image data manager 53 waits for an event to occur. When it receives a block from the printing processor 16, a block acceptance event occurs. A block acceptance processor (not shown in the drawings) in the image data manager 53 then decides whether the block received from the printing processor 16 is the first block to be printed on a page in the long page length mode. If so, the block acceptance processor obtains the band list for each color from the block and enqueues the band list in an image transmission queue. If the block is not the first block on the page, the block acceptance processor appends the band list of the block to the last preceding band list in the image transmission queue, so that all of the band lists are joined up into a single queue of bands. If there is a separate Frame Sync signal for each color, there is also a separate image transmission queue for each color, and each block is enqueued in the image transmission queue of the corresponding color.

When the Frame Sync signal of a particular color is switched on, causing a Frame-Sync-on acceptance event, a Frame-Sync-on processor (not shown in the drawings) in the image data manager 53 takes a band list from the corresponding image transmission queue and transmits the first band of image data in the band list to the printing unit controller 54. The Frame-Sync-on acceptance event occurs only in the first block to be printed in the long page length mode. To keep track of which bands have been transmitted, the Frame-Sync-on processor designates the first band as the last band to have been transmitted.

When the Frame Sync signal of a particular color is switched off, causing a Frame-Sync-off acceptance event, a Frame-Sync-off processor (not shown in the drawings) in the image data manager 53 terminates the printing of the long-page-length image of that color.

When a band of image data of a particular color has been transmitted to the printing unit controller 54, causing a band transmission end acceptance event, a next-band transmission processor (not shown in the drawings) in the image data manager 53 decides whether the last-band flag of the band just transmitted is set to ‘1’. If so, the next-band transmission processor generates a plane transmission end acceptance event, informing the image data manager that all image data of the corresponding color plane on the logical page have been transmitted.

The next-band transmission processor then decides whether the last band transmitted is followed by another band in the image transmission queue. If so, the next-band transmission processor designates this band as the next band to be transmitted, transmits its image data to the printing unit controller 54, then designates this band as the last band to have been transmitted. If there is no next band in the transmission queue, the next-band transmission processor uses the block connectivity information to decide whether the current block is the last block on the page. If it is the last block, the next-band transmission processor terminates the transmission of bands of the current color. If the current block is not the last block, the next-band transmission processor declares an overrun error.

When a plane transmission end acceptance event occurs, a plane-transmission-termination processor (not shown in the drawings) in the image data manager 53 designates the transmission of the corresponding color plane on the current logical page as having ended. The image data manager 53 keeps track of these events so that it knows which color planes have been completely transmitted for the logical page. The plane-transmission-termination processor can accordingly decide whether all color planes on the logical page have been completely transmitted. If they have, the plane-transmission-termination processor informs the printing processor 16 of the end of transmission of a block.

In the fourteenth embodiment, as described above, when a physically long page is divided into logical pages of appropriate lengths, the image data manager 53 connects the image data for the logical pages according to the block connectivity information of the block, so that the printing unit controller 54 does not have to recognize logical page boundaries on the basis of individual logical paper lengths. The image data manager 53 also tells the printing processor 16 when to purge each block, thereby relieving the printing unit controller 54 of this task.

The flow chart in FIG. 78 shows the main routine in the image data management operation described above.

Step S161: Wait for an event to occur.

Step S162: Decide whether a block acceptance event has occurred. If so, go to step S633. If not, go to step S164.

Step S163: Carry out processing to accept the block; then return to step S161.

Step S164: Decide whether a Frame-Sync-on acceptance event has occurred. If so, go to step S165. If not, go to step S156.

Step S165: Execute a Frame-Sync-on process; then return to step S161.

Step S166: Decide whether a Frame-Sync-off acceptance event has occurred. If so, go to step S167. If not, go to step S168.

Step S167: Execute a Frame-Sync-off process; then return to step S161.

Step S168: Decide whether a band transmission end acceptance event has occurred. If so, go to step S169. If not, return to step S170.

Step S169: Carry out processing to transmit the next band; then return to step S161.

Step S170: Decide whether a plane transmission end acceptance event has occurred. If so, go to step S171. If not, return to step S161.

Step S171: Carry out processing associated with the end of the transmission of one color plane in a logical block; then return to step S161.

The flow chart in FIG. 79 shows the subroutine that carries out step S163.

Step S163-1: Decide whether the current block is the first block on the page. If so, go to step S163-2. If not, go to step S163-3.

Step S163-2: Extract an image data band list for each color from the block, and place the band list in the image transmission queue for the corresponding color; then return.

Step S163-3: Extract an image data band list for each color from the block, and append the band list to the band lists already present in the image transmission queue; then return.

The flow chart in FIG. 80 shows the subroutine that carries out step S165.

Step S165-1: Take a band list from the image transmission queue for the color for which the Frame Sync signal has been switched on.

Step S165-2: Transmit the image data of the first band on the band list.

Step S165-3: Designate the first band as the last band to have been transmitted; then return.

The flow chart in FIG. 81 shows the subroutine that carries out step S167.

Step S167-1: Carry out processing to terminate printing of the long-page-length image for the color for which the Frame Sync signal has been switched off; then return.

The flow chart in FIG. 82 shows the subroutine that carries out step S169.

Step S169-1: Decide whether the last-band flag of the last band transmitted is set to ‘1’. If so, go to step S169-2. If not, go to step S169-3.

Step S169-2: Inform the image data manager 53 that the transmission of the color plane in the logical page has ended.

Step S169-3: Decide whether the most recently transmitted band is followed by a next band. If so, go to step S169-7. If not, go to step S169-4.

Step S169-4: Decide whether the block connectivity information indicates that the block is the last block. If so, go to step S169-5. If not, go to step S169-6.

Step S169-5: End the transmission of bands of image data for the current color; then return.

Step S169-6: Declare an overrun; then return.

Step S169-7: Designate transmission of the next band.

Step S169-8: Transmit the image data of the designated band.

Step S169-9: Designate the band just transmitted as the last band to have been transmitted; then return.

The flow chart in FIG. 83 shows the subroutine that carries out step S171.

Step S171-1: Designate the transmission of the color plane as having ended for the logical page.

Step S171-2: Decide whether the transmission of all color planes on the logical page has ended. If so, go to step S171-3. If not, return.

Step S171-3: Inform the printing processor 16 of the end of image data transmission for the block; then return.

When a page printer is used to print a long page, it must generate blocks fast enough to keep up with the transport speed of the paper, from the beginning to the end of printing in the long page length mode; otherwise, an overrun will occur, as noted above.

In the fifteenth embodiment, described below, the rate at which logical pages (image blocks) are generated is compared with the paper transport speed. If the page generation rate is slower than the page transport speed, blocks are enqueued without starting printing. The printing of the long page starts when enough blocks have been enqueued to keep up with the paper transport speed.

Referring to FIG. 84, the printing device 12 in the fifteenth embodiment comprises a receiving processor 13, a job controller 14, a job translator 15, a printing processor 16, an image data manager 53, a printing unit controller 54, and a block loading controller 75,.

The printing processor 16 receives blocks from the block loading controller 75 and exchanges command signals for each block with the printing unit controller 54, instructing it to start printing on the paper P (FIG. 60) in the long page length mode.

The image data manager 53 receives the blocks of image data for each page from the printing processor 16, manages the image data therein, and receives Frame Sync signals from the printing unit controller 54. While a Frame Sync signal is in the ‘on’ state, the image data manager 53 sends image data to the printing unit controller 54. In the long page length mode, the image data manager 53 transmits a continuous stream of image data without breaks between logical pages.

The printing unit controller 54 prints by exchanging command signals with the printing processor 16. In the long page length mode, the printing unit controller 54 counts the pulses supplied to a paper transport motor and thereby recognizes the boundaries between logical pages, so that it can prompt the printing processor to send the image data for each logical page to the image data manager 53 at the necessary time. The printing controller 54 also switches on the Frame Sync signals at the appropriate timing to start receiving the image data from the image data manager 53, and controls the printing unit (not shown) that prints the data on the printing media.

The block loading controller 75 receives logical pages (image data blocks) from the job controller 14, compares the image data generation rate with the paper transport speed, and if necessary, holds the image data blocks temporarily before submitting them to the printing processor 16.

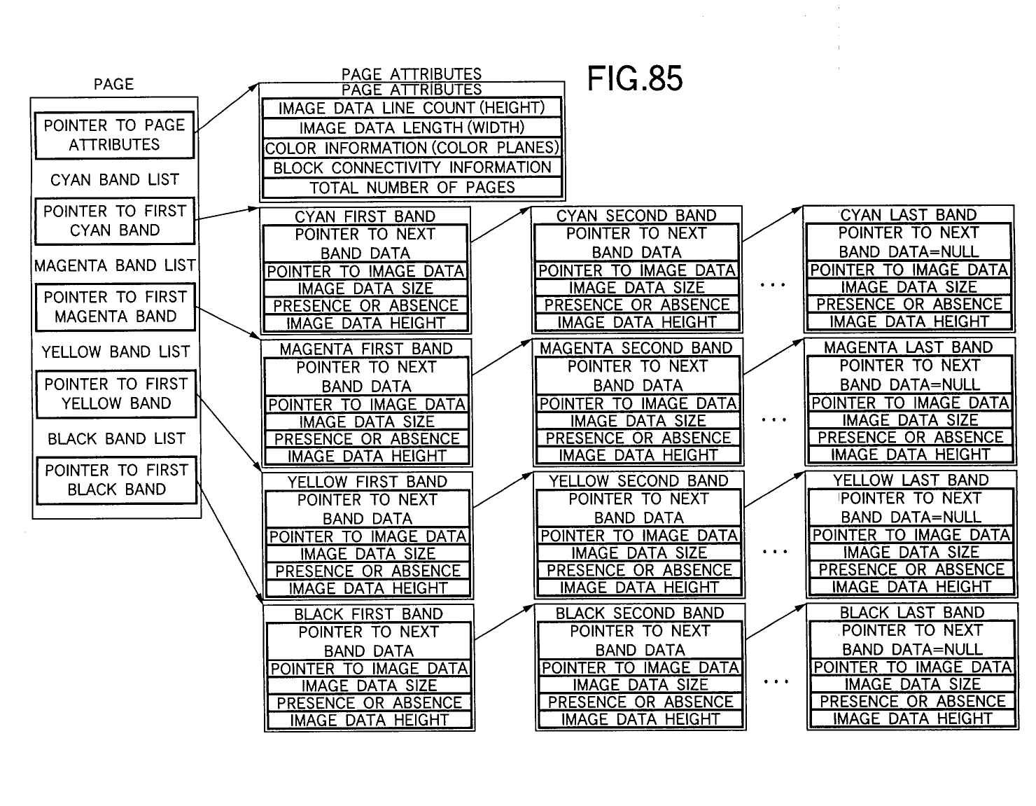

FIG. 85 shows the configuration of a data block in the fifteenth embodiment. A page has page attributes indicating the number of lines of image data on the page, the line length, the presence or absence of primary color planes (cyan, magenta, yellow, black), block connectivity information, and the total number of logical pages constituting the long physical page.

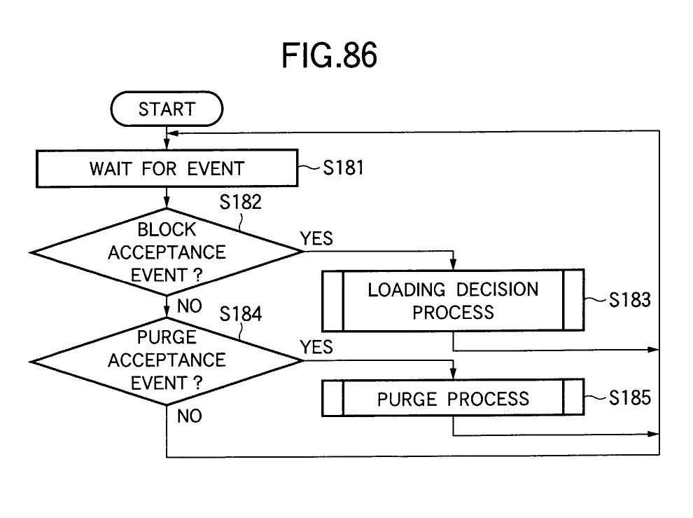

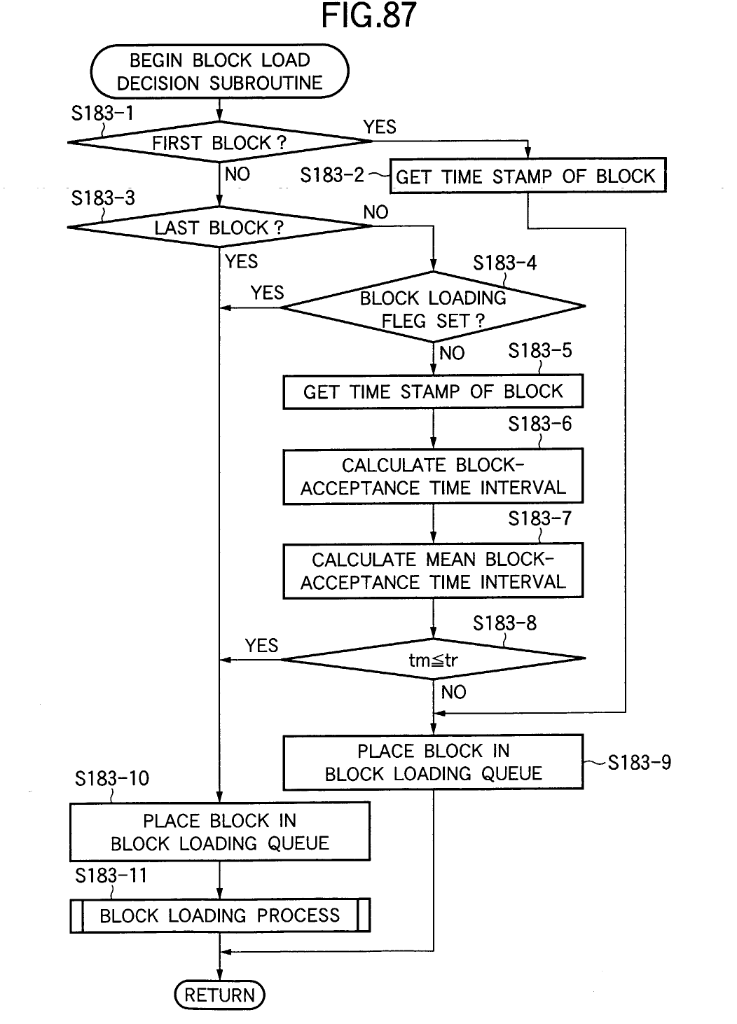

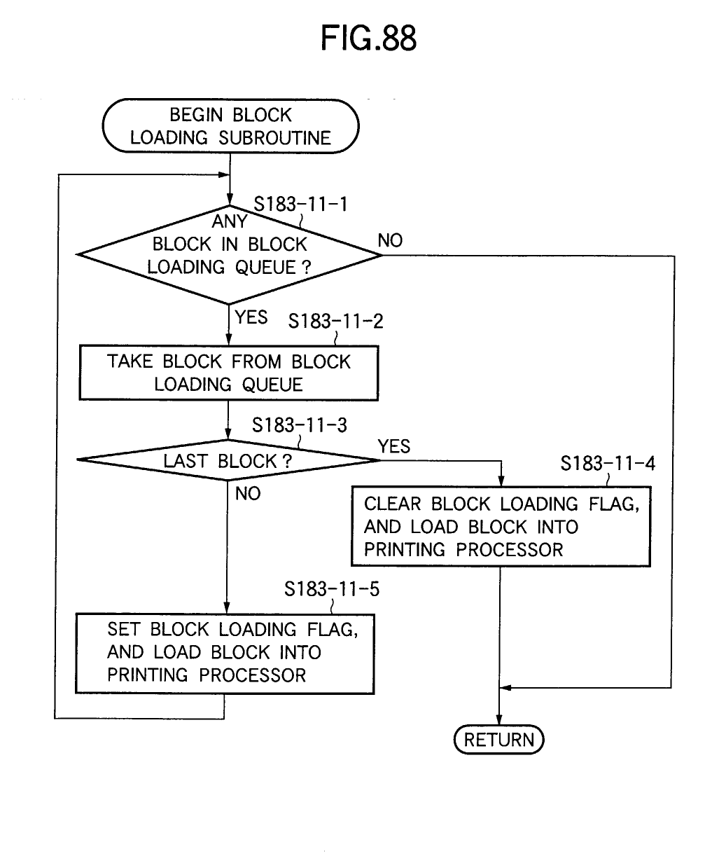

The operation of the block loading controller 75 in the fifteenth embodiment will be described next with reference to FIG. 86, which illustrates the main routine executed by the block loading controller, FIG. 87, which illustrates the subroutine that decides when to commence loading blocks, and FIG. 88, which illustrates the subroutine that loads the blocks.

The block loading controller 75 (FIG. 84) waits for an event to occur. When the block loading controller 75 receives a block from the job controller 14, a block acceptance event occurs, and a block loading decision processor (not shown in the drawings) in the block loading controller 75 is activated. In the long page length mode, if the received block is the first block on the physical page, the block loading decision processor obtains a time stamp of the block and enqueues the block in a block loading queue.

The time stamp is based on the block acceptance time and may indicate, for example, a system clock time, or a real time as measured by a built-in real-time clock. One way to obtain the block acceptance time is to calculate the elapsed time since the printer was powered on. For convenience, it may be assumed that the time is calculated in milliseconds.

If the currently received block is not the first block on the page, the block loading decision processor decides whether the block is the last block on the page. If so, the block loading decision processor enqueues the block in the block loading queue and activates a block loading processor. The block loading processor takes blocks from the block loading queue and loads them into the printing processor 16 one by one, until the block loading queue is empty.

If the received block is neither the first block nor the last block but is an intermediate block, the block loading decision processor consults a block loading flag to decide whether the loading of blocks into the printing processor 16 has already begun. If so, the block loading decision processor enqueues the received block in the block loading queue and activates the block loading processor.

If the block is an intermediate block and the loading of blocks into the printing processor 16 has not already begun, the block loading decision processor obtains the time stamp of the block, and subtracts the time stamp of the preceding block to obtain the time interval between the acceptance of the preceding block and the acceptance of the current block. The block acceptance time interval is calculated in this way each time a block is received from the job controller 14, until block loading begins. From the calculated block-acceptance time intervals, the block loading decision processor calculates a mean block-acceptance time interval (tm).

Information stored in the block loading controller 75 indicates the time required for the page printer to print a single line of image data, that is, the single-line printing time (T1). For convenience, the single-line printing time T1 may be assumed to be measured in milliseconds.

For each block, the block loading controller 75 multiplies the single-line printing time (T1) by the number of lines of image data (L), as obtained from the block attributes, to obtain the time required to print the image data of the block. Next, the block loading decision processor decides whether the mean block-acceptance time interval (tm) is greater than the time intervals at which the remaining blocks must be received in order to avoid an overrun. These intervals will be referred to as the required remaining-block interval (tr). If the mean block-acceptance time interval (tm) is equal to or less than the required remaining-block interval (tr), indicating that blocks are being generated fast enough for printing to start without the likely occurrence of an overrun, the block loading decision processor places the block in the block loading queue and activates the block loading processor. If the mean block-acceptance time interval (tm) is greater than the required remaining-block interval (tr), the block loading decision processor places the block in the block loading queue but does not activate the block loading processor.

The total time (Tt) required to print all blocks on the physical page is expressed as follows:

Tt=T1×L×M

where M is the total number of blocks making up the physical page and L is the number of lines of image data per block.

The required remaining-block interval (tr) is expressed as follows:

$$\begin{matrix}tr = Tt / ( M - N ) \\ = T1 \times L \times M / ( M - N )\end{matrix}$$

where N is the number of blocks accepted so far, and M is greater than N.

T1, from which the required remaining-block interval (tr) is derived, is proportional to the reciprocal of the paper transport speed. The mean block-acceptance interval (tm) is the reciprocal of the block generation rate. Comparing the mean block-acceptance interval (tm) with the required remaining-block interval (tr) is thus equivalent to comparing the block generation rate with the paper transport speed.

When activated, the block loading processor takes a block from the block loading queue, and uses the block connectivity information to decide whether the block is the last block on the page. If it is, the block loading processor clears the block loading flag and loads the block into the printing processor 16. If the block is not the last block on the page, the block loading processor sets the block loading flag and loads the block into the printing processor 16. This entire process is repeated until the block loading queue is empty.

The printing processor 16 processes the blocks as described in, for example, the twelfth, thirteenth, or fourteenth embodiment, purging each block when it has been printed, and notifying the block loading controller 75 of these purges, thereby generating purge acceptance events.

When a purge acceptance event occurs, a purge processor (not shown in the drawings) in the block loading controller 75 informs the job controller 14, so that it can release the memory area used for the block.

The method adopted in the fifteenth embodiment, of comparing the mean block-acceptance time interval (tm) with the required remaining-block interval (tr), is effective if all logical pages have the same height and all blocks are generated in approximately the same time. This method is not suitable if the block generation times vary greatly.

The flow chart in FIG. 86 shows the main routine of the operation described above.

Step S181: Wait for an event to occur.

Step S182: Decide whether a block acceptance event has occurred. If so, go to step S183. If not, go to step S184.

Step S183: Decide whether to load a block; then return to step S181.

Step S184: Decide whether an output acceptance event has occurred. If so, go to step S185. If not, return to step S181.

Step S185: Carry out block output processing; then return to step S181.

The flow chart in FIG. 87 shows the subroutine that carries out step S183.

Step S183-1: Decide whether the current block is the first block on the page. If so, go to step S183-2. If not, go to step S183-3.

Step S183-2: Obtain the time stamp of the block.

Step S183-3: Decide whether the current block is the last block on the page. If so, go to step S183-10. If not, go to step S183-4.

Step S183-4: Decide whether the block has already been loaded into the printing processor 16. If so, go to step S183-10. If not, go to step S183-5.

Step S183-5: Obtain the time stamp of the block.

Step S183-6: Calculate the time interval between the acceptance of the preceding block and the acceptance of the current block.

Step S813-7: Calculate the mean block-acceptance time interval tm.

Step S183-8: Decide whether the mean block-acceptance time interval tm is greater than the required remaining-block interval tr. If the mean block-acceptance time interval tm is not greater than tr, go to step S183-10. If the mean block-acceptance time interval tm is greater than tr, go to step S183-9.

Step S183-9: Place the block in the block loading queue; then return.

Step S183-10: Place the block in the block loading queue.

Step S183-11: Activate the block loading process; then return.

The flow chart in FIG. 88 shows the subroutine that carries out the block loading process.

Step S183-11-1: Decide whether there is a block in the block loading queue. If so, go to step S183-11-2. If not, return.

Step S183-11-2: Take a block from the block loading queue.

Step S183-11-3: Decide whether the block is the last block on the page. If so, go to step S183-11-4. If not, go to step S183-11-5.

Step S183-11-4: Clear the block loading flag and load the block into the printing processor 16; then return.

Step S183-11-5: Set the block loading flag and load the block into the printing processor 16; then return to step S183-11-1.

In a variation of the fifteenth embodiment, the image data manager 53 connects blocks as in the fourteenth embodiment, so that the printing unit controller 54 does not have to detect logical page boundaries.

In another variation of the fifteenth embodiment, the mean block-acceptance time interval (tm) is calculated by dividing the difference between the time stamps of the current block and the first block on the same physical page by n−1, where n is the number of blocks accepted for that physical page so far.

The invention is not limited to the embodiments described above. Those skilled in the art will recognize that further variations are possible within the scope of the appended claims.

What is claimed is:

1. A method of controlling the printing of a physical page by a printing device according to print data prepared by a host device, the method comprising:
dividing the print data for the physical page into a plurality of data blocks in the host device, each data block representing a logical page, and adding information to at least one of the data blocks indicating the existence of a plurality of logical pages;
sending the data blocks from the host device to the printing device;
generating a plurality of image blocks in the printing device according to the received data blocks, each image block representing one logical page; and
printing the image blocks on the physical page according to the information added to said at least one of the data blocks.

2. The method of claim 1, wherein the information added to said at least one of the data blocks includes a start-marker added to a first one of the data blocks, and an end-marker added to a last one of the data blocks.

3. The method of claim 1, wherein the information added to said at least one of the data blocks includes a start-marker added to a first one of the data blocks, and a block count.

4. The method of claim 1, wherein the information added to said at least one of the data blocks includes a start-marker added to a first one of the data blocks, and linking information linking each consecutive pair of the data blocks.

5. The method of claim 1, wherein the printing device sets connectivity information indicating block-to-block connectivity in at least one of the image blocks.

6. The method of claim 1, wherein the printing device saves the data blocks received from the host device in a storage device, and generates the image blocks by reading the data blocks from the storage device.

7. The method of claim 1, wherein the printing device generates all of the image blocks for the physical page before starting to print the physical page.

8. The method of claim 7, wherein the printing device stores at least one of the generated image blocks in a storage device.

9. The method of claim 1, wherein the printing device saves the data blocks received from the host device in a storage device and, if an error occurs during the printing of the physical page, recovers from the error by reading the data blocks from the storage device.

10. The method of claim 1, wherein the printing device saves the generated image blocks in a storage device and, if an error occurs during the printing of the physical page, recovers from the error by reading the image blocks from the storage device.

11. The method of claim 1, further comprising:
saving the received data blocks in a nonvolatile storage device in the printing device;
sending a reprinting instruction from the host device to the printing device; and
reprinting the physical page by reading the data blocks from the storage device.

12. The method of claim 1, further comprising:
calculating a logical length of each logical page; and
detecting boundaries between logical pages according to said logical length, in the printing device.

13. The method of claim 12, further comprising:
switching on a synchronizing signal in the printing device to begin printing of a first logical page on the physical page; and
leaving the synchronizing signal on during and between the printing of all of the logical pages on the physical page;
wherein the synchronizing signal requests printable data from the generated image blocks.

14. The method of claim 1, further comprising:
generating a blank band of image data for a logical page to represent a primary color missing from the logical page;
leaving a synchronizing signal on during the printing of said logical page, the synchronizing signal requesting printable data for said primary color from the generated image blocks; and
supplying said blank band in place of said printable data for said primary color on said logical page.

15. The method of claim 1, further comprising:
comparing a rate of generation of the image blocks with a rate of transport of the physical page in the printing device; and
storing the generated image blocks without starting to print, if the rate of generation of the image blocks is slower than the rate of transport of the physical page.

16. A printing system comprising:
a host device that generates print data for a physical page by dividing the physical page into a plurality of logical pages having lengths shorter than the physical page, generating respective data blocks for the logical pages, and adding information to at least one of the data blocks indicating the existence of a plurality of logical pages; and
a printing device that receives the data blocks from the host device, generates image blocks corresponding to the data blocks, each image block representing one of the logical pages, and prints the image blocks on the physical page according to the information added to the data blocks.

17. The printing system of claim 16, wherein the printing device has a nonvolatile storage device for saving the data blocks received from the host device, and reprints the physical page by using the data blocks stored in the nonvolatile storage device.

18. The printing system of claim 16, wherein the printing device has a storage device for storing the image blocks, generates all of the image blocks for the physical page before starting to print the physical page, and stores at least one of the generated image blocks in the storage device.

19. The printing system of claim 16, wherein the printing device comprises:
an image data manager that manages the image data blocks; and
a printing unit controller that switches on a synchronizing signal to request data from the image blocks managed by the image data manager to start printing the physical page, and leaves the synchronizing signal switched on until all data for the physical page have been received from the image data manager.

20. The printing system of claim 16, wherein the printing device has a block loading controller that compares a rate of generation of the image blocks with a rate of transport of the physical page, and if the rate of generation of the image blocks is slower than the rate of transport of the physical page, stores the generated image blocks without starting to print.
